(19) United States
(12) Patent Application Publication
(10) Pub. No.: US 2023/0114890 A1
(43) Pub. Date: Apr. 13, 2023

(54) LENS OPTICAL SYSTEM, LIGHT RECEIVING DEVICE, AND DISTANCE MEASURING SYSTEM

(71) Applicants: SONY GROUP CORPORATION, TOKYO (JP); SONY SEMICONDUCTOR SOLUTIONS CORPORATION, KANAGAWA (JP)

(72) Inventors: HIDEAKI OKANO, TOKYO (JP); YOSUKE NARITA, TOKYO (JP); SATOSHI TAKEMOTO, TOKYO (JP); FUMIHIKO HANZAWA, KANAGAWA (JP); HIDENORI NAGASAKA, TOKYO (JP)

(21) Appl. No.: 17/906,188

(22) PCT Filed: Mar. 11, 2021
(86) PCT No.: PCT/JP2021/009732

§ 371 Date: Sep. 12, 2022

(30) Foreign Application Priority Data
Mar. 25, 2020 (JP) 2020-053699

(51) Int. Cl. G02B 9/40

(52) U.S. Cl. CPC G02B 9/40

(57) ABSTRACT

The present disclosure relates to a lens optical system, a light receiving device, and a distance measuring system capable of providing a highly efficient lens optical system while achieving reduction in size and height. A lens optical system includes, in order from an object side, a first lens group having a negative refractive power, and a second lens group having a positive refractive power, in which the first lens group includes a first lens having a negative refractive power, the second lens group includes a second lens having a positive or negative refractive power, a third lens having a positive refractive power, and a fourth lens having a positive refractive power, and the lens optical system has a positive refractive power as a whole. The present disclosure can be applied to, for example, a distance measuring system that detects a distance to a subject in a depth direction, and the like.

### TECHNICAL FIELD

The present disclosure relates to a lens optical system, a light receiving device, and a distance measuring system, and particularly relates to a lens optical system, a light receiving device, and a distance measuring system capable of providing a highly efficient lens optical system while achieving reduction in size and height.

### BACKGROUND ART

Imaging devices such as a camera-equipped mobile phone and a digital still camera using an imaging element such as a charge coupled device (CCD) or a complementary metal oxide semiconductor (CMOS) image sensor are known. In such an imaging device, further downsizing, height reduction, high efficiency, and high output power are required, and also in an imaging lens to be mounted, in addition to downsizing and height reduction, it is required to reduce a decrease in peripheral light amount ratio that tends to occur in height reduction. By increasing the peripheral light amount ratio, light beams can be collected more efficiently, and a load of image processing in the subsequent stage is also reduced.

Furthermore, for the imaging lens, a bright lens with a large aperture, that is, an opening with a bright Fno is required in order to achieve a faster shutter speed and secure an absolute light amount incident on the optical system while preventing deterioration of image quality due to noise in imaging in a dark place. As such a small and highly efficient imaging lens, a lens optical system having a configuration of four or more lenses is required.

For example, the lens optical systems of Patent Documents 1 to 4 have been proposed as an optical system with a four-lens configuration.

### CITATION LIST

### Patent Document

Patent Document 1: Japanese Patent Application Laid-Open No. 2017-116795
Patent Document 2: Japanese Patent Application Laid-Open No. 2018-77921
Patent Document 3: Japanese Patent Application Laid-Open No. 2018-141825
Patent Document 4: Japanese Patent Application Laid-Open No. 2018-189867

### SUMMARY OF THE INVENTION

### Problems to be Solved by the Invention

The lens optical system of Patent Document 1 has an Fno of about 2.4 in a four-lens configuration, and various aberrations, particularly spherical aberration and field curvature, are well corrected and good performance can be secured. However, a barrel-shaped distortion aberration cannot be corrected, and the barrel-shaped distortion aberration occurs largely. Furthermore, the second lens has a shape with a convex surface facing an object side and a distance to the first lens is long, and thus the total length becomes long, impairing performance in terms of miniaturization and height reduction.

The lens optical system of Patent Document 2 also has a four-lens configuration and has an Fno of about 2.0, and it can be seen that light beams can be efficiently collected. However, also in this lens optical system, the second lens has a shape with a convex surface facing the object side and the distance to the first lens is long, and thus the total length is long, impairing the performance in terms of miniaturization and height reduction. From these lens optical systems, it is expected that aberration correction, particularly correction of spherical aberration and coma aberration, will be difficult if downsizing and height reduction or enlargement of the Fno aperture are further advanced in the future.

The lens optical system of Patent Document 3 also has a four-lens configuration and has an Fno of about 2.4. This lens optical system has a small size and a low height with a short interval between the respective lenses including the interval between the first lens and the second lens. It can be seen that the second lens has a concave surface facing the object side and can collect light with high efficiency. However, the distance from the final lens to the light receiving element is long, and efficiency of peripheral light beams and light beams incident on a peripheral portion of the light receiving element is low there. Furthermore, the distortion aberration is largely generated in a barrel shape.

The lens optical system of Patent Document 4 also has a four-lens configuration, and Fno is a numerical value from 2.4 to 2.8. A negative first lens, a positive second lens, a positive third lens, and a negative fourth lens are provided, and each lens interval including an interval between the first lens and the second lens or the like is close, which is considered to be suitable for miniaturization and height reduction. Furthermore, it can be seen that the second lens has a concave surface facing the object side and can collect light with high efficiency. However, it is conceivable that this lens optical system splashes the light beams incident on the peripheral portion of the light receiving element from the shape of the final surface of the fourth lens, thereby decreasing efficiency of the peripheral light beams.

The present disclosure has been made in view of such a situation, and an object thereof is to provide a highly efficient lens optical system while achieving reduction in size and height.

### Solutions to Problems

A lens optical system according to a first aspect of the present disclosure includes,

in order from an object side:

a first lens group having a negative refractive power; and

a second lens group having a positive refractive power, in which

the first lens group includes
a first lens having a negative refractive power,

the second lens group includes
a second lens having a positive or negative refractive power,
a third lens having a positive refractive power, and
a fourth lens having a positive refractive power, and

the lens optical system has a positive refractive power as a whole.

A light receiving device according to a second aspect of the present disclosure includes:

a lens optical system; and

a light receiving element that receives light from an object side collected by the lens optical system, in which

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive or negative refractive power,
a third lens having a positive refractive power, and
a fourth lens having a positive refractive power.

A distance measuring system according to a third aspect of the present disclosure includes:

a lighting device that emits irradiation light; and

a light receiving device that receives reflected light in which the irradiation light is reflected by an object, in which

the light receiving device includes
a lens optical system, and
a light receiving element that receives light beams from an object side collected by the lens optical system, and

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive or negative refractive power,
a third lens having a positive refractive power, and
a fourth lens having a positive refractive power.

In the first to third aspects of the present disclosure, as the lens optical system, in order from an object side a first lens group having a negative refractive power, and a second lens group having a positive refractive power are provided, in which the first lens group includes a first lens having a negative refractive power, the second lens group includes a second lens having a positive or negative refractive power, a third lens having a positive refractive power, and a fourth lens having a positive refractive power, and the lens optical system has a positive refractive power as a whole.

A lens optical system according to a fourth aspect of the present disclosure includes,

in order from an object side:

a first lens group having a negative refractive power; and

a second lens group having a positive refractive power, in which

the first lens group includes
a first lens having a negative refractive power,

the second lens group includes
a second lens having a positive refractive power,
a third lens having a positive or negative refractive power, and
a fourth lens having a positive refractive power, and

the lens optical system has a positive refractive power as a whole.

A light receiving device according to a fifth aspect of the present disclosure includes:

a lens optical system; and

a light receiving element that receives light from an object side collected by the lens optical system, in which

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive refractive power,
a third lens having a positive or negative refractive power, and
a fourth lens having a positive refractive power.

A distance measuring system according to a sixth aspect of the present disclosure includes:

a lighting device that emits irradiation light; and

a light receiving device that receives reflected light in which the irradiation light is reflected by an object, in which

the light receiving device includes
a lens optical system, and
a light receiving element that receives light beams from an object side collected by the lens optical system, and

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive refractive power,
a third lens having a positive or negative refractive power, and

a fourth lens having a positive refractive power.

In the fourth to sixth aspects of the present disclosure, as the lens optical system, in order from an object side a first lens group having a negative refractive power, and a second lens group having a positive refractive power are provided, in which the first lens group includes a first lens having a negative refractive power, the second lens group includes a second lens having a positive refractive power, a third lens having a positive or negative refractive power, and a fourth lens having a positive refractive power, and the lens optical system has a positive refractive power as a whole.

The lens optical system, the light receiving device, and the distance measuring system may be independent devices, or may be modules incorporated in other devices.

### BRIEF DESCRIPTION OF DRAWINGS

FIG. 1 is a view illustrating a first configuration example of a lens optical system in a first embodiment.

FIG. 2 is a diagram illustrating characteristic data and lens data of the first configuration example of the lens optical system in the first embodiment.

FIG. 3 is a diagram illustrating aspherical data of the first configuration example of the lens optical system in the first embodiment.

FIG. 4 is an aberration diagram of the first configuration example of the lens optical system in the first embodiment.

FIG. 5 is a view illustrating a second configuration example of the lens optical system in the first embodiment.

FIG. 6 is a diagram illustrating characteristic data and lens data of the second configuration example of the lens optical system in the first embodiment.

FIG. 7 is a diagram illustrating aspherical data of the second configuration example of the lens optical system in the first embodiment.

FIG. 8 is an aberration diagram of the second configuration example of the lens optical system in the first embodiment.

FIG. 9 is a view illustrating a third configuration example of the lens optical system in the first embodiment.

FIG. 10 is a diagram illustrating characteristic data and lens data of the third configuration example of the lens optical system in the first embodiment.

FIG. 11 is a diagram illustrating aspherical data of the third configuration example of the lens optical system in the first embodiment.

FIG. 12 is an aberration diagram of the third configuration example of the lens optical system in the first embodiment.

FIG. 13 is a view illustrating a fourth configuration example of the lens optical system in the first embodiment.

FIG. 14 is a diagram illustrating characteristic data and lens data of the fourth configuration example of the lens optical system in the first embodiment.

FIG. 15 is a diagram illustrating aspherical data of the fourth configuration example of the lens optical system in the first embodiment.

FIG. 16 is an aberration diagram of the fourth configuration example of the lens optical system in the first embodiment.

FIG. 17 is a view illustrating a fifth configuration example of the lens optical system in the first embodiment.

FIG. 18 is a diagram illustrating characteristic data and lens data of the fifth configuration example of the lens optical system in the first embodiment.

FIG. 19 is a diagram illustrating aspherical data of the fifth configuration example of the lens optical system in the first embodiment.

FIG. 20 is an aberration diagram of the fifth configuration example of the lens optical system in the first embodiment.

FIG. 21 is a view illustrating a sixth configuration example of the lens optical system in the first embodiment.

FIG. 22 is a diagram illustrating characteristic data and lens data of the sixth configuration example of the lens optical system in the first embodiment.

FIG. 23 is a diagram illustrating aspherical data of the sixth configuration example of the lens optical system in the first embodiment.

FIG. 24 is an aberration diagram of the sixth configuration example of the lens optical system in the first embodiment.

FIG. 25 is a view illustrating a seventh configuration example of the lens optical system in the first embodiment.

FIG. 26 is a diagram illustrating characteristic data and lens data of the seventh configuration example of the lens optical system in the first embodiment.

FIG. 27 is a diagram illustrating aspherical data of the seventh configuration example of the lens optical system in the first embodiment.

FIG. 28 is an aberration diagram of the seventh configuration example of the lens optical system in the first embodiment.

FIG. 29 is a view illustrating an eighth configuration example of the lens optical system in the first embodiment.

FIG. 30 is a diagram illustrating characteristic data and lens data of the eighth configuration example of the lens optical system in the first embodiment.

FIG. 31 is a diagram illustrating aspherical data of the eighth configuration example of the lens optical system in the first embodiment.

FIG. 32 is an aberration diagram of the eighth configuration example of the lens optical system in the first embodiment.

FIG. 33 is a view illustrating a ninth configuration example of the lens optical system in the first embodiment.

FIG. 34 is a diagram illustrating characteristic data and lens data of the ninth configuration example of the lens optical system in the first embodiment.

FIG. 35 is a diagram illustrating aspherical data of the ninth configuration example of the lens optical system in the first embodiment.

FIG. 36 is an aberration diagram of the ninth configuration example of the lens optical system in the first embodiment.

FIG. 37 is a view illustrating a tenth configuration example of the lens optical system in the first embodiment.

FIG. 38 is a diagram illustrating characteristic data and lens data of the tenth configuration example of the lens optical system in the first embodiment.

FIG. 39 is a diagram illustrating aspherical data of the tenth configuration example of the lens optical system in the first embodiment.

FIG. 40 is an aberration diagram of the tenth configuration example of the lens optical system in the first embodiment.

FIG. 41 is a view illustrating an 11th configuration example of the lens optical system in the first embodiment.

FIG. 42 is a diagram illustrating characteristic data and lens data of the 11th configuration example of the lens optical system in the first embodiment.

FIG. 43 is a diagram illustrating aspherical data of the 11th configuration example of the lens optical system in the first embodiment.

FIG. 44 is an aberration diagram of the 11th configuration example of the lens optical system in the first embodiment.

FIG. 45 is a view illustrating a 12th configuration example of the lens optical system in the first embodiment.

FIG. 46 is a diagram illustrating characteristic data and lens data of the 12th configuration example of the lens optical system in the first embodiment.

FIG. 47 is a diagram illustrating aspherical data of the 12th configuration example of the lens optical system in the first embodiment.

FIG. 48 is an aberration diagram of the 12th configuration example of the lens optical system in the first embodiment.

FIG. 49 is a view illustrating a 13th configuration example of the lens optical system in the first embodiment.

FIG. 50 is a diagram illustrating characteristic data and lens data of the 13th configuration example of the lens optical system in the first embodiment.

FIG. 51 is a diagram illustrating aspherical data of the 13th configuration example of the lens optical system in the first embodiment.

FIG. 52 is an aberration diagram of the 13th configuration example of the lens optical system in the first embodiment.

FIG. 53 is a view illustrating a 14th configuration example of the lens optical system in the first embodiment.

FIG. 54 is a diagram illustrating characteristic data and lens data of the 14th configuration example of the lens optical system in the first embodiment.

FIG. 55 is a diagram illustrating aspherical data of the 14th configuration example of the lens optical system in the first embodiment.

FIG. 56 is an aberration diagram of the 14th configuration example of the lens optical system in the first embodiment.

FIG. 57 is a view illustrating a 15th configuration example of the lens optical system in the first embodiment.

FIG. 58 is a diagram illustrating characteristic data and lens data of the 15th configuration example of the lens optical system in the first embodiment.

FIG. 59 is a diagram illustrating aspherical data of the 15th configuration example of the lens optical system in the first embodiment.

FIG. 60 is an aberration diagram of the 15th configuration example of the lens optical system in the first embodiment.

FIG. 61 is a view illustrating a 16th configuration example of the lens optical system in the first embodiment.

FIG. 62 is a diagram illustrating characteristic data and lens data of the 16th configuration example of the lens optical system in the first embodiment.

FIG. 63 is a diagram illustrating aspherical data of the 16th configuration example of the lens optical system in the first embodiment.

FIG. 64 is an aberration diagram of the 16th configuration example of the lens optical system in the first embodiment.

FIG. 65 is a view illustrating a 17th configuration example of the lens optical system in the first embodiment.

FIG. 66 is a diagram illustrating characteristic data and lens data of the 17th configuration example of the lens optical system in the first embodiment.

FIG. 67 is a diagram illustrating aspherical data of the 17th configuration example of the lens optical system in the first embodiment.

FIG. 68 is an aberration diagram of the 17th configuration example of the lens optical system in the first embodiment.

FIG. 69 is a view illustrating an 18th configuration example of the lens optical system in the first embodiment.

FIG. 70 is a diagram illustrating characteristic data and lens data of the 18th configuration example of the lens optical system in the first embodiment.

FIG. 71 is a diagram illustrating aspherical data of the 18th configuration example of the lens optical system in the first embodiment.

FIG. 72 is an aberration diagram of the 18th configuration example of the lens optical system in the first embodiment.

FIG. 73 is a view illustrating a 19th configuration example of the lens optical system in the first embodiment.

FIG. 74 is a diagram illustrating characteristic data and lens data of the 19th configuration example of the lens optical system in the first embodiment.

FIG. 75 is a diagram illustrating aspherical data of the 19th configuration example of the lens optical system in the first embodiment.

FIG. 76 is an aberration diagram of the 19th configuration example of the lens optical system in the first embodiment.

FIG. 77 is a view illustrating a 20th configuration example of the lens optical system in the first embodiment.

FIG. 78 is a diagram illustrating characteristic data and lens data of the 20th configuration example of the lens optical system in the first embodiment.

FIG. 79 is a diagram illustrating aspherical data of the 20th configuration example of the lens optical system in the first embodiment.

FIG. 80 is an aberration diagram of the 20th configuration example of the lens optical system in the first embodiment.

FIG. 81 is a view illustrating a 21st configuration example of the lens optical system in the first embodiment.

FIG. 82 is a diagram illustrating characteristic data and lens data of the 21st configuration example of the lens optical system in the first embodiment.

FIG. 83 is a diagram illustrating aspherical data of the 21st configuration example of the lens optical system in the first embodiment.

FIG. 84 is an aberration diagram of the 21st configuration example of the lens optical system in the first embodiment.

FIG. 85 is a view illustrating a 22nd configuration example of the lens optical system in the first embodiment.

FIG. 86 is a diagram illustrating characteristic data and lens data of the 22nd configuration example of the lens optical system in the first embodiment.

FIG. 87 is a diagram illustrating aspherical data of the 22nd configuration example of the lens optical system in the first embodiment.

FIG. 88 is an aberration diagram of the 22nd configuration example of the lens optical system in the first embodiment.

FIG. 89 is a view illustrating a 23rd configuration example of the lens optical system in the first embodiment.

FIG. 90 is a diagram illustrating characteristic data and lens data of the 23rd configuration example of the lens optical system in the first embodiment.

FIG. 91 is a diagram illustrating aspherical data of the 23rd configuration example of the lens optical system in the first embodiment.

FIG. 92 is an aberration diagram of the 23rd configuration example of the lens optical system in the first embodiment.

FIG. 93 is a view illustrating a 24th configuration example of the lens optical system in the first embodiment.

FIG. 94 is a diagram illustrating characteristic data and lens data of the 24th configuration example of the lens optical system in the first embodiment.

FIG. 95 is a diagram illustrating aspherical data of the 24th configuration example of the lens optical system in the first embodiment.

FIG. 96 is an aberration diagram of the 24th configuration example of the lens optical system in the first embodiment.

FIG. 97 is a view illustrating a 25th configuration example of the lens optical system in the first embodiment.

FIG. 98 is a diagram illustrating characteristic data and lens data of the 25th configuration example of the lens optical system in the first embodiment.

FIG. 99 is a diagram illustrating aspherical data of the 25th configuration example of the lens optical system in the first embodiment.

FIG. 100 is an aberration diagram of the 25th configuration example of the lens optical system in the first embodiment.

FIG. 101 is a diagram illustrating conditional expression data of each configuration example of the lens optical system according to the first embodiment.

FIG. 102 is a diagram illustrating conditional expression data of each configuration example of the lens optical system according to the first embodiment.

FIG. 103 is a diagram illustrating conditional expression data of each configuration example of the lens optical system according to the first embodiment.

FIG. 104 is a view illustrating a first configuration example of a lens optical system in a second embodiment.

FIG. 105 is a diagram illustrating characteristic data and lens data of the first configuration example of the lens optical system in the second embodiment.

FIG. 106 is a diagram illustrating aspherical data of the first configuration example of the lens optical system in the second embodiment.

FIG. 107 is an aberration diagram of the first configuration example of the lens optical system in the second embodiment.

FIG. 108 is a view illustrating a second configuration example of the lens optical system in the second embodiment.

FIG. 109 is a diagram illustrating characteristic data and lens data of the second configuration example of the lens optical system in the second embodiment.

FIG. 110 is a diagram illustrating aspherical data of the second configuration example of the lens optical system in the second embodiment.

FIG. 111 is an aberration diagram of the second configuration example of the lens optical system in the second embodiment.

FIG. 112 is a view illustrating a third configuration example of the lens optical system in the second embodiment.

FIG. 113 is a diagram illustrating characteristic data and lens data of the third configuration example of the lens optical system in the second embodiment.

FIG. 114 is a diagram illustrating aspherical data of the third configuration example of the lens optical system in the second embodiment.

FIG. 115 is an aberration diagram of the third configuration example of the lens optical system in the second embodiment.

FIG. 116 is a view illustrating a fourth configuration example of the lens optical system in the second embodiment.

FIG. 117 is a diagram illustrating characteristic data and lens data of the fourth configuration example of the lens optical system in the second embodiment.

FIG. 118 is a diagram illustrating aspherical data of the fourth configuration example of the lens optical system in the second embodiment.

FIG. 119 is an aberration diagram of the fourth configuration example of the lens optical system in the second embodiment.

FIG. 120 is a view illustrating a fifth configuration example of the lens optical system in the second embodiment.

FIG. 121 is a diagram illustrating characteristic data and lens data of the fifth configuration example of the lens optical system in the second embodiment.

FIG. 122 is a diagram illustrating aspherical data of the fifth configuration example of the lens optical system in the second embodiment.

FIG. 123 is an aberration diagram of the fifth configuration example of the lens optical system in the second embodiment.

FIG. 124 is a view illustrating a sixth configuration example of the lens optical system in the second embodiment.

FIG. 125 is a diagram illustrating characteristic data and lens data of the sixth configuration example of the lens optical system in the second embodiment.

FIG. 126 is a diagram illustrating aspherical data of the sixth configuration example of the lens optical system in the second embodiment.

FIG. 127 is an aberration diagram of the sixth configuration example of the lens optical system in the second embodiment.

FIG. 128 is a view illustrating a seventh configuration example of the lens optical system in the second embodiment.

FIG. 129 is a diagram illustrating characteristic data and lens data of the seventh configuration example of the lens optical system in the second embodiment.

FIG. 130 is a diagram illustrating aspherical data of the seventh configuration example of the lens optical system in the second embodiment.

FIG. 131 is an aberration diagram of the seventh configuration example of the lens optical system in the second embodiment.

FIG. 132 is a view illustrating an eighth configuration example of the lens optical system in the second embodiment.

FIG. 133 is a diagram illustrating characteristic data and lens data of the eighth configuration example of the lens optical system in the second embodiment.

FIG. 134 is a diagram illustrating aspherical data of the eighth configuration example of the lens optical system in the second embodiment.

FIG. 135 is an aberration diagram of the eighth configuration example of the lens optical system in the second embodiment.

FIG. 136 is a view illustrating a ninth configuration example of the lens optical system in the second embodiment.

FIG. 137 is a diagram illustrating characteristic data and lens data of the ninth configuration example of the lens optical system in the second embodiment.

FIG. 138 is a diagram illustrating aspherical data of the ninth configuration example of the lens optical system in the second embodiment.

FIG. 139 is an aberration diagram of the ninth configuration example of the lens optical system in the second embodiment.

FIG. 140 is a view illustrating a tenth configuration example of the lens optical system in the second embodiment.

FIG. 141 is a diagram illustrating characteristic data and lens data of the tenth configuration example of the lens optical system in the second embodiment.

FIG. 142 is a diagram illustrating aspherical data of the tenth configuration example of the lens optical system in the second embodiment.

FIG. 143 is an aberration diagram of the tenth configuration example of the lens optical system in the second embodiment.

FIG. 144 is a view illustrating an 11th configuration example of the lens optical system in the second embodiment.

FIG. 145 is a diagram illustrating characteristic data and lens data of the 11th configuration example of the lens optical system in the second embodiment.

FIG. 146 is a diagram illustrating aspherical data of the 11th configuration example of the lens optical system in the second embodiment.

FIG. 147 is an aberration diagram of the 11th configuration example of the lens optical system in the second embodiment.

FIG. 148 is a view illustrating a 12th configuration example of the lens optical system in the second embodiment.

FIG. 149 is a diagram illustrating characteristic data and lens data of the 12th configuration example of the lens optical system in the second embodiment.

FIG. 150 is a diagram illustrating aspherical data of the 12th configuration example of the lens optical system in the second embodiment.

FIG. 151 is an aberration diagram of the 12th configuration example of the lens optical system in the second embodiment.

FIG. 152 is a view illustrating a 13th configuration example of the lens optical system in the second embodiment.

FIG. 153 is a diagram illustrating characteristic data and lens data of the 13th configuration example of the lens optical system in the second embodiment.

FIG. 154 is a diagram illustrating aspherical data of the 13th configuration example of the lens optical system in the second embodiment.

FIG. 155 is an aberration diagram of the 13th configuration example of the lens optical system in the second embodiment.

FIG. 156 is a view illustrating a 14th configuration example of the lens optical system in the second embodiment.

FIG. 157 is a diagram illustrating characteristic data and lens data of the 14th configuration example of the lens optical system in the second embodiment.

FIG. 158 is a diagram illustrating aspherical data of the 14th configuration example of the lens optical system in the second embodiment.

FIG. 159 is an aberration diagram of the 14th configuration example of the lens optical system in the second embodiment.

FIG. 160 is a diagram illustrating conditional expression data of each configuration example of the lens optical system according to the second embodiment.

FIG. 161 is a diagram illustrating conditional expression data of each configuration example of the lens optical system according to the second embodiment.

FIG. 162 is a view illustrating a configuration example of a distance measuring system on which a lens optical system according to the first embodiment or the second embodiment is mounted.

FIG. 163 is a block diagram illustrating a configuration example of a smartphone as an electronic device equipped with a distance measuring system.

FIG. 164 is a block diagram illustrating an example of a schematic configuration of a vehicle control system.

FIG. 165 is an explanatory view illustrating an example of installation positions of outside-vehicle information detection units and imaging sections.

### MODE FOR CARRYING OUT THE INVENTION

Hereinafter, modes for carrying out the present disclosure (hereinafter, it is referred to as an embodiment) will be described with reference to the accompanying drawings. Note that in the description and the drawings, components having substantially the same functional configuration are denoted by the same reference numerals, and redundant descriptions are omitted. The description will be made in the following order.

1. First Embodiment of Lens Optical System

2. Second Embodiment of Lens Optical System

3. Application Example to Distance Measuring System

4. Application Example to Electronic Device

5. Application Example to Mobile Object

### 1. First Embodiment of Lens Optical System

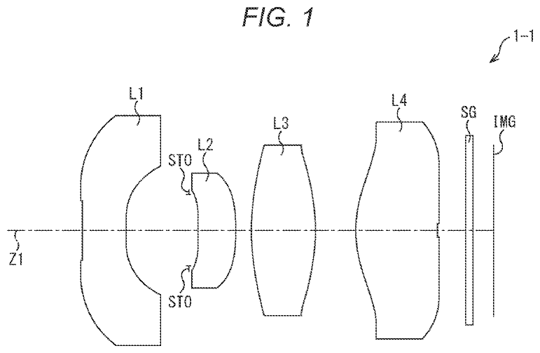

First, a lens optical system according to a first embodiment of the present disclosure will be described with reference to a lens optical system 1-1 in FIG. 1. The lens optical system 1-1 in FIG. 1 is a first configuration example of a lens optical system 1 in the first embodiment.

The lens optical system 1 according to the first embodiment of the present disclosure includes a first lens L1 having a negative refractive power, a second lens L2 having a positive or negative refractive power, a third lens L3 having a positive refractive power, and a fourth lens L4 having a positive refractive power in order from an object side around an optical axis Z1 of a one-dot chain line, and has a positive refractive power as a whole. The first lens L1 closer to the object side than an aperture stop STO constitutes a first lens group and has a negative refractive power. The second lens L2 to the fourth lens L4 on an image side of the aperture stop STO constitute a second lens group and have a positive refractive power. The first lens group is also referred to as a front group, and the second lens group is also referred to as a rear group.

In the lens optical system 1, the aperture stop STO is disposed between the first lens L1 and the second lens L2, and a sealing glass SG is disposed between the fourth lens L4 and an image plane IMG. The sealing glass SG can have a filter function such as an infrared cut filter and a band pass filter, an antireflection function, and the like, in addition to a function of protecting a light receiving element. Note that the sealing glass SG may be omitted.

The lens optical system 1 collects light beams from the object side on a photoelectric conversion section of the light receiving element arranged at the position of the image plane IMG and forms an image.

The lens optical system 1 has negative (first lens L1), positive or negative (second lens L2), positive (third lens L3), and positive (fourth lens L4) refractive powers in order from the first lens L1 on the object side, and has a positive refractive power as a whole, so that the angle of view is widened, the range on the object side can thereby be widened, and the light beams from the object side can be efficiently collected and guided to the light receiving element. Moreover, in addition to good collecting performance and optical performance, it is possible to shorten the total optical length, and it is possible to meet the need for reduction in size and height.

In the lens optical system 1, by configuring each lens so as to satisfy at least one conditional expression, preferably two or more conditional expressions in combination described below, it is possible to achieve a lens optical system having good collecting performance and optical performance, and having a reduced size and a reduced height.

Note that, in the following description, a surface on the object side of the first lens L1 is assumed as “1”, and a lens surface is denoted by “Si” with a number i so as to sequentially increase toward the image side. Furthermore, a paraxial curvature radius (mm) of the lens surface “Si” is represented by “Ri”.

First, for the lens optical system 1, a first conditional expression is that the lens shape of the second lens L2 on the object side is concave toward the object side. That is, a curvature radius R3 of a lens surface S3 satisfies the following conditional expression (1).

R3<0 (1)

Next, for the lens optical system 1, a second conditional expression is that the lens shape of the fourth lens L4 on the object side is convex toward the object side. That is, a curvature radius R7 of a lens surface S7 satisfies the following conditional expression (2).

R7>0 (2)

Since the lens shape of the second lens L2 on the object side is concave toward the object side, the light beams from the object side can be efficiently collected up to the peripheral edge portion of the light receiving element, and a shading characteristic is improved.

Next, the lens optical system 1 satisfies the following conditional expression (3).

|f/(fa₁/fa₂)|<2.0 (3)

In the conditional expression (3), f represents a focal length (mm) of the entire lens optical system 1 at a d-line (wavelength 587.6 nm), fa₁ represents a focal length (mm) of the first lens group (front group) at the d-line (wavelength 587.6 nm), and fa₂ represents a focal length (mm) of the second lens group (rear group) at the d-line (wavelength 587.6 nm).

The conditional expression (3) is an expression relating to an appropriate power distribution of the first lens group and the second lens group with respect to the power of lens of the entire optical system. The absolute value is used in the conditional expression (3) because the first lens group has negative power. When the conditional expression (3) exceeds an upper limit, the power of the first lens group becomes too small with respect to the power of lens of the entire optical system and the power of the second lens group, and it becomes difficult to widen the angle of view.

In consideration of securing the angle of view and the viewing angle, the conditional expression (3) more preferably satisfies the following conditional expression (3)′.

|f/(fa₁/fa₂)|<1.5 (3)′

Next, the lens optical system 1 satisfies the following conditional expression (4).

15<f/(f₂×f₃)<70 (4)

In the conditional expression (4), f₂ represents a focal length (mm) of the second lens L2 at the d-line (wavelength 587.6 nm), and f₃ represents a focal length (mm) of the third lens L3 at the d-line (wavelength 587.6 nm).

The conditional expression (4) is an expression relating to an appropriate power distribution of the combined power of the second lens L2 and the third lens L3 with respect to the power of lens of the entire optical system. When the conditional expression (4) exceeds an upper limit, the combined power of the second lens L2 and the third lens L3 becomes excessively large with respect to the power of lens of the entire optical system, and it becomes difficult to collect the light beams up to the peripheral angle of view while securing the angle of view and to secure the peripheral light amount ratio. On the other hand, when the conditional expression (4) exceeds a lower limit, the power of lens of the entire optical system becomes excessively large with respect to the combined power of the second lens L2 and the third lens L3, and although it is easy to widen the angle of view, it becomes difficult to correct each aberration, particularly coma aberration, and it becomes difficult to secure performance.

In consideration of securing the angle of view and the viewing angle, the conditional expression (4) more preferably satisfies the following conditional expression (4)′.

20<f/(f₂×f₃)<60 (4)′

Next, the lens optical system 1 satisfies the following conditional expression (5).

3<(FOV×D12)/TL<25 (5)

In the conditional expression (5), FOV represents an object-side capturing angle of the lens optical system 1, what is called an angle of view, and corresponds to an angle of view 2ω on both sides. D12 represents an inter-lens distance between the first lens L1 and the second lens L2. TL represents the total optical length of the lens optical system 1.

The conditional expression (5) is a conditional expression indicating the relationship among the angle of view FOV, the inter-lens distance D12 between the first lens L1 and the second lens L2, and the total optical length TL of the lens optical system 1. When the conditional expression (5) exceeds an upper limit, the total optical length TL of the lens optical system 1 becomes too short with respect to the relationship between the angle of view FOV and the length D12 from the first lens L1 to the second lens L2, and it becomes difficult to secure necessary optical performance in a state where the angle of view FOV is maintained. On the other hand, when the conditional expression (5) falls below a lower limit, the total optical length TL of the lens optical system 1 becomes too long with respect to the angle of view FOV and the length D12 from the first lens L1 to the second lens L2, and is no longer small in size.

In consideration of securing the angle of view and the viewing angle, the conditional expression (5) more preferably satisfies the following conditional expression (5)′.

3<(FOV×D12)/TL<25 (5)

Next, the lens optical system 1 satisfies the following conditional expression (6).

−8.0<(R1−R2)/(R1+R2)<140 (6)

The conditional expression (6) expresses the relationship of the lens curvature radius R2 of an image-side surface S2 of the first lens L1 with the lens curvature radius R1 of an object-side surface S1 of the first lens L1 by the conditional expression. When the conditional expression (6) falls below a lower limit, in a case where the object-side surface S1 of the first lens L1 is a concave surface, the curvature radius R2 of the image-side surface S2 becomes too large with respect to the curvature radius R1 of the object-side surface S1, and in a case where the object-side surface S1 of the first lens L1 is a convex surface, the curvature radius R2 of the image-side surface S2 becomes too small with respect to the curvature radius R1 of the object-side surface S1, so that it becomes difficult to efficiently collect the light beams up to the peripheral edge portion of the light receiving element. On the other hand, when the conditional expression (6) exceeds an upper limit, the curvature radius R2 of the image-side surface S2 becomes too small with respect to the curvature radius R1 of the object-side surface S1 of the first lens L1, and it becomes difficult to efficiently collect the light beams up to the peripheral edge portion of the light receiving element.

In consideration of efficiently collecting light up to the peripheral edge portion of the light receiving element, the conditional expression (6) more preferably satisfies the following conditional expression (6)′.

−5.0<(R1−R2)/(R1+R2)<120 (6)′

Next, the lens optical system 1 satisfies the following conditional expression (7).

−2.0<(R3−R4)/(R3+R4)<2.0 (7)

The conditional expression (7) expresses the relationship of the lens curvature radius R4 of the image-side surface S4 of the second lens L2 with the lens curvature radius R3 of the object-side surface S3 of the second lens L2. When the conditional expression (7) falls below a lower limit, the lens curvature radius R4 of the image-side surface S4 becomes too large with respect to the curvature radius R3 of the object-side surface S3 of the second lens L2, and it becomes difficult to efficiently cause the light beams collected by the first lens L1 to reach the peripheral edge portion of the light receiving element. On the other hand, when the conditional expression (7) exceeds an upper limit, the curvature radius R4 of the image-side surface S4 becomes too small with respect to the curvature radius R3 of the object-side surface S3 of the second lens L2, and it becomes difficult to efficiently cause the light beams collected by the first lens L1 to reach the peripheral edge portion of the light receiving element.

In consideration of efficiently collecting light up to the peripheral edge portion of the light receiving element, the conditional expression (7) more preferably satisfies the following conditional expression (7)′.

−0.5<(R3−R4)/(R3+R4)<1.0 (7)′

Next, the lens optical system 1 satisfies the following conditional expression (8).

−10.0<(R7+R8)/(R7−R8)<2.0 (8)

The conditional expression (8) expresses the relationship of the lens curvature radius R8 of the image-side surface S8 of the fourth lens L4 with the lens curvature radius R7 of the object-side surface S7 of the fourth lens L4. When the conditional expression (8) falls below a lower limit, the lens curvature radius R8 of the image-side surface S8 becomes too small with respect to the lens curvature radius R7 of the object-side surface S7 of the fourth lens L4, which adversely affects aberration correction, particularly distortion aberration correction. On the other hand, when the conditional expression (8) exceeds an upper limit, the lens curvature radius R8 of the image-side surface S8 becomes too large with respect to the lens curvature radius R7 of the object-side surface S7 of the fourth lens L4, and similarly, aberration correction, particularly correction of distortion aberration becomes difficult, making it difficult to obtain an appropriate correction effect.

In consideration of the aberration correction effect, the conditional expression (8) more preferably satisfies the following conditional expression (8)′.

−8.0<(R7+R8)/(R7−R8)<0.0 (8)′

Hereinafter, a configuration example in which specific numerical values are applied to the lens optical system 1 in the first embodiment will be described.

<1.1 First Configuration Example of First Embodiment>

FIG. 1 illustrates a first configuration example (Example 1) of the lens optical system 1 in the first embodiment.

The lens optical system 1-1 in FIG. 1 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

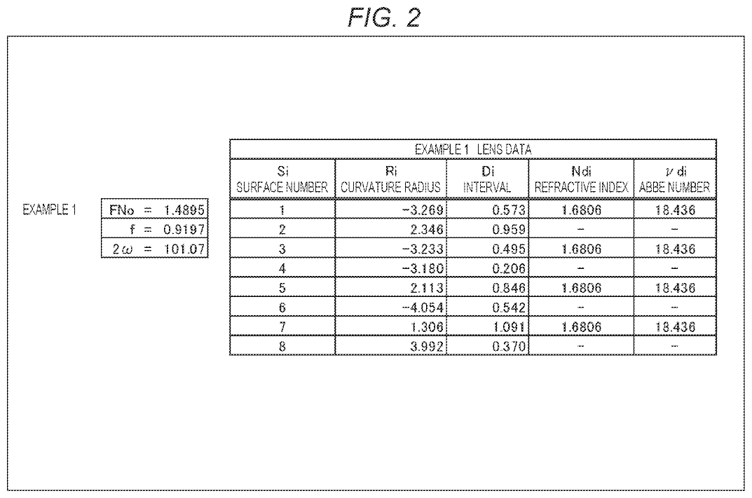

FIG. 2 illustrates specific characteristic data of the lens optical system 1-1 and lens data of the first lens L1 to the fourth lens L4.

In FIG. 2, “FNo” represents the F-number of the lens optical system 1-1, “f” represents the focal length (mm) of the entire lens system of the lens optical system 1-1, and “2ω” represents a diagonal total angle of view (°).

Furthermore, “Si” represents the i-th surface counted from the object side to the image side, “Ri” represents a paraxial curvature radius of the i-th surface Si, “Di” represents an interval on the optical axis between the i-th surface S1 and the (i+1)-th surface S(i+1), “Ndi” represents a refractive index at the d-line (wavelength 587.6 nm) of the lens starting from the i-th surface Si, and “νdi” represents the Abbe number at the d-line of the lens starting from the i-th surface Si.

An aspherical shape of each surface S1 of the lens optical system 1-1 is expressed by the following Formula (1). In Formula (1), Z represents a depth of the aspherical surface, and Y represents a height from the optical axis (a position in a direction perpendicular to the optical axis). Furthermore, K represents a conic constant, and Ai represents an i-th order (i is an integer of 3 or more) aspherical coefficient. R is a paraxial curvature radius. The meaning of each symbol is similar in other configuration examples (examples) described later.

$$\begin{matrix}[ Formula 1 ] & \\ Z = \frac{{Y}^{2} / R}{1 + \sqrt{1 - ( 1 + K ) {( Y / R )}^{2}}} + \sum Ai \cdot {Y}^{i} & ( 1 )\end{matrix}$$

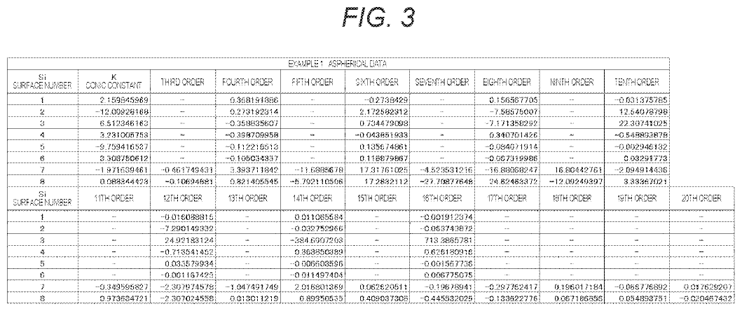

FIG. 3 illustrates a conic constant K of Formula (1) for specifying the aspherical shape of each surface S1 of the lens optical system 1-1 and a value of the i-th order (i is an integer of 3 or more) aspherical coefficient Ai.

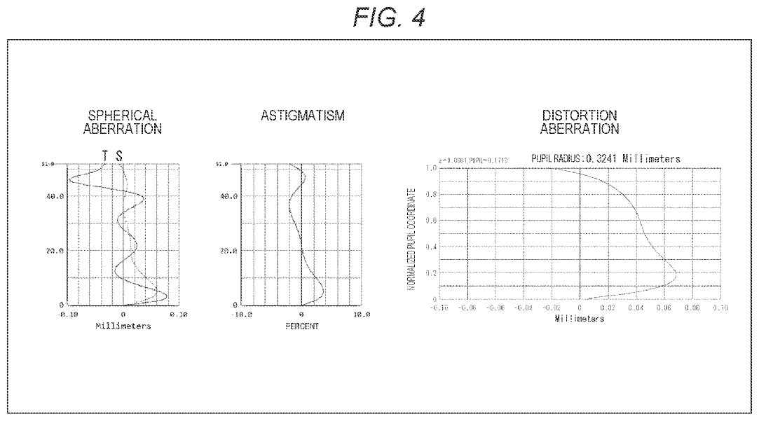

FIG. 4 is a diagram illustrating aberration performance of the lens optical system 1-1, and illustrates a spherical aberration diagram, an astigmatism diagram, and a distortion aberration diagram.

In the spherical aberration diagram, T represents spherical aberration in a lens normal direction, and S represents spherical aberration in a lens tangential direction. T and S are similarly used in spherical aberration diagrams of other configuration examples (examples) described later.

As can be seen from each aberration diagram, the lens optical system 1-1 has various aberrations corrected well and has excellent image forming performance.

<1.2 Second Configuration Example of First Embodiment>

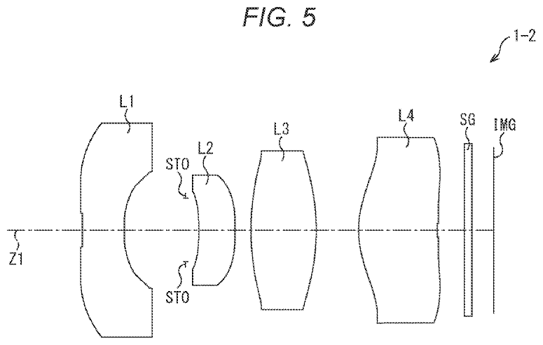

FIG. 5 illustrates a second configuration example (Example 2) of the lens optical system 1 in the first embodiment.

A lens optical system 1-2 in FIG. 5 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

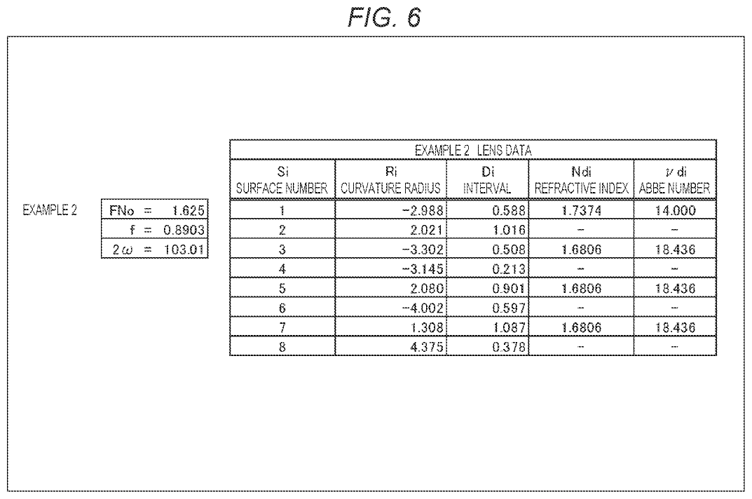

FIG. 6 illustrates specific characteristic data of the lens optical system 1-2 and lens data of the first lens L1 to the fourth lens L4.

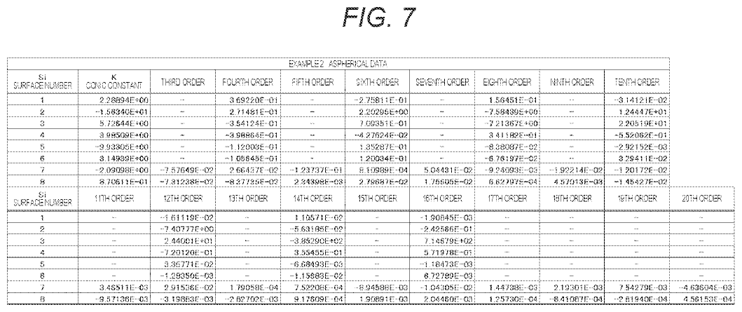

FIG. 7 illustrates a conic constant K of Formula (1) for specifying the aspherical shape of each surface S1 of the lens optical system 1-2 and a value of the i-th order (i is an integer of 3 or more) aspherical coefficient Ai. In the value of the aspherical coefficient Ai, a numerical value including a symbol “E” is an expression by an exponential function with a base of 10, and for example, “1.0E-05” indicates “1.0×10⁻⁵”.

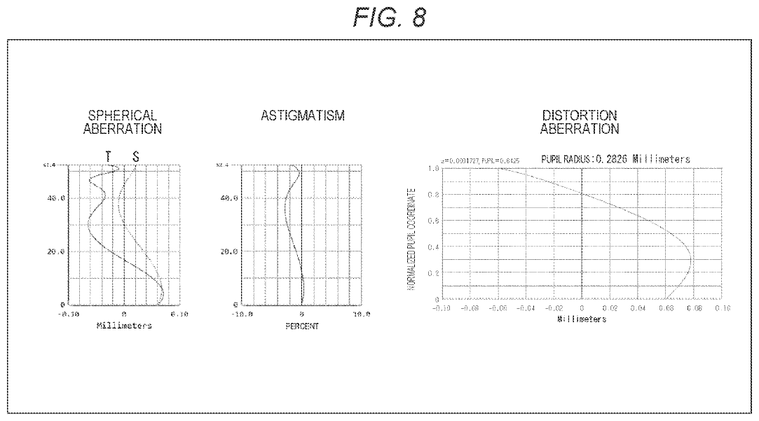

FIG. 8 is a diagram illustrating aberration performance of the lens optical system 1-2, and illustrates a spherical aberration diagram, an astigmatism diagram, and a distortion aberration diagram.

As can be seen from each aberration diagram, the lens optical system 1-2 has various aberrations corrected well and has excellent image forming performance.

<1.3 Third Configuration Example of First Embodiment>

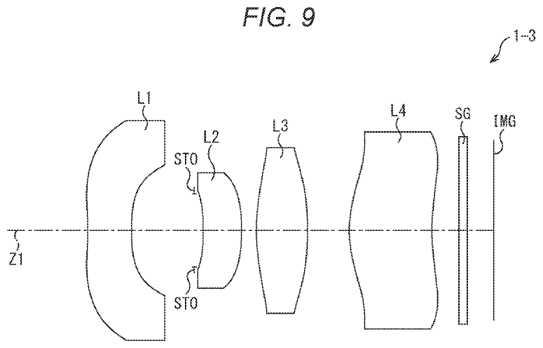

FIG. 9 illustrates a third configuration example (Example 3) of the lens optical system 1 in the first embodiment.

A lens optical system 1-3 in FIG. 9 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

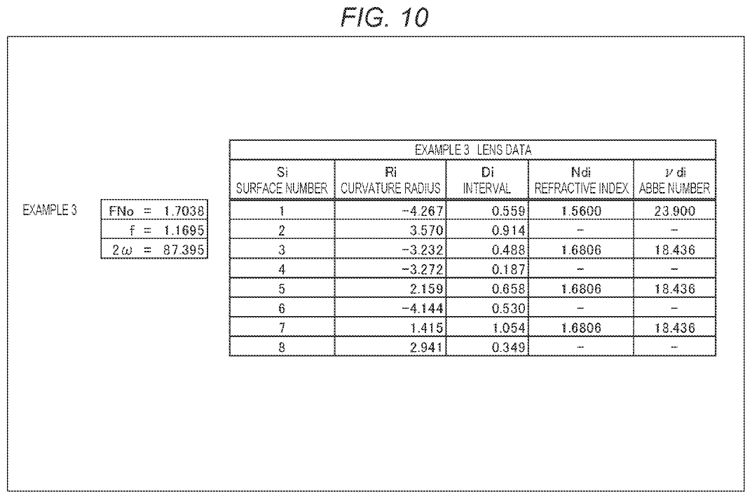

FIG. 10 illustrates specific characteristic data of the lens optical system 1-3 and lens data of the first lens L1 to the fourth lens L4.

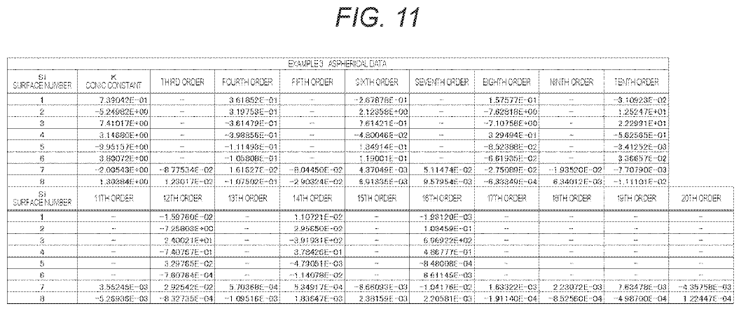

FIG. 11 illustrates a conic constant K of Formula (1) for specifying the aspherical shape of each surface S1 of the lens optical system 1-3 and a value of the i-th order (i is an integer of 3 or more) aspherical coefficient Ai.

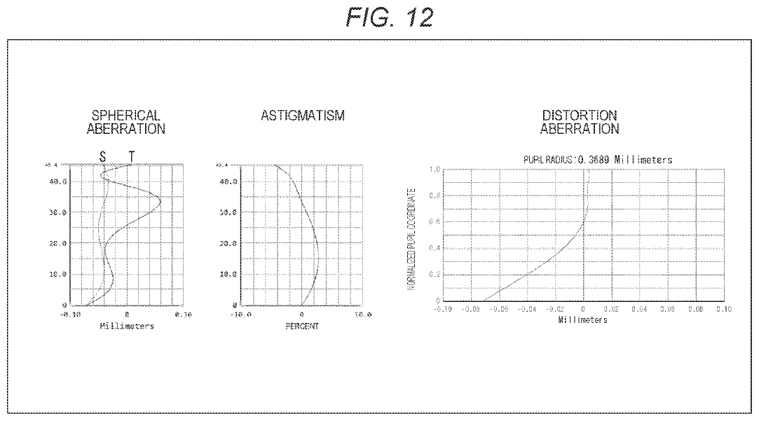

FIG. 12 is a diagram illustrating aberration performance of the lens optical system 1-3, and illustrates a spherical aberration diagram, an astigmatism diagram, and a distortion aberration diagram.

As can be seen from each aberration diagram, the lens optical system 1-3 has various aberrations corrected well and has excellent image forming performance.

<1.4 Fourth Configuration Example of First Embodiment>

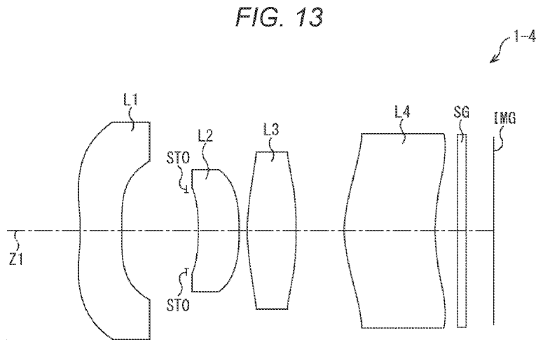

FIG. 13 illustrates a fourth configuration example (Example 4) of the lens optical system 1 in the first embodiment.

A lens optical system 1-4 in FIG. 13 includes the first lens group having a negative refractive power and the second lens group having a positive refractive power, and has a positive refractive power as a whole. The first lens L1 to the fourth lens L4 has negative, negative, positive, and positive refractive power, respectively, in order from the first lens L1 on the object side. Therefore, the second lens L2 has a positive refractive power in the lens optical systems 1-1 to 1-3 described above, but has a negative refractive power in the lens optical system 1-4.

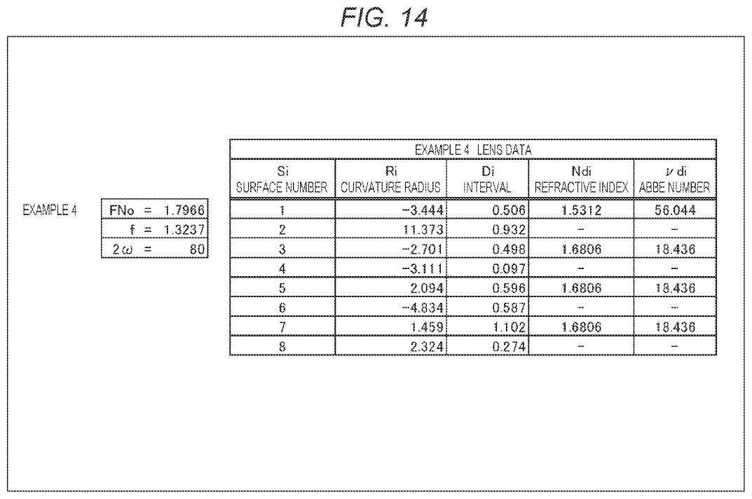

FIG. 14 illustrates specific characteristic data of the lens optical system 1-4 and lens data of the first lens L1 to the fourth lens L4.

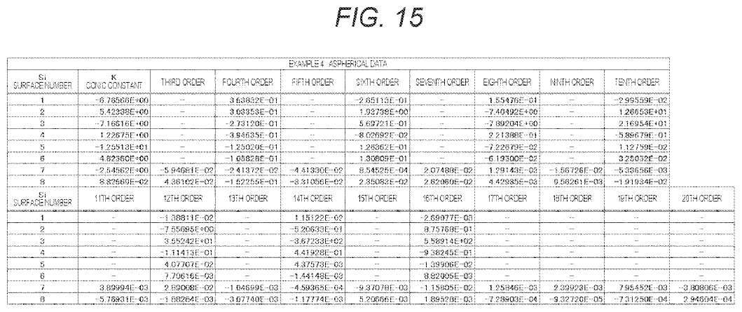

FIG. 15 illustrates a conic constant K of Formula (1) for specifying the aspherical shape of each surface S1 of the lens optical system 1-4 and a value of the i-th order (i is an integer of 3 or more) aspherical coefficient Ai.

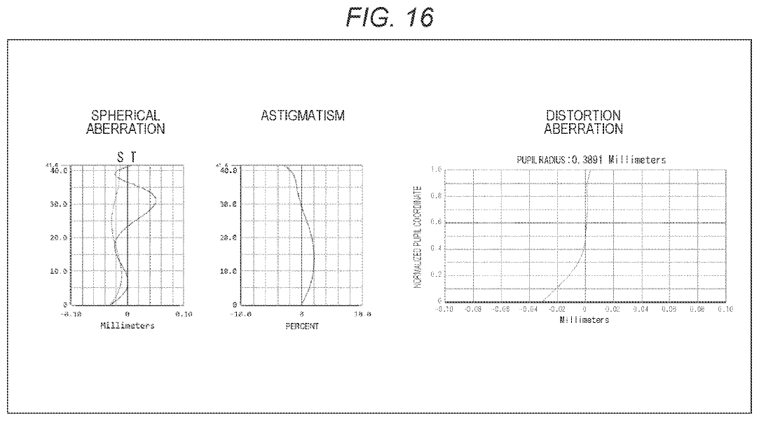

FIG. 16 is a diagram illustrating aberration performance of the lens optical system 1-4, and illustrates a spherical aberration diagram, an astigmatism diagram, and a distortion aberration diagram.

As can be seen from each aberration diagram, the lens optical system 1-4 has various aberrations corrected well and has excellent image forming performance.

<1.5 Fifth Configuration Example of First Embodiment>

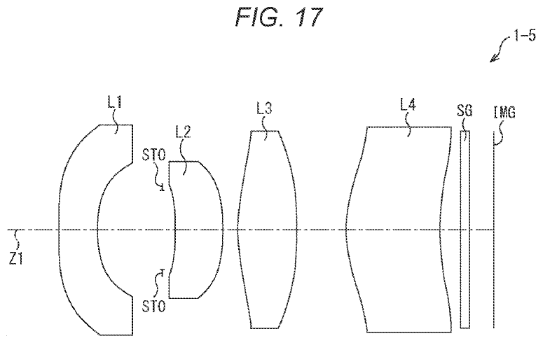

FIG. 17 illustrates a fifth configuration example (Example 5) of the lens optical system 1 in the first embodiment.

A lens optical system 1-5 in FIG. 17 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

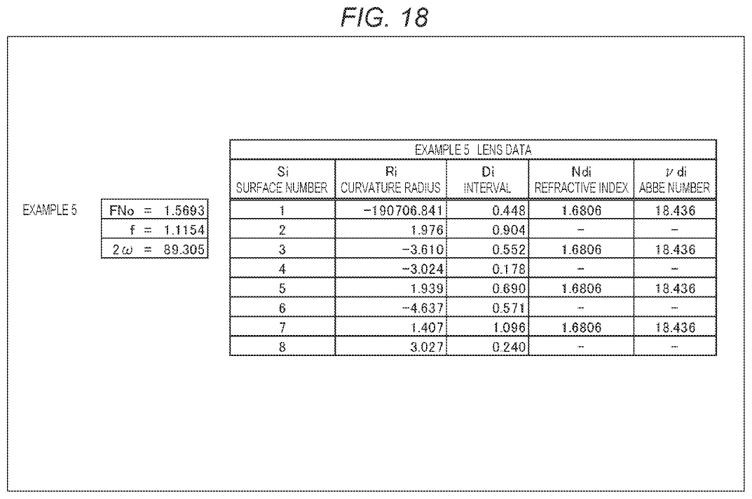

FIG. 18 illustrates specific characteristic data of the lens optical system 1-5 and lens data of the first lens L1 to the fourth lens L4.

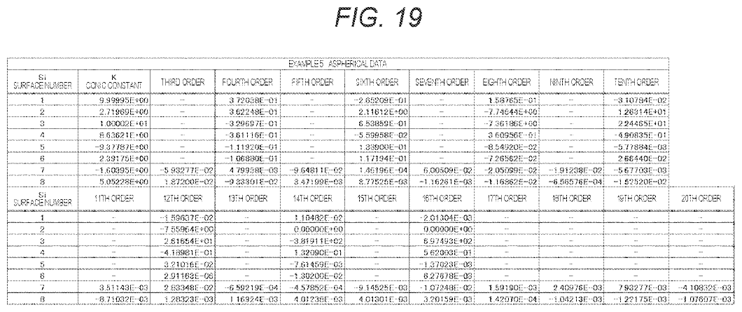

FIG. 19 illustrates a conic constant K of Formula (1) for specifying the aspherical shape of each surface S1 of the lens optical system 1-5 and a value of the i-th order (i is an integer of 3 or more) aspherical coefficient Ai.

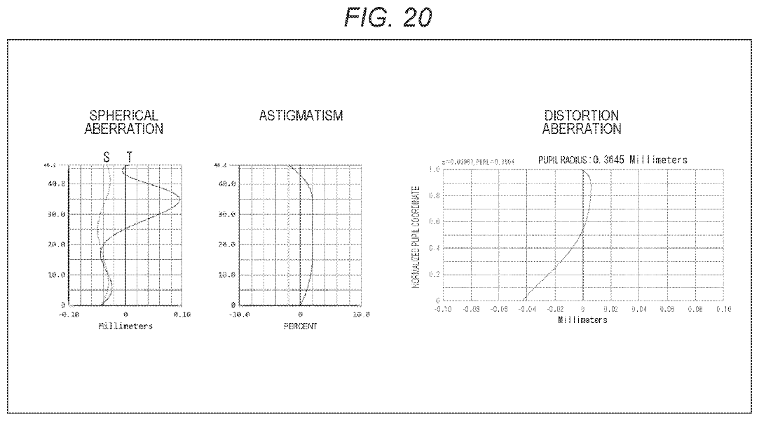

FIG. 20 is a diagram illustrating aberration performance of the lens optical system 1-5, and illustrates a spherical aberration diagram, an astigmatism diagram, and a distortion aberration diagram.

As can be seen from each aberration diagram, the lens optical system 1-5 has various aberrations corrected well and has excellent image forming performance.

<1.6 Sixth Configuration Example of First Embodiment>

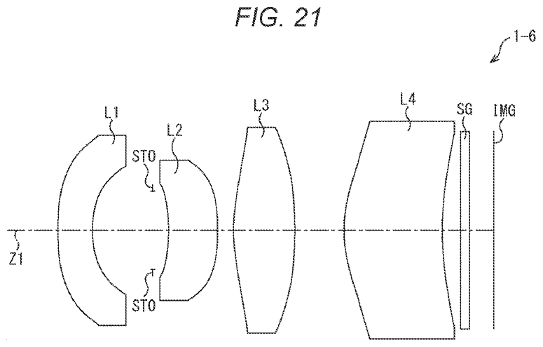

FIG. 21 illustrates a sixth configuration example (Example 6) of the lens optical system 1 in the first embodiment.

A lens optical system 1-6 in FIG. 21 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

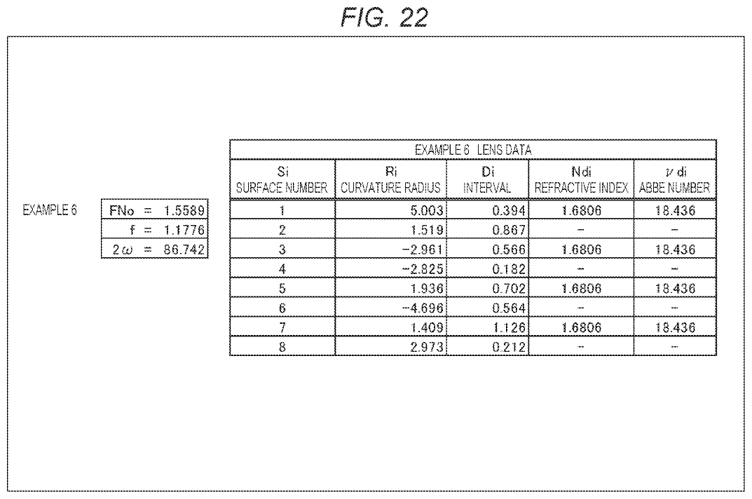

FIG. 22 illustrates specific characteristic data of the lens optical system 1-6 and lens data of the first lens L1 to the fourth lens L4.

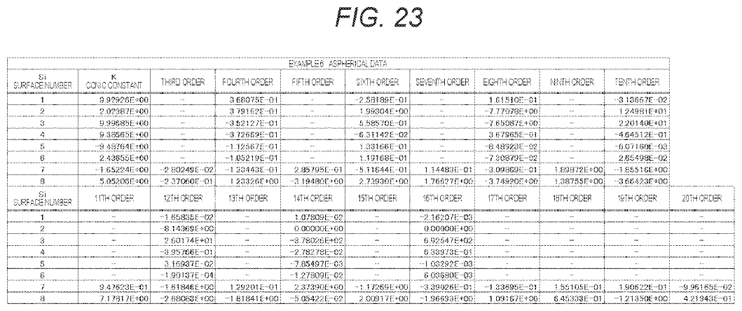

FIG. 23 illustrates a conic constant K of Formula (1) for specifying the aspherical shape of each surface S1 of the lens optical system 1-6 and a value of the i-th order (i is an integer of 3 or more) aspherical coefficient Ai.

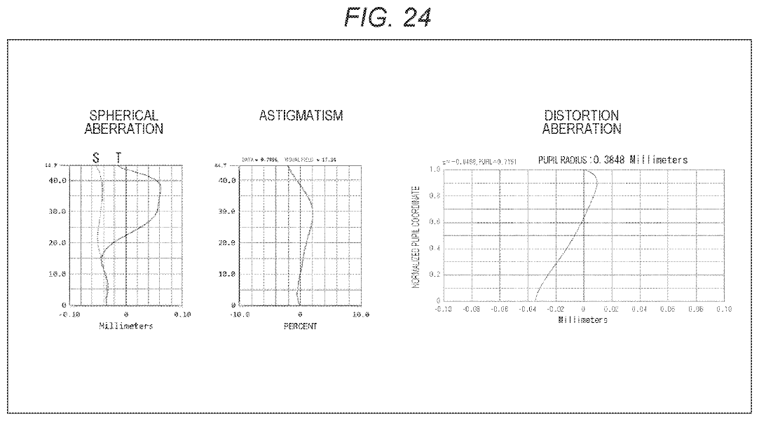

FIG. 24 is a diagram illustrating aberration performance of the lens optical system 1-6, and illustrates a spherical aberration diagram, an astigmatism diagram, and a distortion aberration diagram.

As can be seen from each aberration diagram, the lens optical system 1-6 has various aberrations corrected well and has excellent image forming performance.

<1.7 Seventh Configuration Example of First Embodiment>

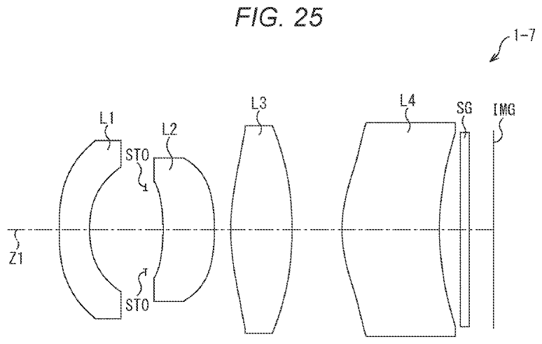

FIG. 25 illustrates a seventh configuration example (Example 7) of the lens optical system 1 in the first embodiment.

A lens optical system 1-7 in FIG. 25 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

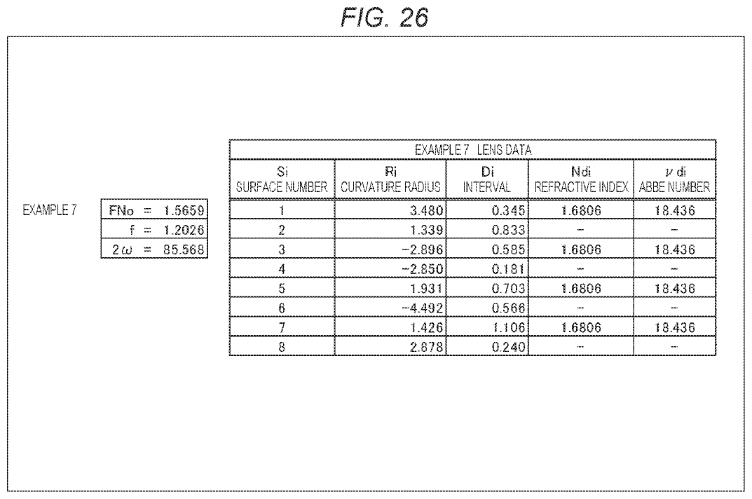

FIG. 26 illustrates specific characteristic data of the lens optical system 1-7 and lens data of the first lens L1 to the fourth lens L4.

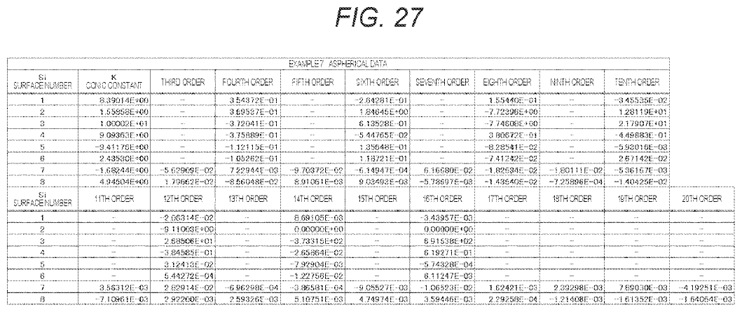

FIG. 27 illustrates a conic constant K of Formula (1) for specifying the aspherical shape of each surface S1 of the lens optical system 1-7 and a value of the i-th order (i is an integer of 3 or more) aspherical coefficient Ai.

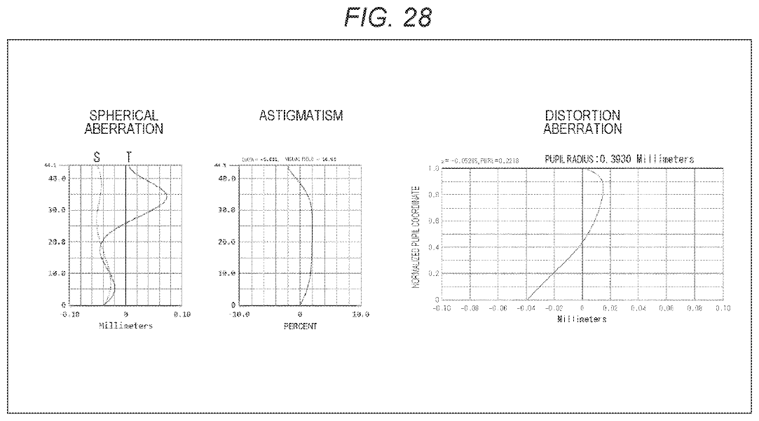

FIG. 28 is a diagram illustrating aberration performance of the lens optical system 1-7, and illustrates a spherical aberration diagram, an astigmatism diagram, and a distortion aberration diagram.

As can be seen from each aberration diagram, the lens optical system 1-7 has various aberrations corrected well and has excellent image forming performance.

<1.8 Eighth Configuration Example of First Embodiment>

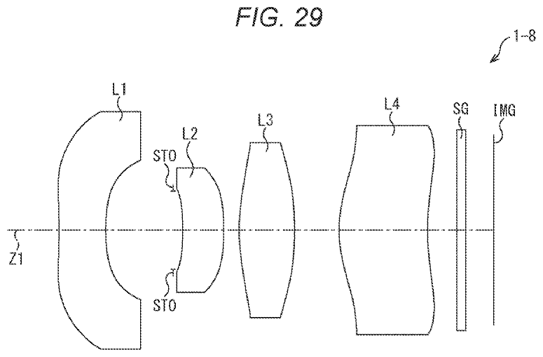

FIG. 29 illustrates an eighth configuration example (Example 8) of the lens optical system 1 in the first embodiment.

A lens optical system 1-8 in FIG. 29 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

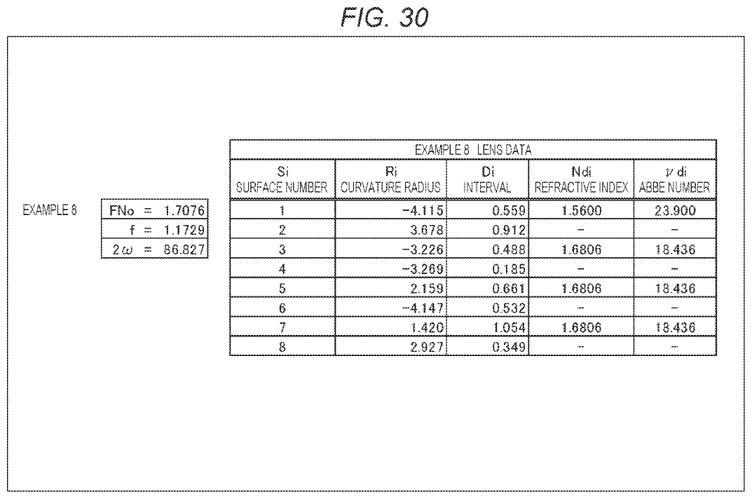

FIG. 30 illustrates specific characteristic data of the lens optical system 1-8 and lens data of the first lens L1 to the fourth lens L4.

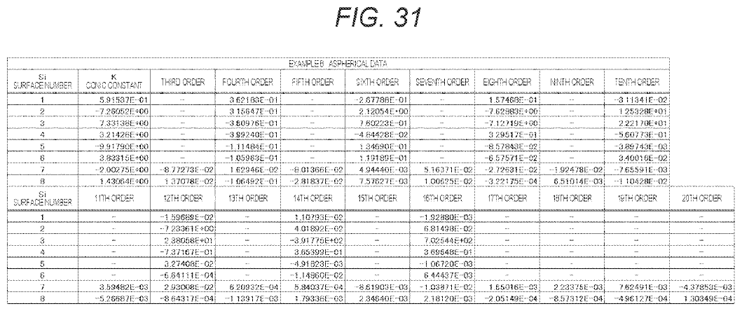

FIG. 31 illustrates a conic constant K of Formula (1) for specifying the aspherical shape of each surface S1 of the lens optical system 1-8 and a value of the i-th order (i is an integer of 3 or more) aspherical coefficient Ai.

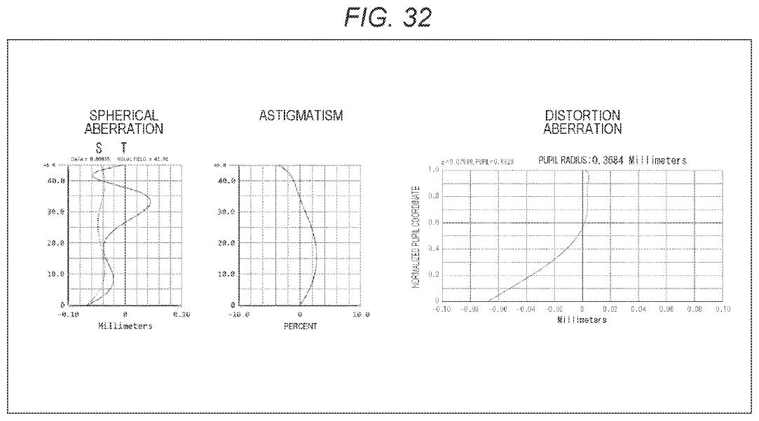

FIG. 32 is a diagram illustrating aberration performance of the lens optical system 1-8, and illustrates a spherical aberration diagram, an astigmatism diagram, and a distortion aberration diagram.

As can be seen from each aberration diagram, the lens optical system 1-8 has various aberrations corrected well and has excellent image forming performance.

<1.9 Ninth Configuration Example of First Embodiment>

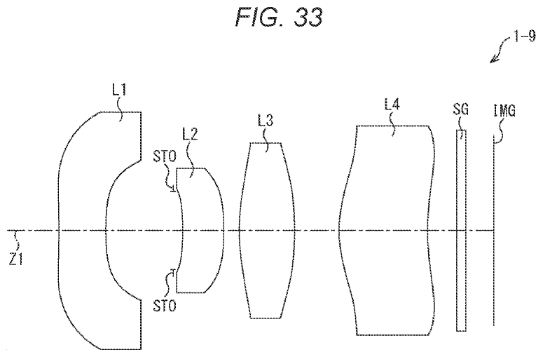

FIG. 33 illustrates a ninth configuration example (Example 9) of the lens optical system 1 in the first embodiment.

A lens optical system 1-9 in FIG. 33 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

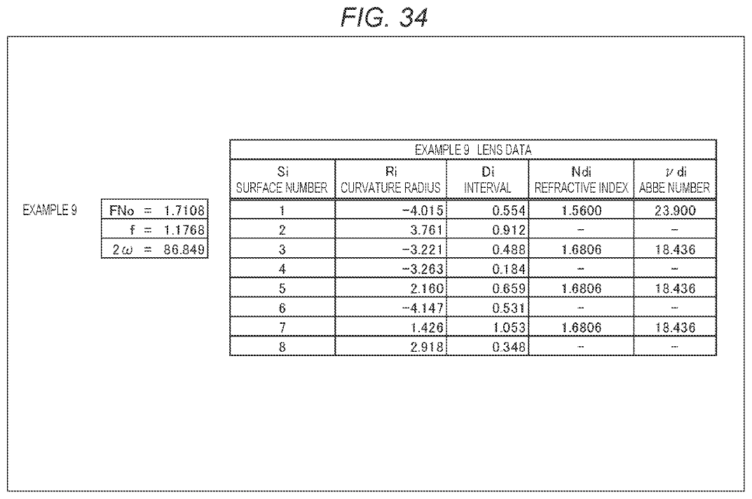

FIG. 34 illustrates specific characteristic data of the lens optical system 1-9 and lens data of the first lens L1 to the fourth lens L4.

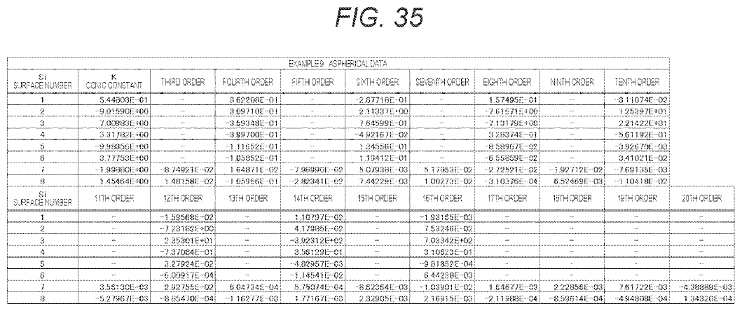

FIG. 35 illustrates a conic constant K of Formula (1) for specifying the aspherical shape of each surface S1 of the lens optical system 1-9 and a value of the i-th order (i is an integer of 3 or more) aspherical coefficient Ai.

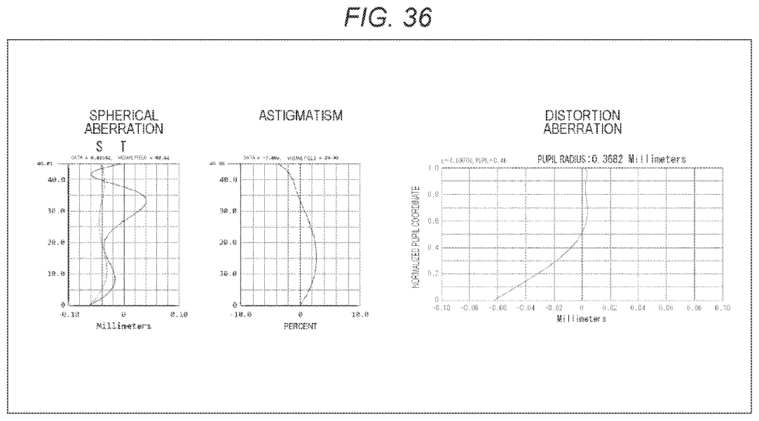

FIG. 36 is a diagram illustrating aberration performance of the lens optical system 1-9, and illustrates a spherical aberration diagram, an astigmatism diagram, and a distortion aberration diagram.

As can be seen from each aberration diagram, the lens optical system 1-9 has various aberrations corrected well and has excellent image forming performance.

<1.10 Tenth Configuration Example of First Embodiment>

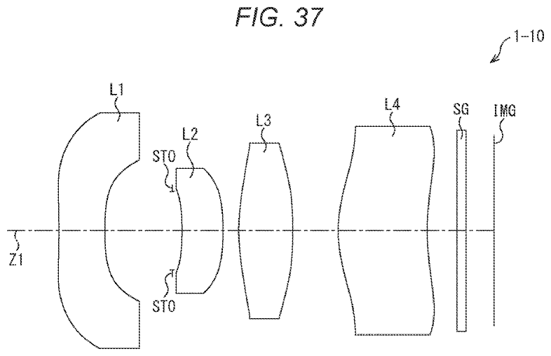

FIG. 37 illustrates a tenth configuration example (Example 10) of the lens optical system 1 in the first embodiment.

A lens optical system 1-10 in FIG. 37 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

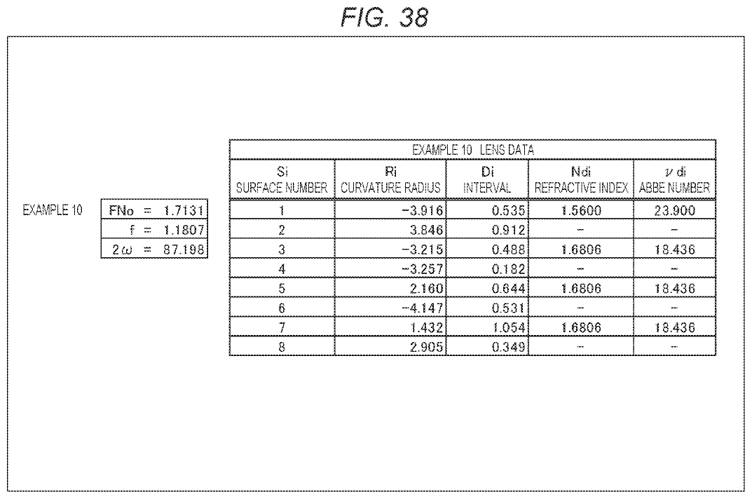

FIG. 38 illustrates specific characteristic data of the lens optical system 1-10 and lens data of the first lens L1 to the fourth lens L4.

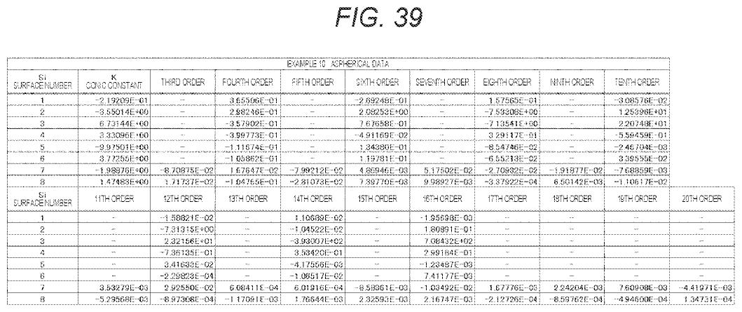

FIG. 39 illustrates a conic constant K of Formula (1) for specifying the aspherical shape of each surface S1 of the lens optical system 1-10 and a value of the i-th order (i is an integer of 3 or more) aspherical coefficient Ai.

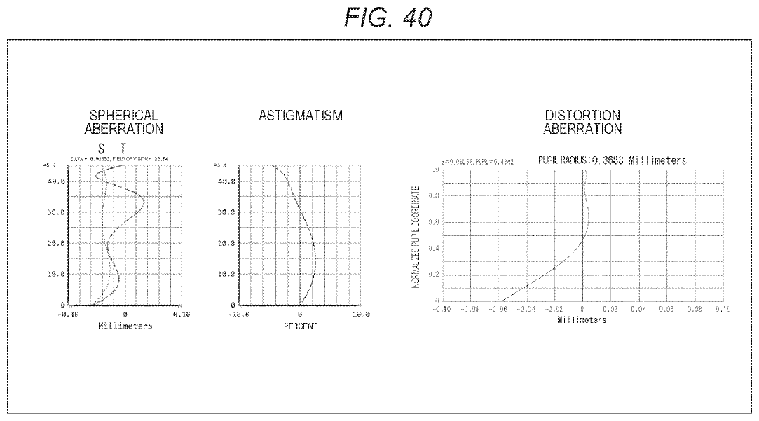

FIG. 40 is a diagram illustrating aberration performance of the lens optical system 1-10, and illustrates a spherical aberration diagram, an astigmatism diagram, and a distortion aberration diagram.

As can be seen from each aberration diagram, the lens optical system 1-10 has various aberrations corrected well and has excellent image forming performance.

<1.11 11th Configuration Example of First Embodiment>

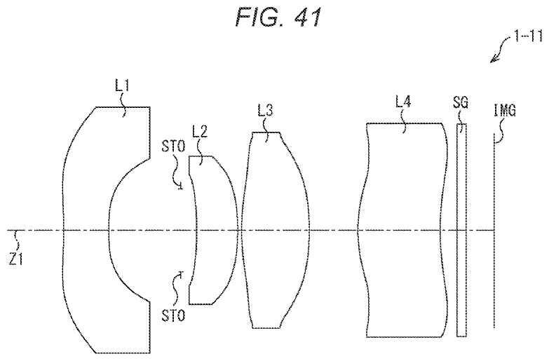

FIG. 41 illustrates an 11th configuration example (Example 11) of the lens optical system 1 in the first embodiment.

A lens optical system 1-11 in FIG. 41 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

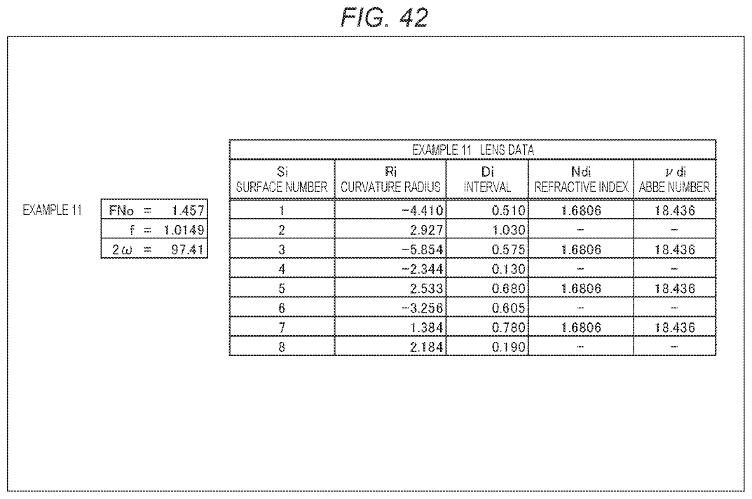

FIG. 42 illustrates specific characteristic data of the lens optical system 1-11 and lens data of the first lens L1 to the fourth lens L4.

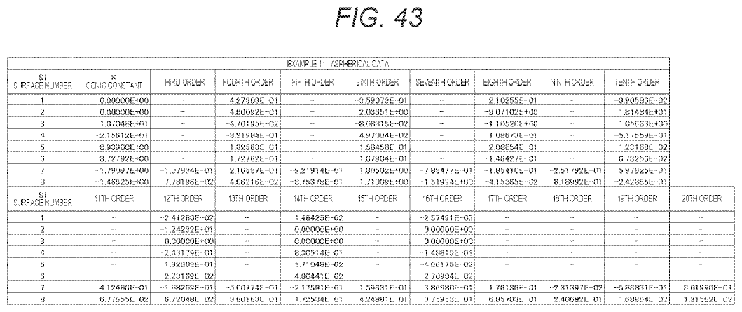

FIG. 43 illustrates a conic constant K of Formula (1) for specifying the aspherical shape of each surface S1 of the lens optical system 1-11 and a value of the i-th order (i is an integer of 3 or more) aspherical coefficient Ai.

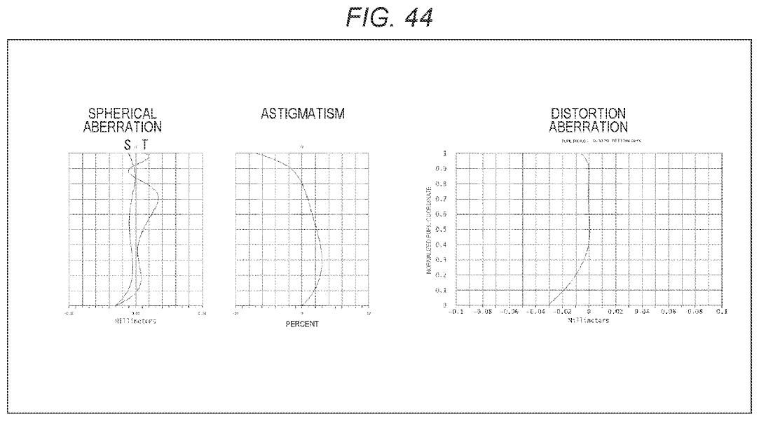

FIG. 44 is a diagram illustrating aberration performance of the lens optical system 1-11, and illustrates a spherical aberration diagram, an astigmatism diagram, and a distortion aberration diagram.

As can be seen from each aberration diagram, the lens optical system 1-11 has various aberrations corrected well and has excellent image forming performance.

<1.12 12th Configuration Example of First Embodiment>

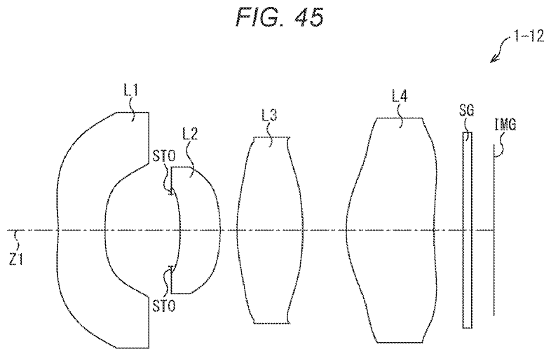

FIG. 45 illustrates a 12th configuration example (Example 12) of the lens optical system 1 in the first embodiment.

A lens optical system 1-12 in FIG. 45 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

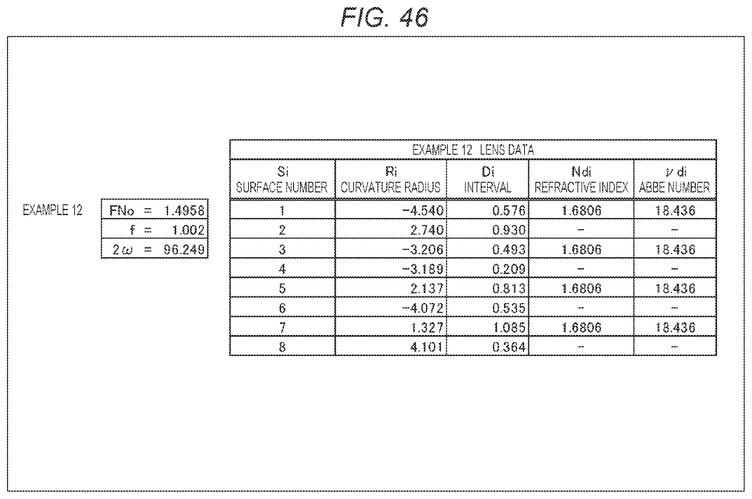

FIG. 46 illustrates specific characteristic data of the lens optical system 1-12 and lens data of the first lens L1 to the fourth lens L4.

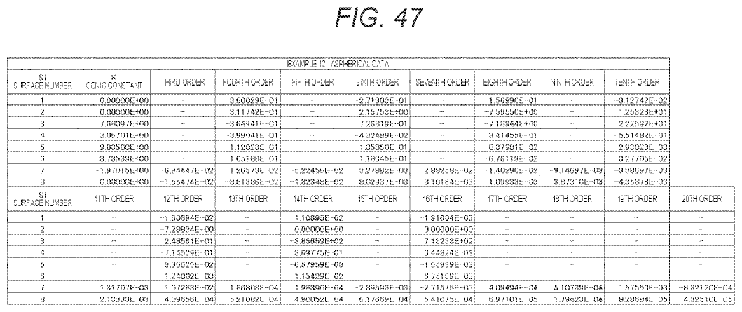

FIG. 47 illustrates a conic constant K of Formula (1) for specifying the aspherical shape of each surface S1 of the lens optical system 1-12 and a value of the i-th order (i is an integer of 3 or more) aspherical coefficient Ai.

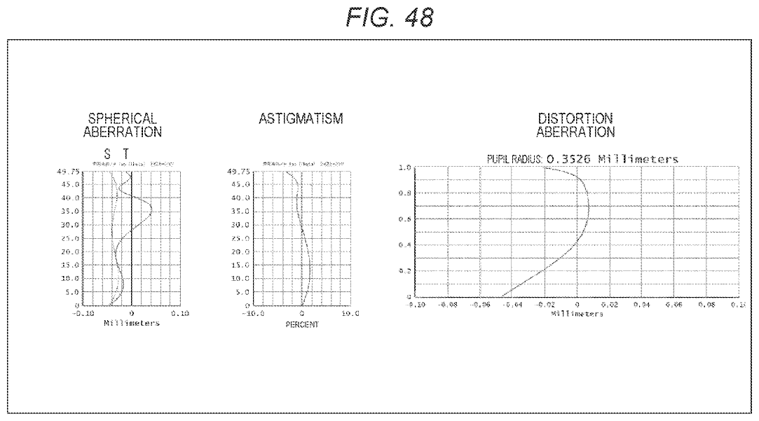

FIG. 48 is a diagram illustrating aberration performance of the lens optical system 1-12, and illustrates a spherical aberration diagram, an astigmatism diagram, and a distortion aberration diagram.

As can be seen from each aberration diagram, the lens optical system 1-12 has various aberrations corrected well and has excellent image forming performance.

<1.13 13th Configuration Example of First Embodiment>

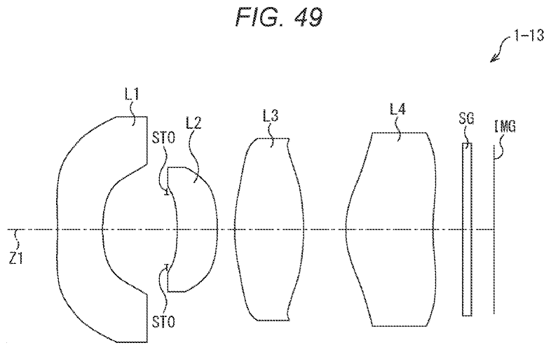

FIG. 49 illustrates a 13th configuration example (Example 13) of the lens optical system 1 in the first embodiment.

A lens optical system 1-13 in FIG. 49 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

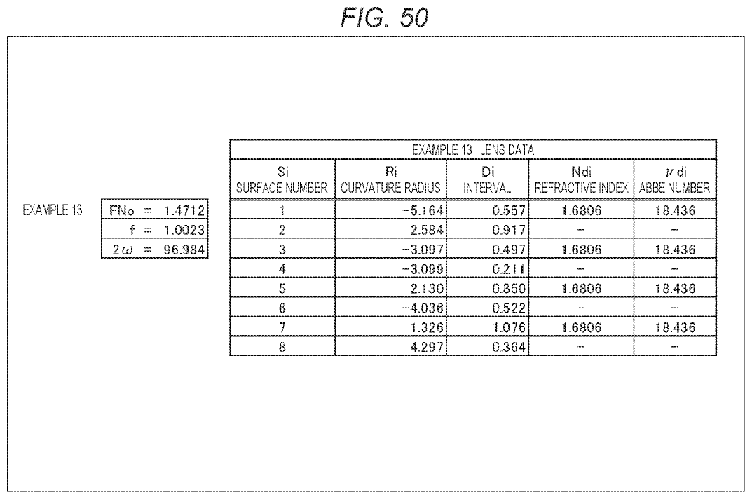

FIG. 50 illustrates specific characteristic data of the lens optical system 1-13 and lens data of the first lens L1 to the fourth lens L4.

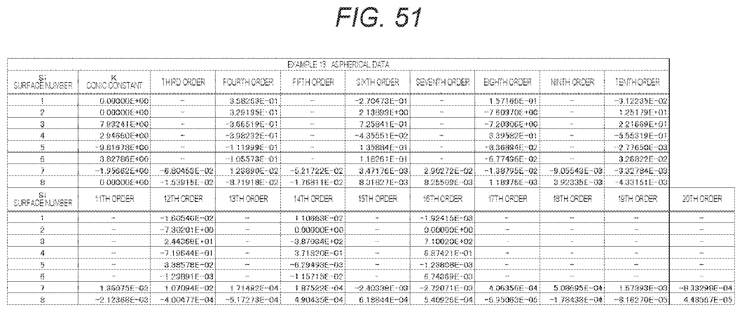

FIG. 51 illustrates a conic constant K of Formula (1) for specifying the aspherical shape of each surface S1 of the lens optical system 1-13 and a value of the i-th order (i is an integer of 3 or more) aspherical coefficient Ai.

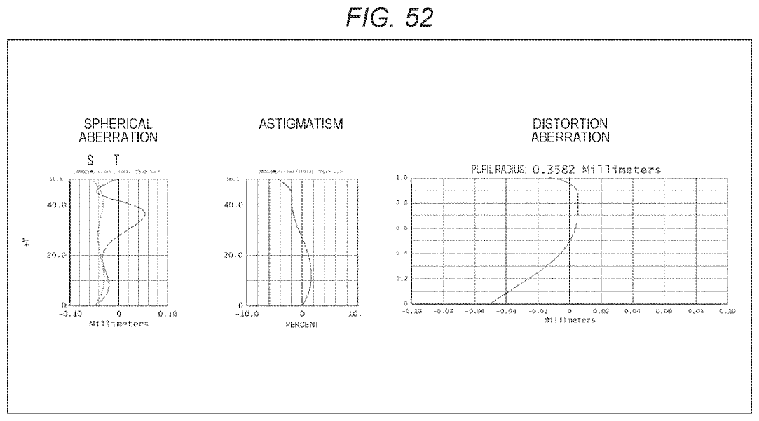

FIG. 52 is a diagram illustrating aberration performance of the lens optical system 1-13, and illustrates a spherical aberration diagram, an astigmatism diagram, and a distortion aberration diagram.

As can be seen from each aberration diagram, the lens optical system 1-13 has various aberrations corrected well and has excellent image forming performance.

<1.14 14th Configuration Example of First Embodiment>

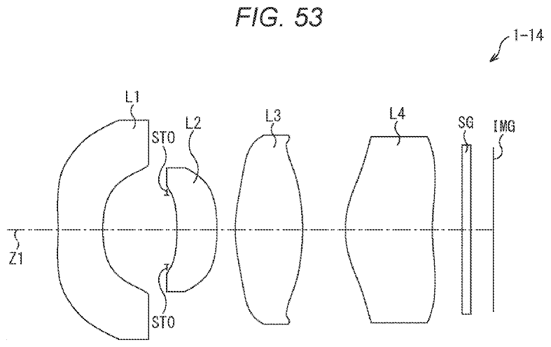

FIG. 53 illustrates a 14th configuration example (Example 14) of the lens optical system 1 in the first embodiment.

A lens optical system 1-14 in FIG. 53 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

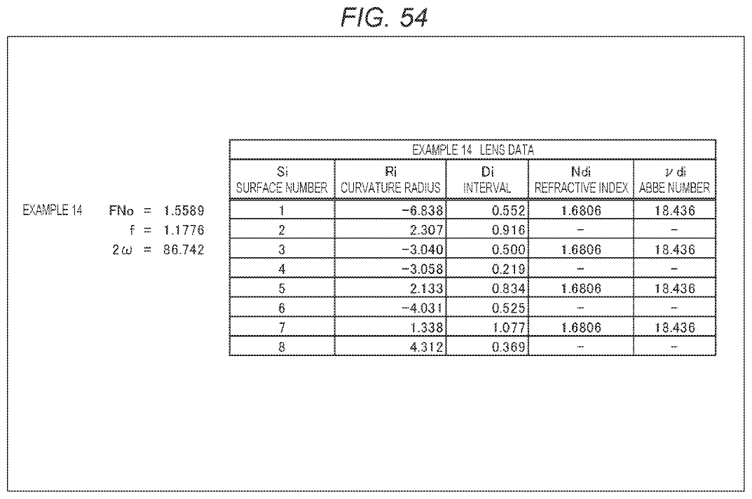

FIG. 54 illustrates specific characteristic data of the lens optical system 1-14 and lens data of the first lens L1 to the fourth lens L4.

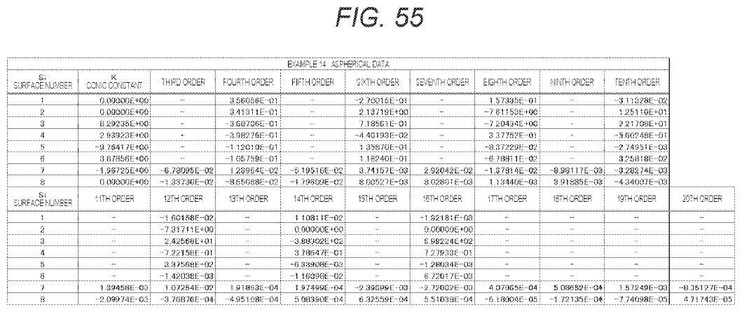

FIG. 55 illustrates a conic constant K of Formula (1) for specifying the aspherical shape of each surface S1 of the lens optical system 1-14 and a value of the i-th order (i is an integer of 3 or more) aspherical coefficient Ai.

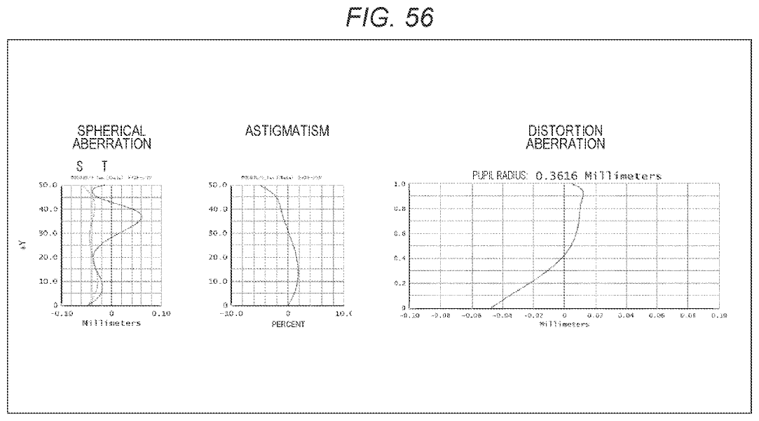

FIG. 56 is a diagram illustrating aberration performance of the lens optical system 1-14, and illustrates a spherical aberration diagram, an astigmatism diagram, and a distortion aberration diagram.

As can be seen from each aberration diagram, the lens optical system 1-14 has various aberrations corrected well and has excellent image forming performance.

<1.15 15th Configuration Example of First Embodiment>

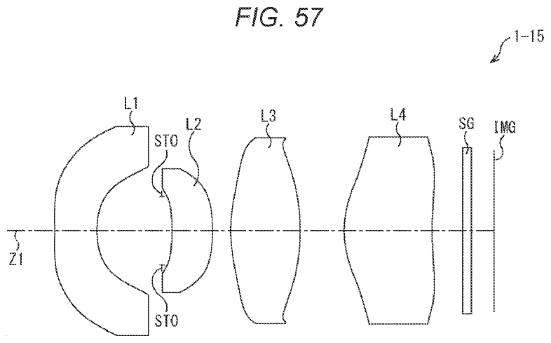

FIG. 57 illustrates a 15th configuration example (Example 15) of the lens optical system 1 in the first embodiment.

A lens optical system 1-15 in FIG. 57 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

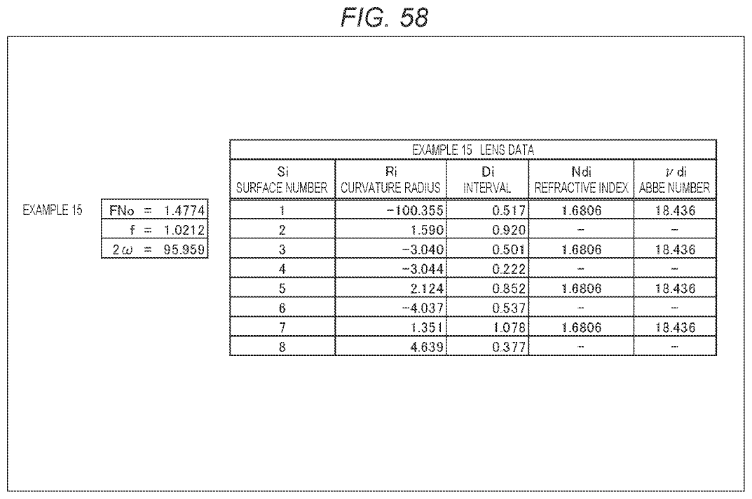

FIG. 58 illustrates specific characteristic data of the lens optical system 1-15 and lens data of the first lens L1 to the fourth lens L4.

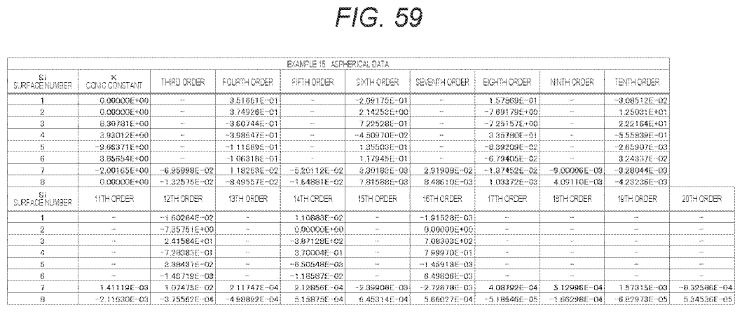

FIG. 59 illustrates a conic constant K of Formula (1) for specifying the aspherical shape of each surface S1 of the lens optical system 1-15 and a value of the i-th order (i is an integer of 3 or more) aspherical coefficient Ai.

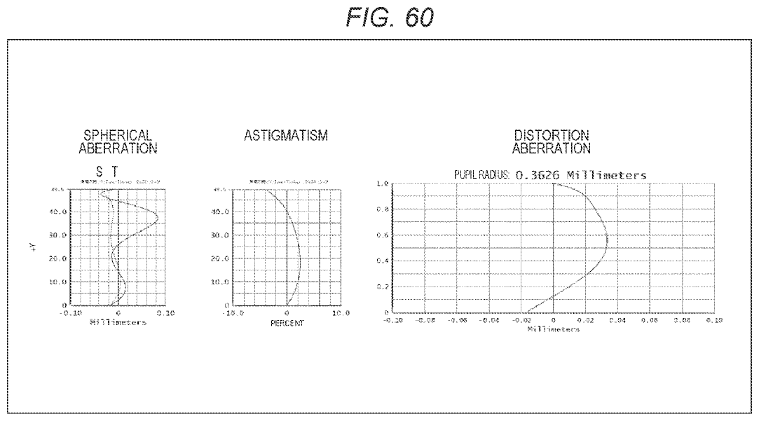

FIG. 60 is a diagram illustrating aberration performance of the lens optical system 1-15, and illustrates a spherical aberration diagram, an astigmatism diagram, and a distortion aberration diagram.

As can be seen from each aberration diagram, the lens optical system 1-15 has various aberrations corrected well and has excellent image forming performance.

<1.16 16th Configuration Example of First Embodiment>

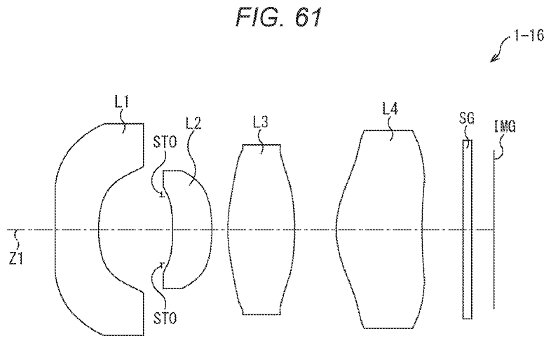

FIG. 61 illustrates a 16th configuration example (Example 16) of the lens optical system 1 in the first embodiment.

A lens optical system 1-16 in FIG. 61 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

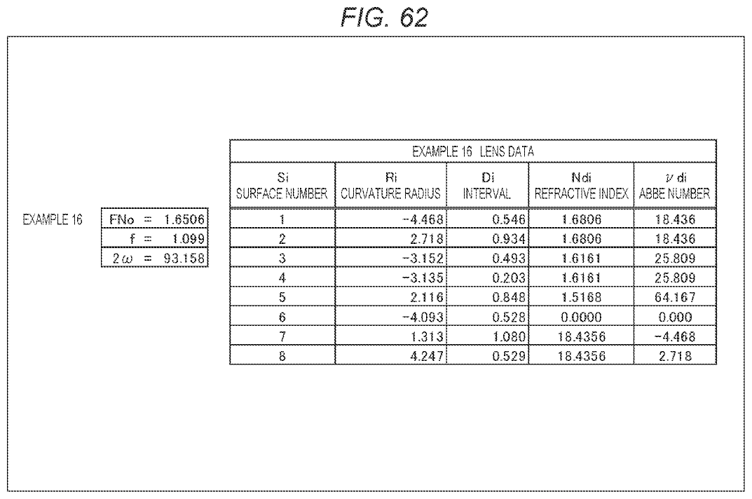

FIG. 62 illustrates specific characteristic data of the lens optical system 1-16 and lens data of the first lens L1 to the fourth lens L4.

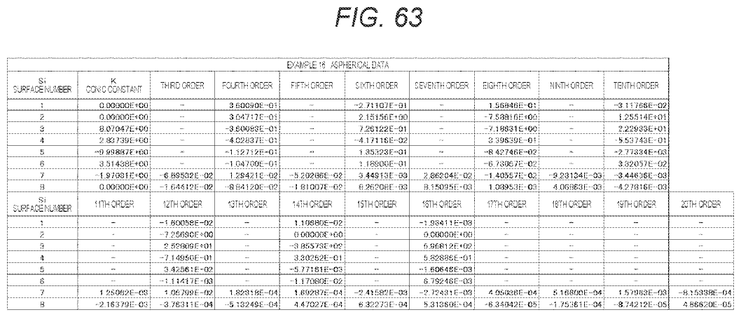

FIG. 63 illustrates a conic constant K of Formula (1) for specifying the aspherical shape of each surface S1 of the lens optical system 1-16 and a value of the i-th order (i is an integer of 3 or more) aspherical coefficient Ai.

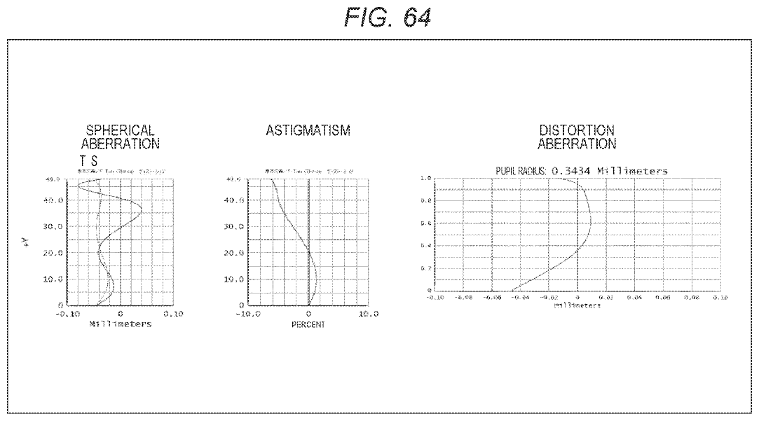

FIG. 64 is a diagram illustrating aberration performance of the lens optical system 1-16, and illustrates a spherical aberration diagram, an astigmatism diagram, and a distortion aberration diagram.

As can be seen from each aberration diagram, the lens optical system 1-16 has various aberrations corrected well and has excellent image forming performance.

<1.17 17th Configuration Example of First Embodiment>

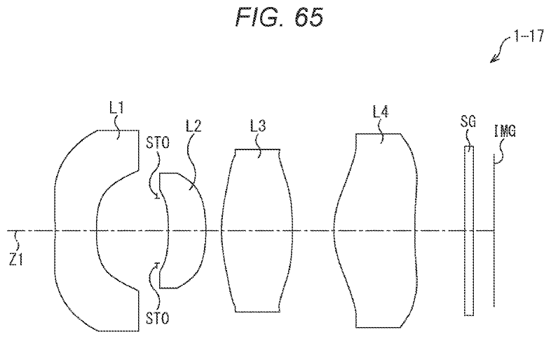

FIG. 65 illustrates a 17th configuration example (Example 17) of the lens optical system 1 in the first embodiment.

A lens optical system 1-17 in FIG. 65 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

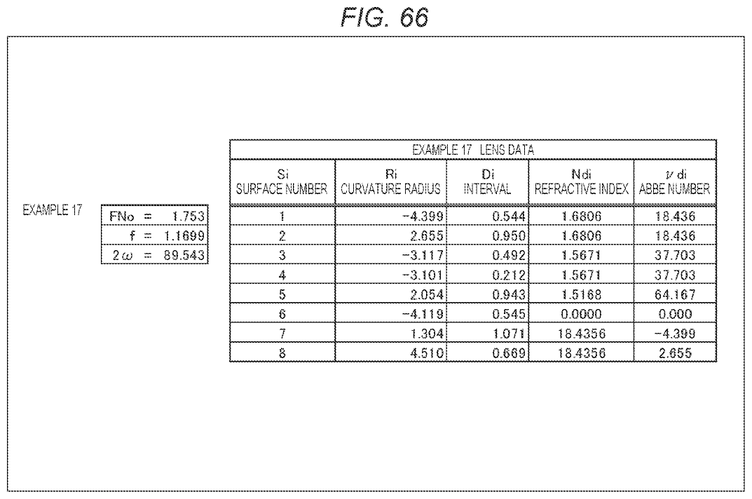

FIG. 66 illustrates specific characteristic data of the lens optical system 1-17 and lens data of the first lens L1 to the fourth lens L4.

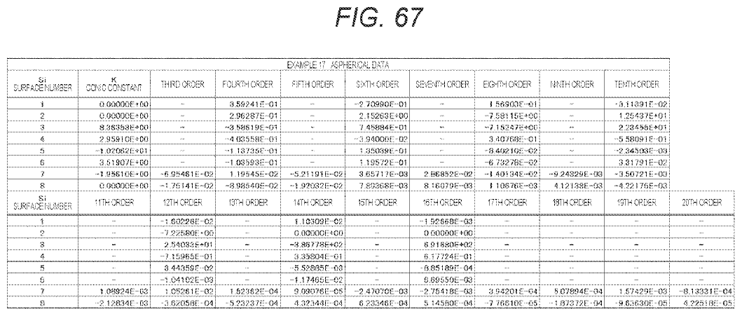

FIG. 67 illustrates a conic constant K of Formula (1) for specifying the aspherical shape of each surface S1 of the lens optical system 1-17 and a value of the i-th order (i is an integer of 3 or more) aspherical coefficient Ai.

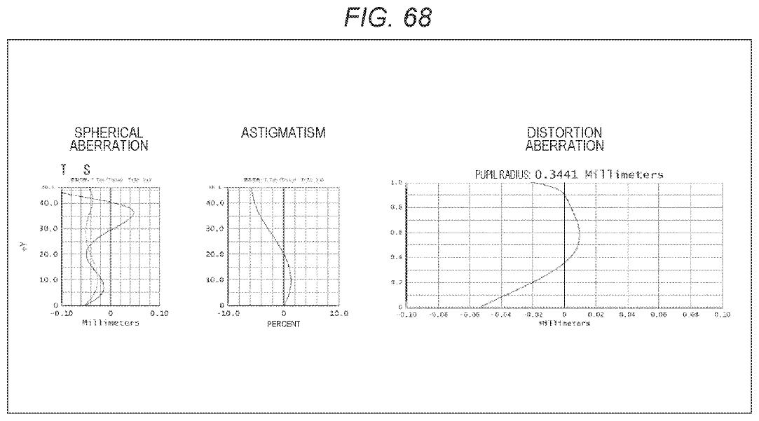

FIG. 68 is a diagram illustrating aberration performance of the lens optical system 1-17, and illustrates a spherical aberration diagram, an astigmatism diagram, and a distortion aberration diagram.

As can be seen from each aberration diagram, the lens optical system 1-17 has various aberrations corrected well and has excellent image forming performance.

<1.18 18th Configuration Example of First Embodiment>

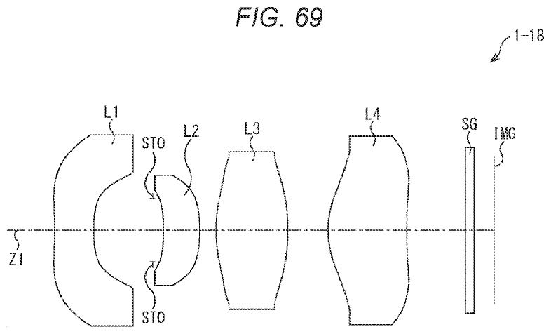

FIG. 69 illustrates an 18th configuration example (Example 18) of the lens optical system 1 in the first embodiment.

A lens optical system 1-18 in FIG. 69 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

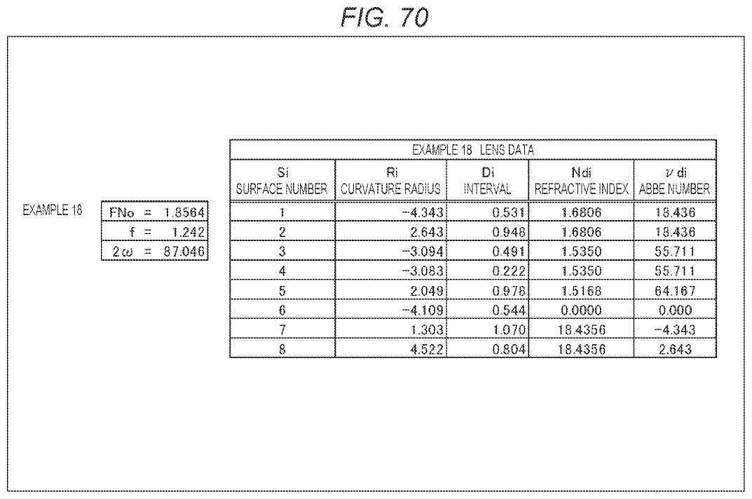

FIG. 70 illustrates specific characteristic data of the lens optical system 1-18 and lens data of the first lens L1 to the fourth lens L4.

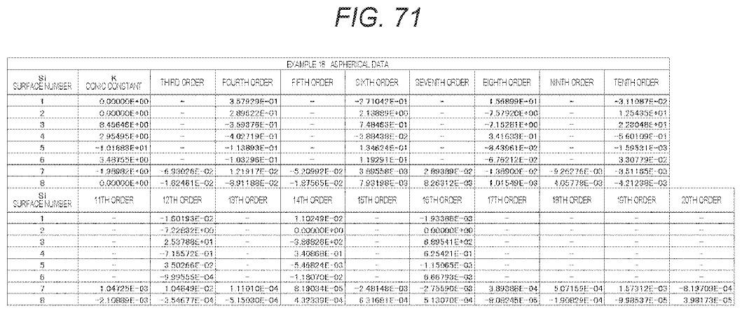

FIG. 71 illustrates a conic constant K of Formula (1) for specifying the aspherical shape of each surface S1 of the lens optical system 1-18 and a value of the i-th order (i is an integer of 3 or more) aspherical coefficient Ai.

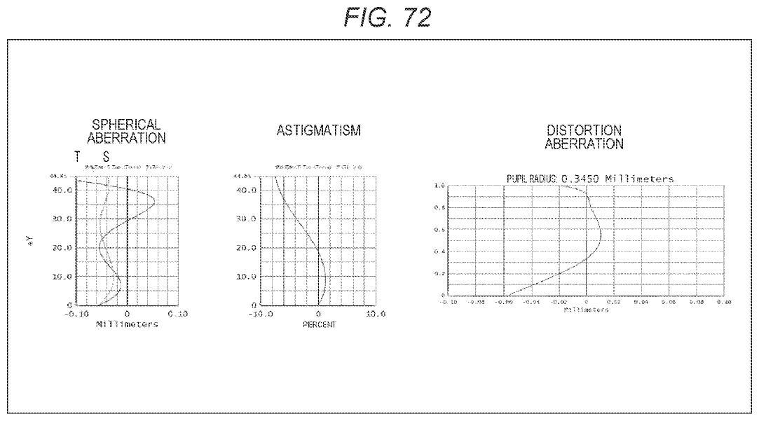

FIG. 72 is a diagram illustrating aberration performance of the lens optical system 1-18, and illustrates a spherical aberration diagram, an astigmatism diagram, and a distortion aberration diagram.

As can be seen from each aberration diagram, the lens optical system 1-18 has various aberrations corrected well and has excellent image forming performance.

<1.19 19th Configuration Example of First Embodiment>

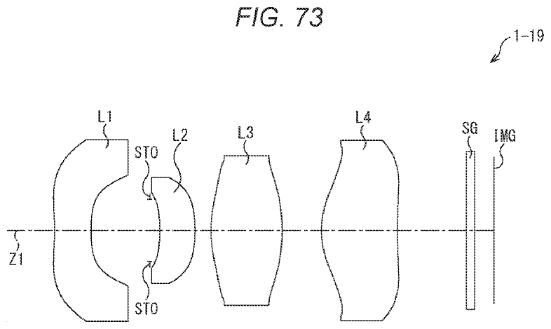

FIG. 73 illustrates a 19th configuration example (Example 19) of the lens optical system 1 in the first embodiment.

A lens optical system 1-19 in FIG. 73 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

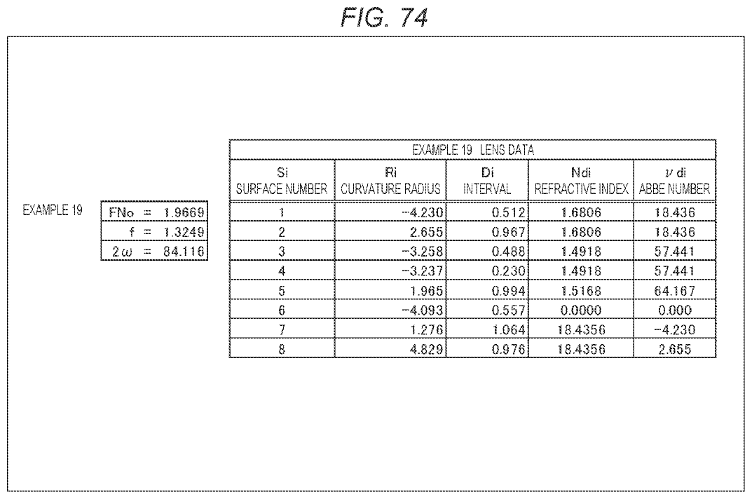

FIG. 74 illustrates specific characteristic data of the lens optical system 1-19 and lens data of the first lens L1 to the fourth lens L4.

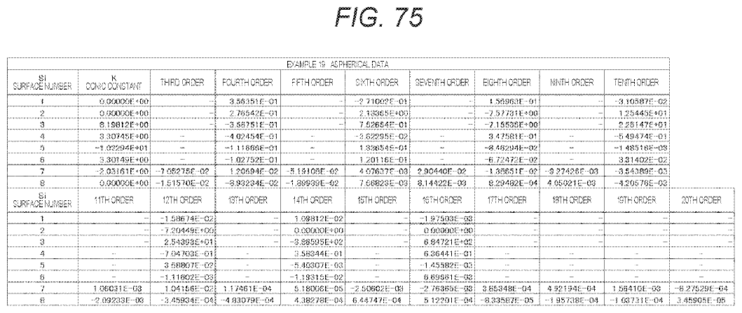

FIG. 75 illustrates a conic constant K of Formula (1) for specifying the aspherical shape of each surface S1 of the lens optical system 1-19 and a value of the i-th order (i is an integer of 3 or more) aspherical coefficient Ai.

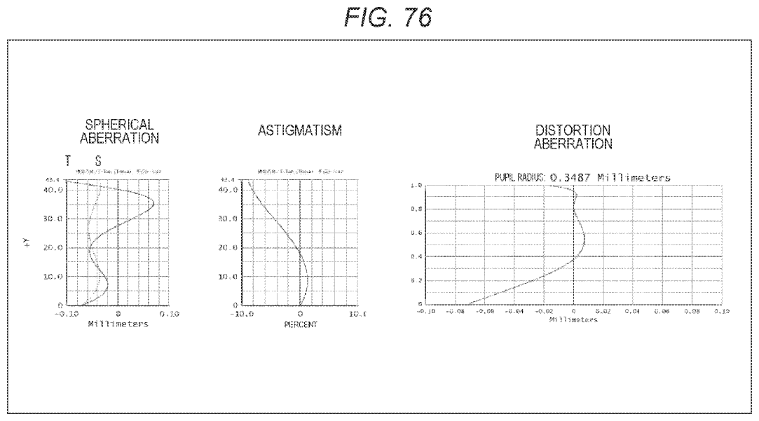

FIG. 76 is a diagram illustrating aberration performance of the lens optical system 1-19, and illustrates a spherical aberration diagram, an astigmatism diagram, and a distortion aberration diagram.

As can be seen from each aberration diagram, the lens optical system 1-19 has various aberrations corrected well and has excellent image forming performance.

<1.20 20th Configuration Example of First Embodiment>

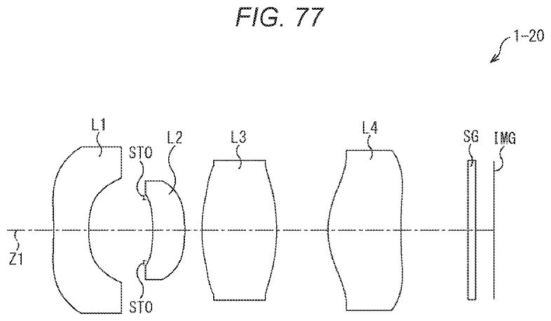

FIG. 77 illustrates a 20th configuration example (Example 20) of the lens optical system 1 in the first embodiment.

A lens optical system 1-20 in FIG. 77 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

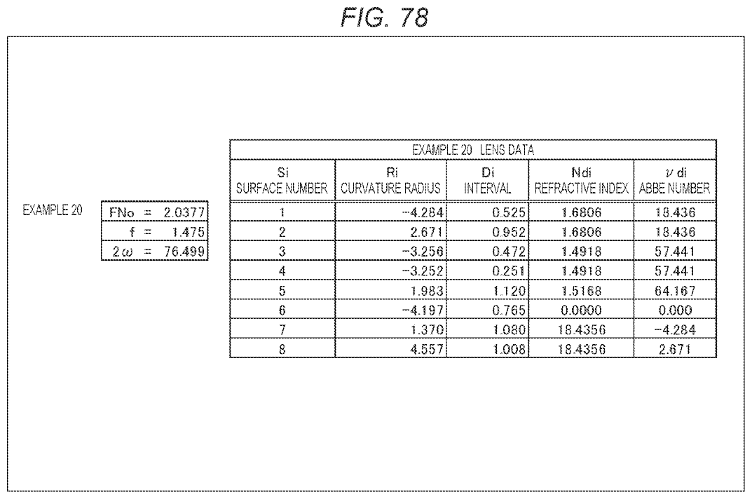

FIG. 78 illustrates specific characteristic data of the lens optical system 1-20 and lens data of the first lens L1 to the fourth lens L4.

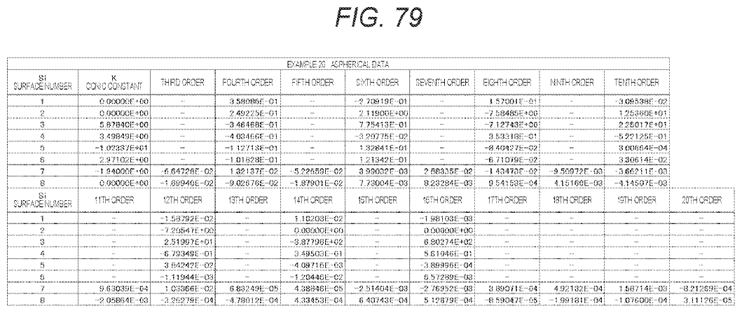

FIG. 79 illustrates a conic constant K of Formula (1) for specifying the aspherical shape of each surface S1 of the lens optical system 1-20 and a value of the i-th order (i is an integer of 3 or more) aspherical coefficient Ai.

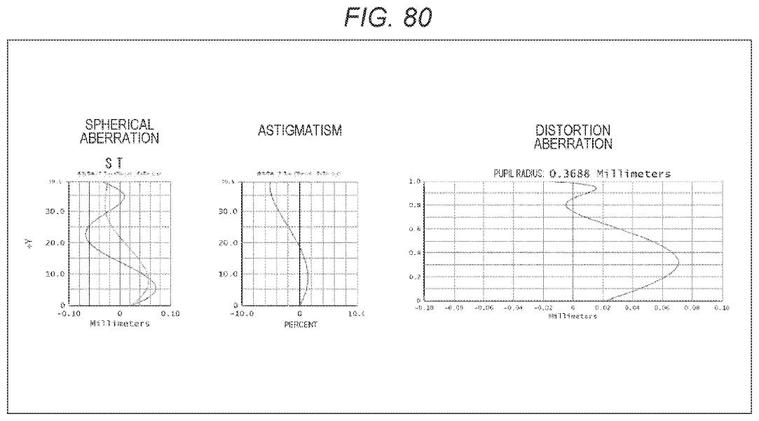

FIG. 80 is a diagram illustrating aberration performance of the lens optical system 1-20, and illustrates a spherical aberration diagram, an astigmatism diagram, and a distortion aberration diagram.

As can be seen from each aberration diagram, the lens optical system 1-20 has various aberrations corrected well and has excellent image forming performance.

<1.21 21st Configuration Example of First Embodiment>

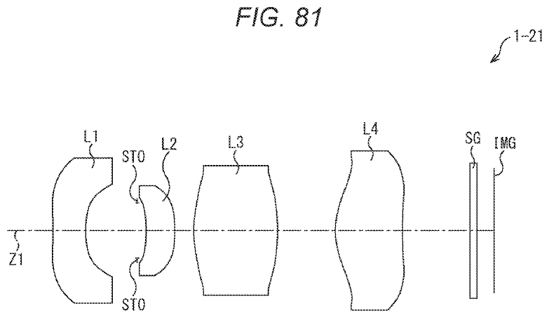

FIG. 81 illustrates a 21st configuration example (Example 21) of the lens optical system 1 in the first embodiment.

A lens optical system 1-21 in FIG. 81 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

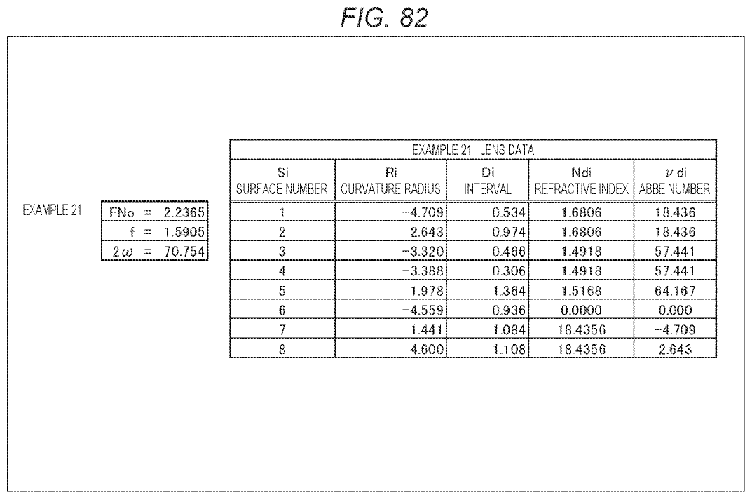

FIG. 82 illustrates specific characteristic data of the lens optical system 1-21 and lens data of the first lens L1 to the fourth lens L4.

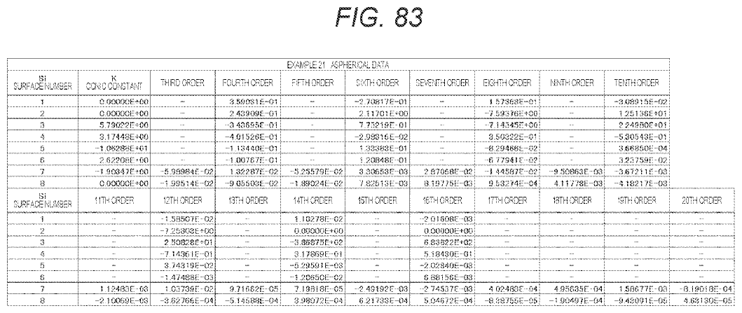

FIG. 83 illustrates a conic constant K of Formula (1) for specifying the aspherical shape of each surface S1 of the lens optical system 1-21 and a value of the i-th order (i is an integer of 3 or more) aspherical coefficient Ai.

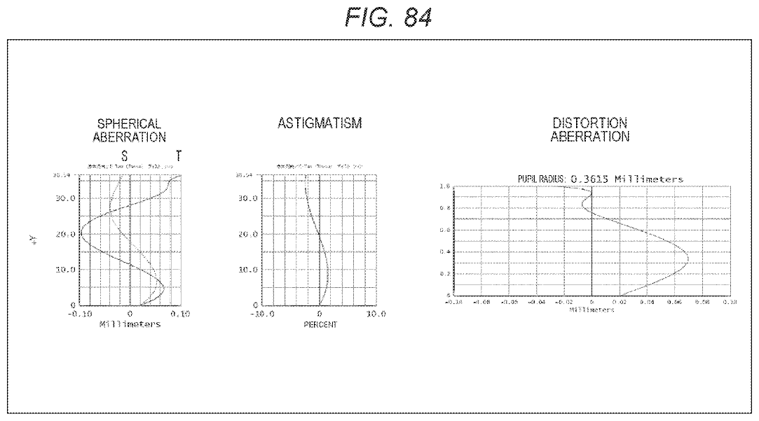

FIG. 84 is a diagram illustrating aberration performance of the lens optical system 1-21, and illustrates a spherical aberration diagram, an astigmatism diagram, and a distortion aberration diagram.

As can be seen from each aberration diagram, the lens optical system 1-21 has various aberrations corrected well and has excellent image forming performance.

<1.22 22nd Configuration Example of First Embodiment>

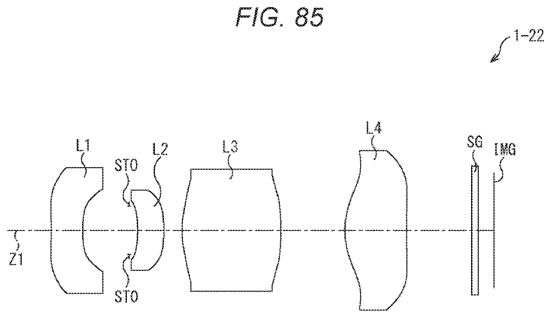

FIG. 85 illustrates a 22nd configuration example (Example 22) of the lens optical system 1 in the first embodiment.

A lens optical system 1-22 in FIG. 85 includes the first lens group having a negative refractive power and the second lens group having a positive refractive power, and has a positive refractive power as a whole. The first lens L1 to the fourth lens L4 has negative, negative, positive, and positive refractive power, respectively, in order from the first lens L1 on the object side. Therefore, in the lens optical system 1-22, similarly to the lens optical system 1-4 in FIG. 13 described above, the second lens L2 has a negative refractive power.

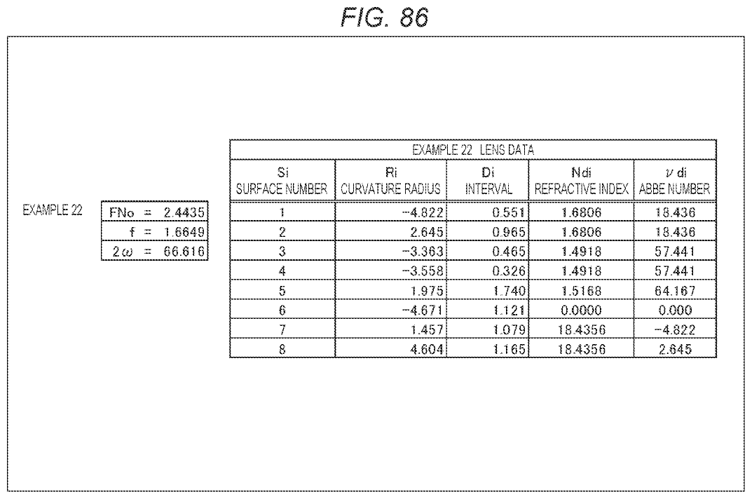

FIG. 86 illustrates specific characteristic data of the lens optical system 1-22 and lens data of the first lens L1 to the fourth lens L4.

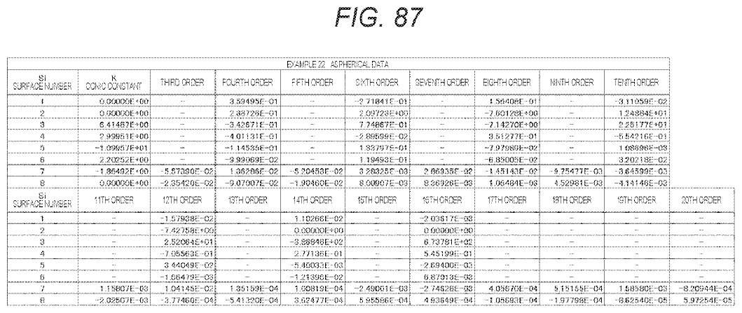

FIG. 87 illustrates a conic constant K of Formula (1) for specifying the aspherical shape of each surface S1 of the lens optical system 1-22 and a value of the i-th order (i is an integer of 3 or more) aspherical coefficient Ai.

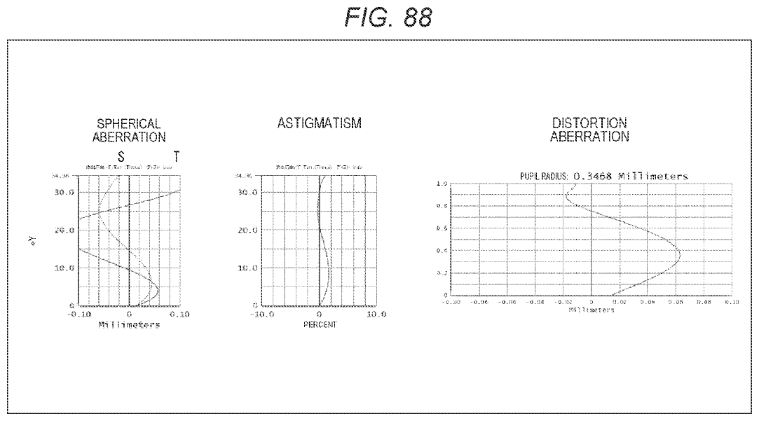

FIG. 88 is a diagram illustrating aberration performance of the lens optical system 1-22, and illustrates a spherical aberration diagram, an astigmatism diagram, and a distortion aberration diagram.

As can be seen from each aberration diagram, the lens optical system 1-22 has various aberrations corrected well and has excellent image forming performance.

<1.23 23rd Configuration Example of First Embodiment>

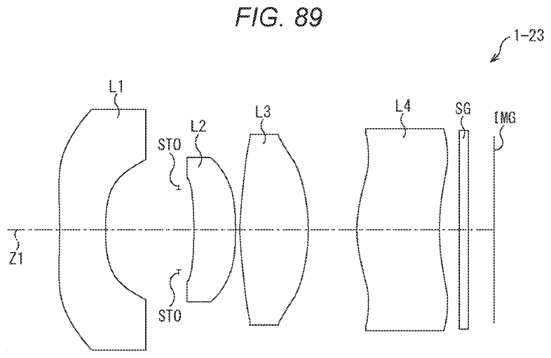

FIG. 89 illustrates a 23rd configuration example (Example 23) of the lens optical system 1 in the first embodiment.

A lens optical system 1-23 in FIG. 89 includes the first lens group having a negative refractive power and the second lens group having a positive refractive power, and has a positive refractive power as a whole. The first lens L1 to the fourth lens L4 has negative, negative, positive, and positive refractive power, respectively, in order from the first lens L1 on the object side. Therefore, in the lens optical system 1-23, similarly to the lens optical system 1-22 in FIG. 85 described above, the second lens L2 has a negative refractive power.

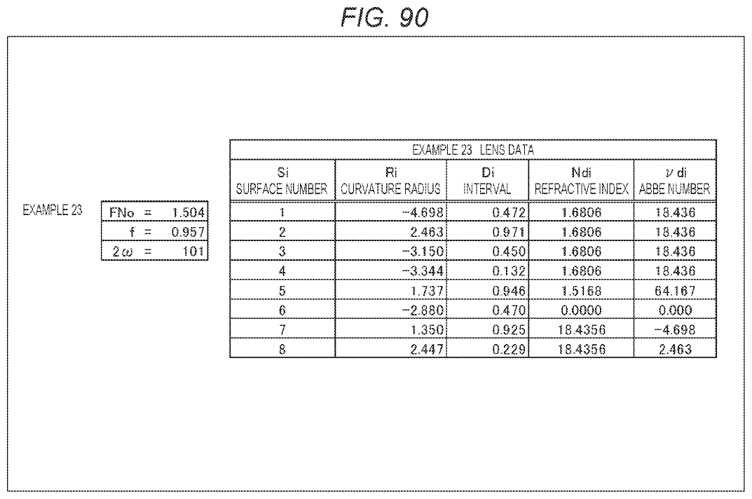

FIG. 90 illustrates specific characteristic data of the lens optical system 1-23 and lens data of the first lens L1 to the fourth lens L4.

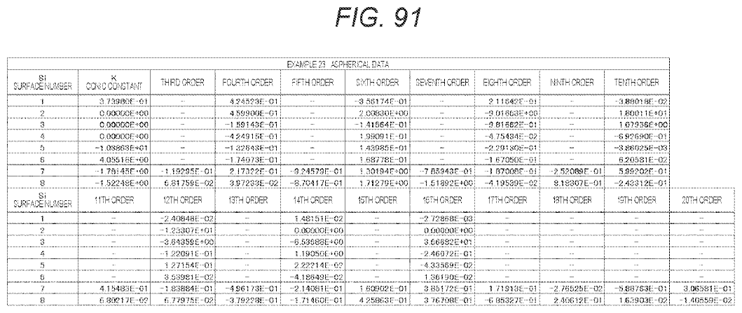

FIG. 91 illustrates a conic constant K of Formula (1) for specifying the aspherical shape of each surface S1 of the lens optical system 1-23 and a value of the i-th order (i is an integer of 3 or more) aspherical coefficient Ai.

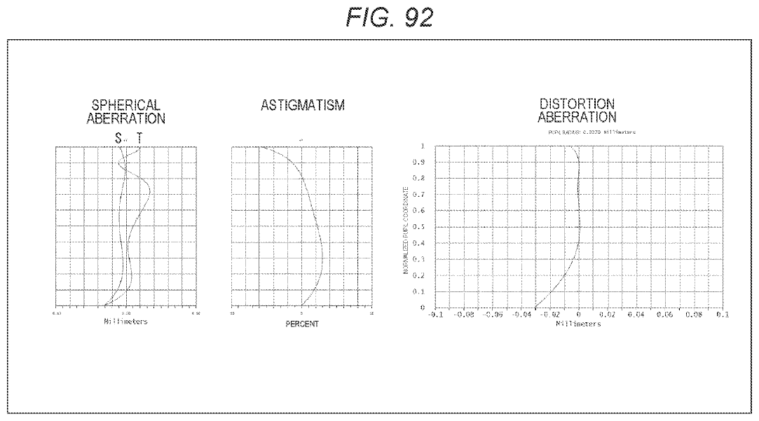

FIG. 92 is a diagram illustrating aberration performance of the lens optical system 1-23, and illustrates a spherical aberration diagram, an astigmatism diagram, and a distortion aberration diagram.

As can be seen from each aberration diagram, the lens optical system 1-23 has various aberrations corrected well and has excellent image forming performance.

<1.24 24th Configuration Example of First Embodiment>

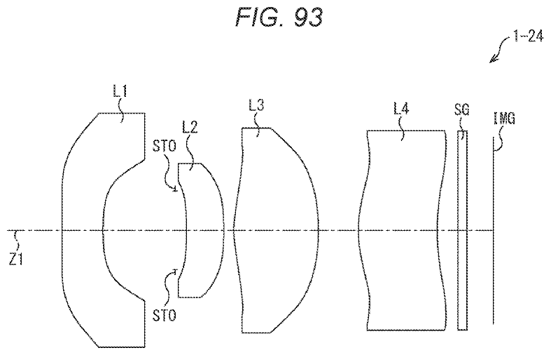

FIG. 93 illustrates a 24th configuration example (Example 24) of the lens optical system 1 in the first embodiment.

A lens optical system 1-24 in FIG. 93 includes the first lens group having a negative refractive power and the second lens group having a positive refractive power, and has a positive refractive power as a whole. The first lens L1 to the fourth lens L4 has negative, negative, positive, and positive refractive power, respectively, in order from the first lens L1 on the object side. Therefore, in the lens optical system 1-24, similarly to the lens optical system 1-23 in FIG. 89 described above, the second lens L2 has a negative refractive power.

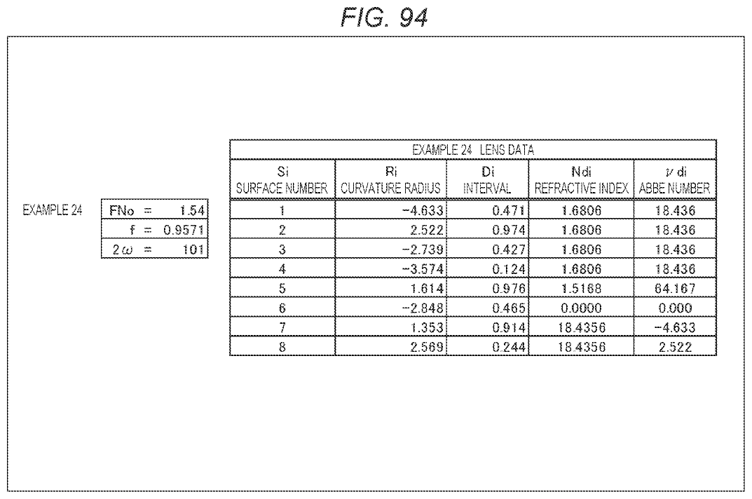

FIG. 94 illustrates specific characteristic data of the lens optical system 1-24 and lens data of the first lens L1 to the fourth lens L4.

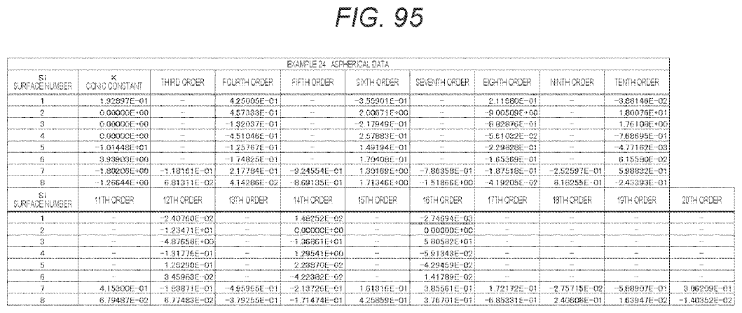

FIG. 95 illustrates a conic constant K of Formula (1) for specifying the aspherical shape of each surface S1 of the lens optical system 1-24 and a value of the i-th order (i is an integer of 3 or more) aspherical coefficient Ai.

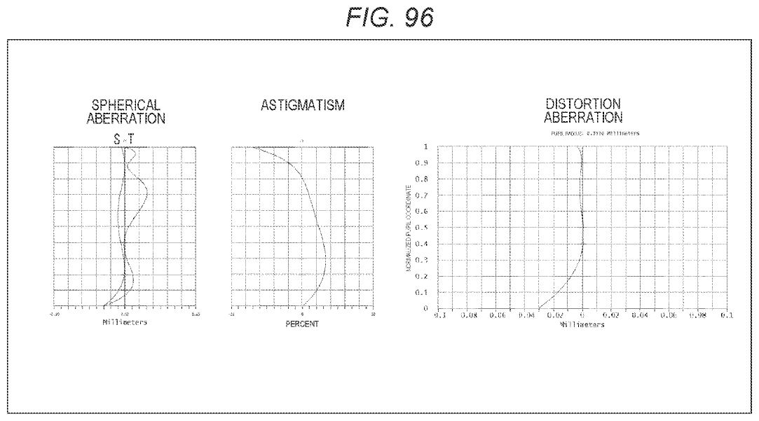

FIG. 96 is a diagram illustrating aberration performance of the lens optical system 1-24, and illustrates a spherical aberration diagram, an astigmatism diagram, and a distortion aberration diagram.

As can be seen from each aberration diagram, the lens optical system 1-24 has various aberrations corrected well and has excellent image forming performance.

<1.25 25th Configuration Example of First Embodiment>

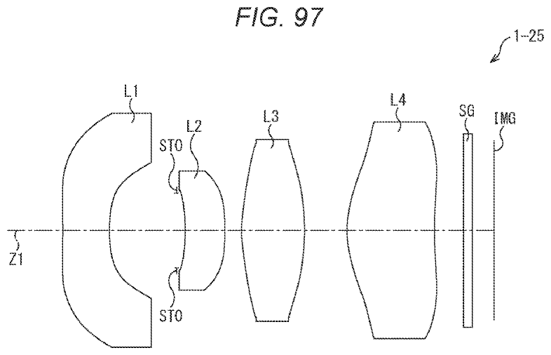

FIG. 97 illustrates a 25th configuration example (Example 25) of the lens optical system 1 in the first embodiment.

A lens optical system 1-25 in FIG. 97 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

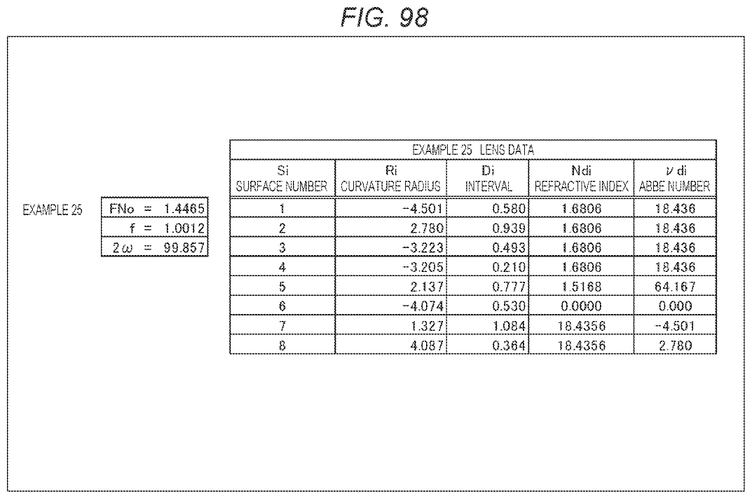

FIG. 98 illustrates specific characteristic data of the lens optical system 1-25 and lens data of the first lens L1 to the fourth lens L4.

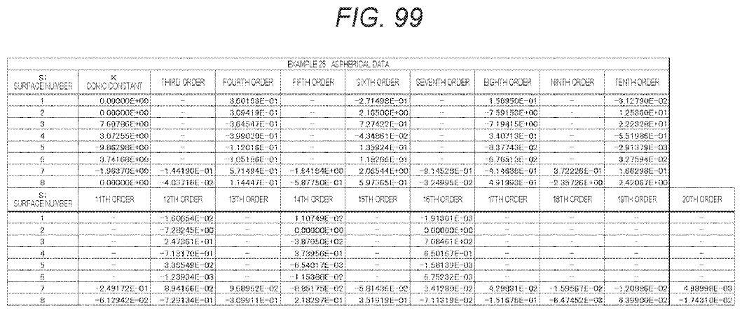

FIG. 99 illustrates a conic constant K of Formula (1) for specifying the aspherical shape of each surface S1 of the lens optical system 1-25 and a value of the i-th order (i is an integer of 3 or more) aspherical coefficient Ai.

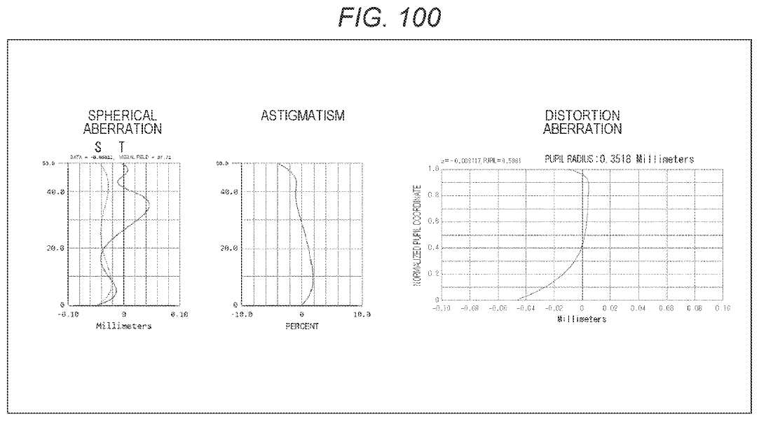

FIG. 100 is a diagram illustrating aberration performance of the lens optical system 1-25, and illustrates a spherical aberration diagram, an astigmatism diagram, and a distortion aberration diagram.

As can be seen from each aberration diagram, the lens optical system 1-21 has various aberrations corrected well and has excellent image forming performance.

<1.26 Conditional Expression Data of Lens Optical System According to First Embodiment>

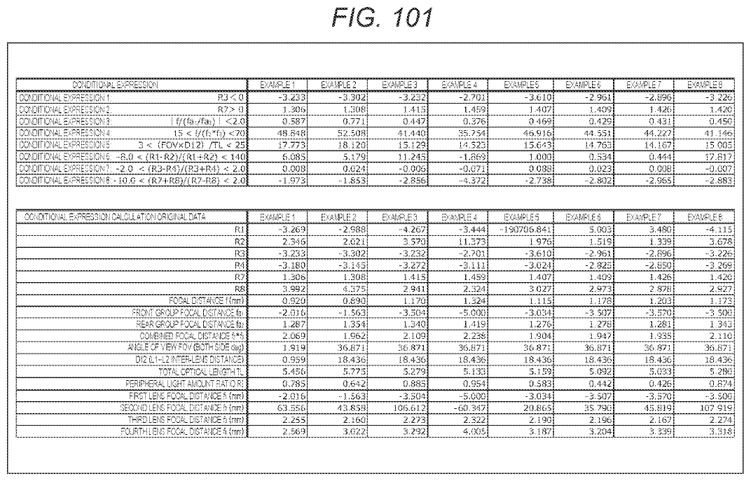

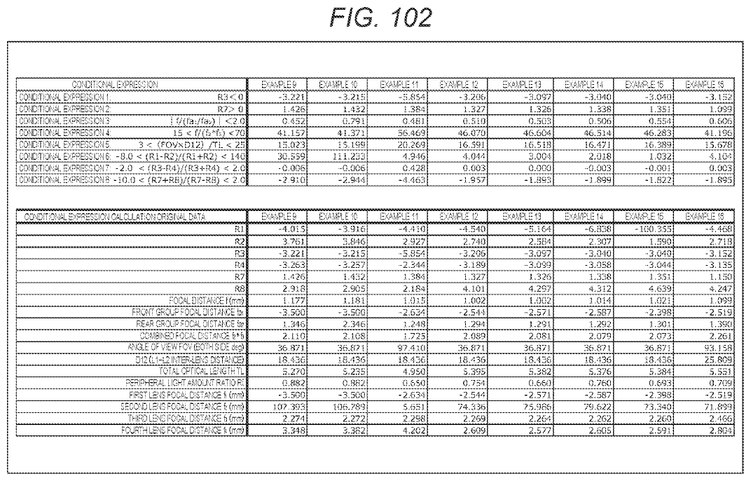

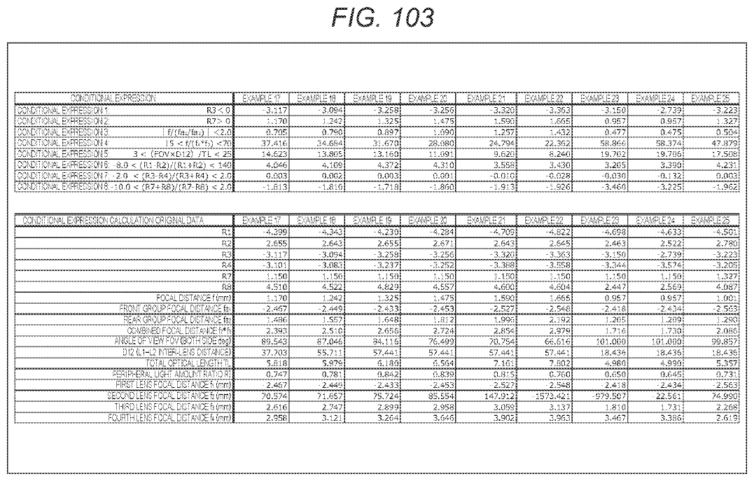

FIGS. 101 to 103 illustrate values obtained by calculating the conditional expressions (1) to (8) and original data required for calculating the respective conditional expressions in the lens optical systems 1-1 to 1-25 illustrated in FIGS. 1 to 100.

As illustrated in FIGS. 101 to 103, the lens optical systems 1-1 to 1-25 satisfy all of the conditional expressions (1) to (8). Furthermore, the lens optical systems 1-1 to 1-25 also satisfy the conditional expressions (3)′ to (8)′ which are more preferable conditions.

With the lens optical systems 1-1 to 1-25 satisfying the conditional expressions (1) to (8), more preferably the conditional expressions (3)′ to (8)′, Fno is bright, the light beams including peripheral light beams can be captured with high efficiency, and reduction in size and height can be achieved.

<2. Second Embodiment of Lens Optical System>

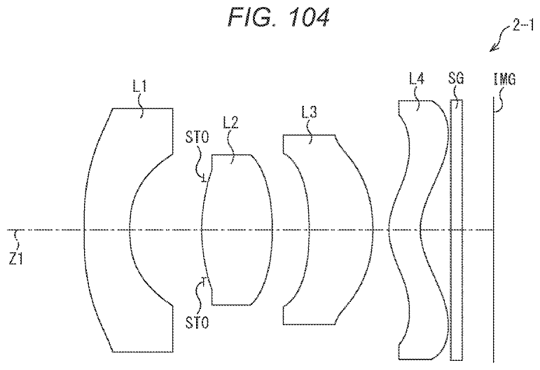

Next, a lens optical system according to a second embodiment of the present disclosure will be described with reference to a lens optical system 2-1 in FIG. 104. The lens optical system 2-1 in FIG. 104 is a first configuration example of the lens optical system 2 in the second embodiment.

The lens optical system 2 according to the second embodiment of the present disclosure includes a first lens L1 having a negative refractive power, a second lens L2 having a positive refractive power, a third lens L3 having a positive or negative refractive power, and a fourth lens L4 having a positive refractive power in order from the object side around the optical axis Z1 of a one-dot chain line, and has a positive refractive power as a whole. The first lens L1 closer to the object side than an aperture stop STO constitutes a first lens group and has a negative refractive power. The second lens L2 to the fourth lens L4 on an image side of the aperture stop STO constitute a second lens group and have a positive refractive power. The first lens group is also referred to as a front group, and the second lens group is also referred to as a rear group.

In the lens optical system 2, the aperture stop STO is disposed between the first lens L1 and the second lens L2, and a sealing glass SG is disposed between the fourth lens L4 and an image plane IMG. The sealing glass SG can have a filter function such as an infrared cut filter and a band pass filter, an antireflection function, and the like, in addition to a function of protecting a light receiving element.

The lens optical system 2 collects the light beams from the object side on a photoelectric conversion section of the light receiving element arranged at the position of the image plane IMG and forms an image.

The lens optical system 2 has negative (first lens L1), positive (second lens L2), positive or negative (third lens L3), and positive (fourth lens L4) refractive powers in order from the first lens L1 on the object side, and has a positive refractive power as a whole, so that the angle of view is widened, the range on the object side can thereby be widened, and the light beams from the object side can be efficiently collected and guided to the light receiving element. Moreover, in addition to good collecting performance and optical performance, it is possible to shorten the total optical length, and it is possible to meet the need for reduction in size and height.

In the lens optical system 2, by configuring each lens so as to satisfy at least one conditional expression, preferably two or more conditional expressions in combination described below, it is possible to achieve a lens optical system having good collecting performance and optical performance, and having a reduced size and a reduced height.

Note that, also in the second embodiment, the meaning of each symbol and each symbol are similar to that of the first embodiment.

First, for the lens optical system 2, a first conditional expression is that the lens shape of the third lens L3 on the object side is concave toward the object side. That is, a curvature radius R5 of a lens surface S5 satisfies the following conditional expression (1).

R5<0 (1)

Next, for the lens optical system 2, a second conditional expression is that the lens shape of the fourth lens L4 on the object side is convex toward the object side. That is, a curvature radius R7 of a lens surface S7 satisfies the following conditional expression (2).

R7>0 (2)

Since the lens shape of the third lens L3 on the object side is concave toward the object side, the light beams from the object side can be efficiently collected up to the peripheral edge portion of the light receiving element, and a shading characteristic is improved.

Next, the lens optical system 2 satisfies the following conditional expression (3).

|f/(fa₁/fa₂)|<1.5 (3)

In the conditional expression (3), f represents a focal length (mm) of the entire lens optical system 2 at a d-line (wavelength 587.6 nm), fa₁ represents a focal length (mm) of the first lens group (front group) at the d-line (wavelength 587.6 nm), and fa₂ represents a focal length (mm) of the second lens group (rear group) at the d-line (wavelength 587.6 nm).

The conditional expression (3) is an expression relating to an appropriate power distribution of the first lens group and the second lens group with respect to the power of lens of the entire optical system. The absolute value is used in the conditional expression (3) because the first lens group has negative power. When the conditional expression (3) exceeds an upper limit, the power of the first lens group becomes too small with respect to the power of lens of the entire optical system and the power of the second lens group, and it becomes difficult to widen the angle of view.

In consideration of securing the angle of view and the viewing angle, the conditional expression (3) more preferably satisfies the following conditional expression (3)′.

|f/(fa₁/fa₂)|<1.1 (3)′

Next, the lens optical system 2 satisfies the following conditional expression (4).

|(f₂×f₄)/f|<18 (4)

In the conditional expression (4), f₂ represents a focal length (mm) of the second lens L2 at the d-line (wavelength 587.6 nm), and f₃ represents a focal length (mm) of the third lens L3 at the d-line (wavelength 587.6 nm).

The conditional expression (4) is an expression relating to an appropriate power distribution of the power of the entire optical system with respect to the combined power of the second lens L2 and the third lens L3. When the conditional expression (4) exceeds an upper limit, the power of the second lens L2 and the third lens L3 becomes too weak with respect to the power of the entire optical system, and it becomes difficult to efficiently collect light up to the peripheral edge portion of the light receiving element and to perform appropriate aberration correction while maintaining the wide angle of view.

In consideration of securing the angle of view and the aberration correction, the conditional expression (4) more preferably satisfies the following conditional expression (4)′.

|(f₂×f₄)/f|<14 (4)′

Next, the lens optical system 2 satisfies the following conditional expression (5).

10<(FOV×D12)/TL<45 (5)

FOV represents an object-side capturing angle of the lens optical system 2, what is called an angle of view, and corresponds to an angle of view 2ω on both sides. D12 represents an inter-lens distance between the first lens L1 and the second lens L2. TL represents the total optical length of the lens optical system 2.

The conditional expression (5) is a conditional expression indicating the relationship among the angle of view FOV, the inter-lens distance D12 between the first lens L1 and the second lens L2, and the total optical length TL of the lens optical system 2. When the conditional expression (5) exceeds an upper limit, the total optical length TL of the lens optical system 2 becomes too short with respect to the relationship between the angle of view FOV and the length D12 from the first lens L1 to the second lens L2, and it becomes difficult to secure necessary optical performance in a state where the angle of view FOV is maintained. On the other hand, when the conditional expression (5) falls below a lower limit, the total optical length TL of the lens optical system 2 becomes too long with respect to the angle of view FOV and the length D12 from the first lens L1 to the second lens L2, and is no longer small in size.

In consideration of securing the angle of view and the viewing angle, the conditional expression (5) more preferably satisfies the following conditional expression (5)′.

13<(FOV×D12)/TL<38 (5)′

Next, the lens optical system 2 satisfies the following conditional expression (6).

−2.0<(R5−R6)/(R5+R6)<1.5 (6)

The conditional expression (6) expresses the relationship of the lens curvature radius R6 of the image-side surface S6 of the third lens L3 with the lens curvature radius R5 of the object-side surface S5 of the third lens L3 by the conditional expression. When the conditional expression (6) falls below a lower limit, the lens curvature radius R6 of the image-side surface S6 becomes too large with respect to the curvature radius R5 of the object-side surface S5 of the third lens L3, and it becomes difficult to efficiently collect the light beams up to the peripheral edge portion of the light receiving element. On the other hand, when the conditional expression (6) exceeds an upper limit, the lens curvature radius R6 of the image-side surface S6 of the third lens L3 becomes too small with respect to the lens curvature radius R5 of the object-side surface S5 of the third lens L3, and it becomes difficult to efficiently collect the light beams up to the peripheral edge portion of the light receiving element. Furthermore, when both the lower limit and the upper limit are out of the range of the conditional expression, the aberration correction effect, particularly the correction effect on the field curvature and the coma aberration is impaired.

In consideration of efficiently collecting light up to the peripheral edge portion of the light receiving element and securing the aberration correction, the conditional expression (6) more preferably satisfies the following conditional expression (6)′.

−1.5<(R5−R6)/(R5+R6)<1.0 (6)′

Next, the lens optical system 2 satisfies the following conditional expression (7).

−1.5<(R7+R8)/(R7−R8)<0.5 (7)

The conditional expression (7) expresses the relationship of the lens curvature radius R8 of the image-side surface S8 of the fourth lens L4 with the lens curvature radius R7 of the object-side surface S7 of the fourth lens L4. When the conditional expression (7) falls below a lower limit, the lens curvature radius R8 of the image-side surface S8 becomes too small with respect to the lens curvature radius R7 of the object-side surface S7 of the fourth lens L4, which adversely affects aberration correction, particularly distortion aberration correction. On the other hand, when the conditional expression (7) exceeds an upper limit, the lens curvature radius R8 of the image-side surface S8 of the fourth lens L4 becomes too large with respect to the lens curvature radius R7 of the object-side surface S7 of the fourth lens L4, and similarly, aberration correction, particularly correction of distortion aberration becomes difficult, making it difficult to obtain an appropriate correction effect.

In consideration of the aberration correction effect, the conditional expression (7) more preferably satisfies the following conditional expression (7)′.

−0.9<(R7+R8)/(R7−R8)<0.2 (7)′

Hereinafter, a configuration example in which specific numerical values are applied to the lens optical system 2 in the second embodiment will be described.

<2.1 First Configuration Example of Second Embodiment>

FIG. 104 illustrates a first configuration example (Example 1) of the lens optical system 2 in the second embodiment.

The lens optical system 2-1 in FIG. 104 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

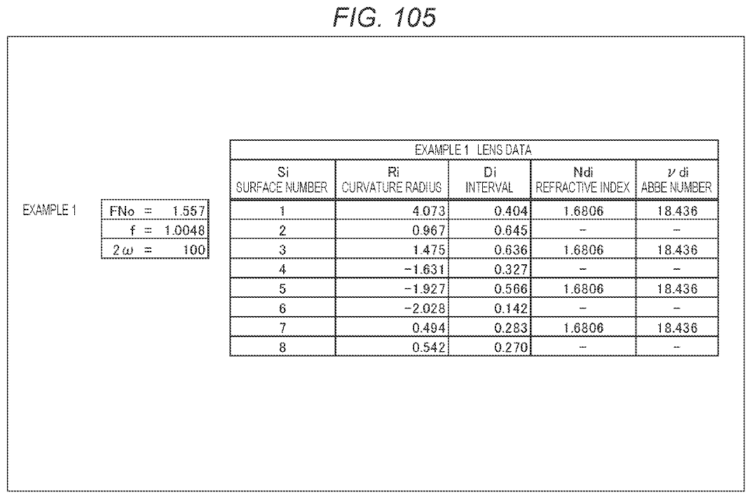

FIG. 105 illustrates specific characteristic data of the lens optical system 2-1 and lens data of the first lens L1 to the fourth lens L4.

In FIG. 105, “FNo” represents the F-number of the lens optical system 2-1, “f” represents the focal length (mm) of the entire lens system of the lens optical system 2-1, and “2ω” represents a diagonal total angle of view)(°.

Furthermore, “Si” represents the i-th surface counted from the object side to the image side, “Ri” represents a paraxial curvature radius of the i-th surface Si, “Di” represents an interval on the optical axis between the i-th surface S1 and the (i+1)-th surface S(i+1), “Ndi” represents a refractive index at the d-line (wavelength 587.6 nm) of the lens starting from the i-th surface Si, and “νdi” represents the Abbe number at the d-line of the lens starting from the i-th surface Si.

The aspherical shape of each surface S1 of the lens optical system 2-1 is expressed by the above-described formula (1). In Formula (1), Z represents the depth of the aspherical surface, and Y represents the height from the optical axis (the position in the direction perpendicular to the optical axis). Furthermore, K represents a conic constant, and Ai represents the i-th order (i is an integer of 3 or more) aspherical coefficient. R is a paraxial curvature radius. The meaning of each symbol is similar in other configuration examples (examples) described later.

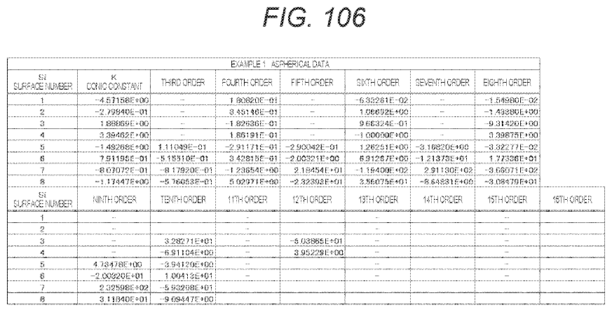

FIG. 106 illustrates a conic constant K of Formula (1) for specifying the aspherical shape of each surface S1 of the lens optical system 2-1 and a value of the i-th order (i is an integer of 3 or more) aspherical coefficient Ai.

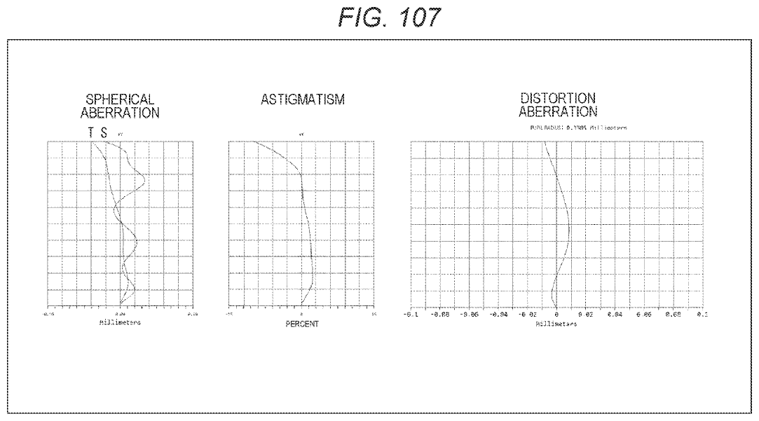

FIG. 107 is a diagram illustrating aberration performance of the lens optical system 2-1, and illustrates a spherical aberration diagram, an astigmatism diagram, and a distortion aberration diagram.

In the spherical aberration diagram, T represents spherical aberration in the lens normal direction, and S represents spherical aberration in the lens tangential direction. T and S are similarly used in spherical aberration diagrams of other configuration examples (examples) described later.

As can be seen from each aberration diagram, the lens optical system 2-1 has various aberrations corrected well and has excellent image forming performance.

<2.2 Second Configuration Example of Second Embodiment>

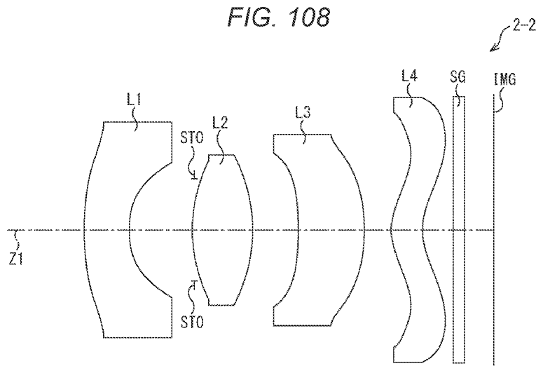

FIG. 108 illustrates a second configuration example (Example 2) of the lens optical system 2 in the second embodiment.

A lens optical system 2-2 in FIG. 108 includes the first lens group having a negative refractive power and the second lens group having a positive refractive power, and has a positive refractive power as a whole. The first lens L1 to the fourth lens L4 has negative, positive, negative, and positive refractive powers, respectively, in order from the first lens L1 on the object side. Therefore, the third lens L3 has a positive refractive power in the lens optical system 2-1 described above, but has a negative refractive power in the lens optical system 2-2.

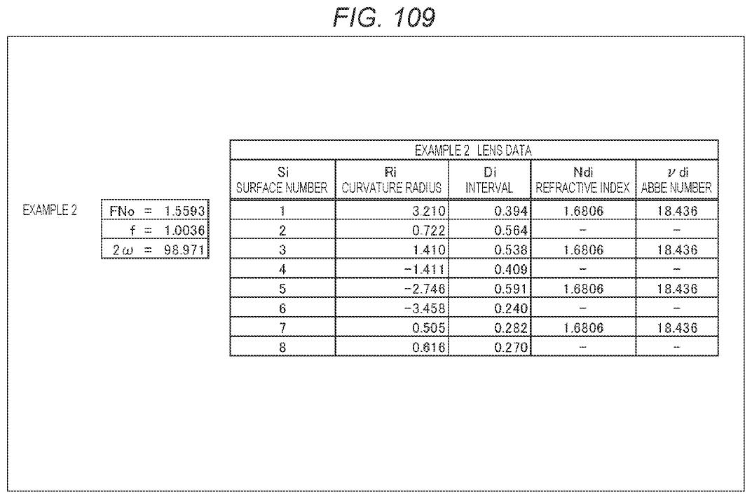

FIG. 109 illustrates specific characteristic data of the lens optical system 2-2 and lens data of the first lens L1 to the fourth lens L4.

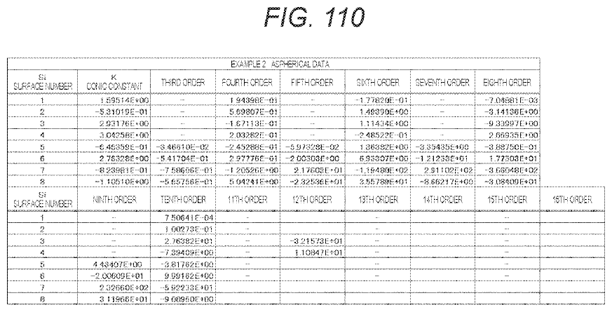

FIG. 110 illustrates a conic constant K of Formula (1) for specifying the aspherical shape of each surface S1 of the lens optical system 2-2 and a value of the i-th order (i is an integer of 3 or more) aspherical coefficient Ai.

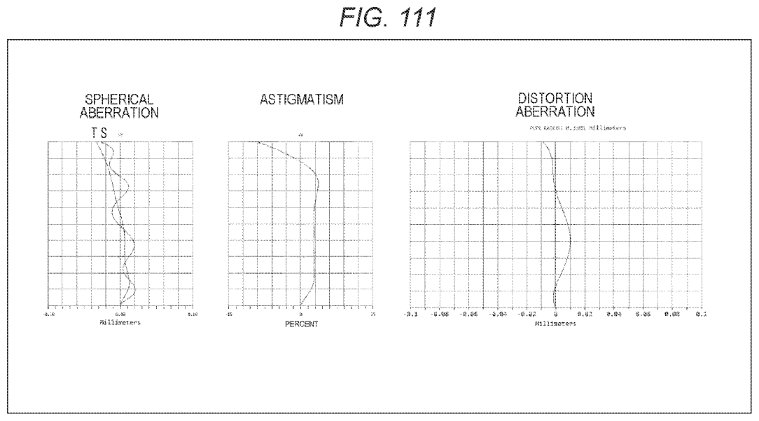

FIG. 111 is a diagram illustrating aberration performance of the lens optical system 2-2, and illustrates a spherical aberration diagram, an astigmatism diagram, and a distortion aberration diagram.

As can be seen from each aberration diagram, the lens optical system 2-2 has various aberrations corrected well and has excellent image forming performance.

<2.3 Third Configuration Example of Second Embodiment>

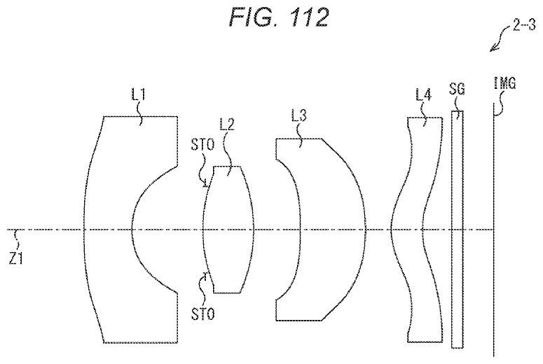

FIG. 112 illustrates a third configuration example (Example 3) of the lens optical system 2 in the second embodiment.

A lens optical system 2-3 in FIG. 112 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

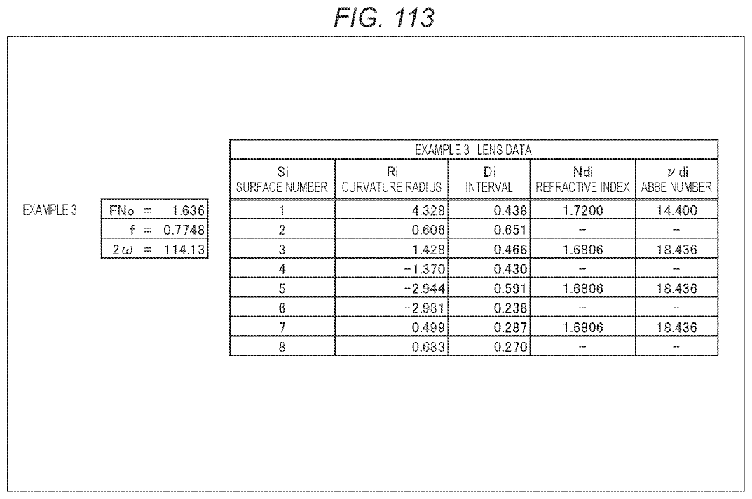

FIG. 113 illustrates specific characteristic data of the lens optical system 2-3 and lens data of the first lens L1 to the fourth lens L4.

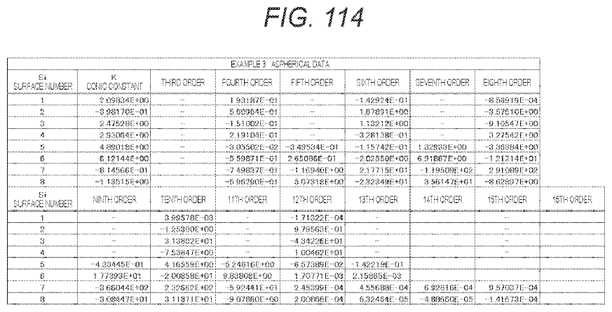

FIG. 114 illustrates a conic constant K of Formula (1) for specifying the aspherical shape of each surface S1 of the lens optical system 2-3 and a value of the i-th order (i is an integer of 3 or more) aspherical coefficient Ai.

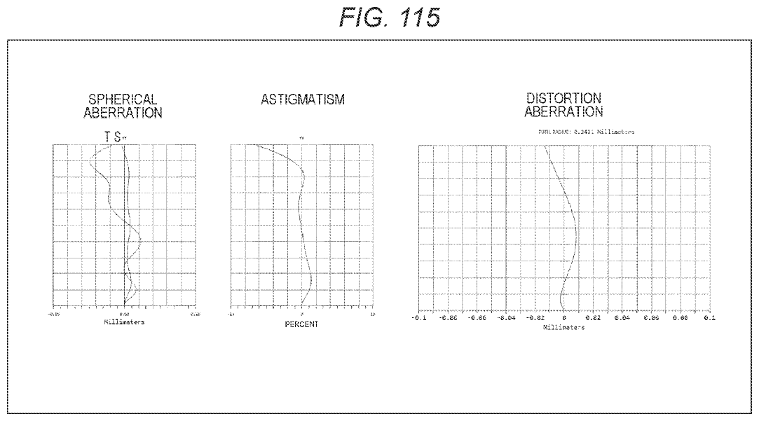

FIG. 115 is a diagram illustrating aberration performance of the lens optical system 2-3, and illustrates a spherical aberration diagram, an astigmatism diagram, and a distortion aberration diagram.

As can be seen from each aberration diagram, the lens optical system 2-3 has various aberrations corrected well and has excellent image forming performance.

<2.4 Fourth Configuration Example of Second Embodiment>

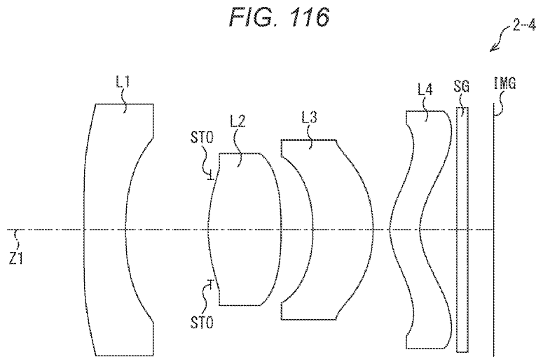

FIG. 116 illustrates a fourth configuration example (Example 4) of the lens optical system 2 in the second embodiment.

A lens optical system 2-4 in FIG. 116 includes the first lens group having a negative refractive power and the second lens group having a positive refractive power, and has a positive refractive power as a whole. The first lens L1 to the fourth lens L4 has negative, positive, negative, and positive refractive powers, respectively, in order from the first lens L1 on the object side. Therefore, the third lens L3 has a positive refractive power in the lens optical system 2-3 described above, but has a negative refractive power in the lens optical system 2-4.

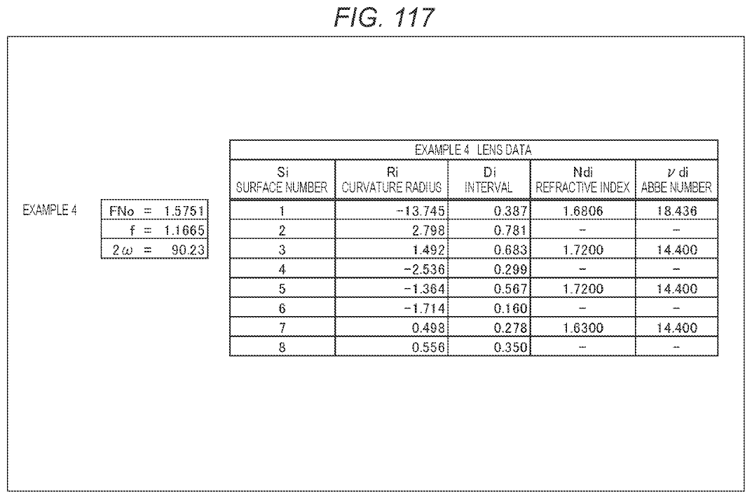

FIG. 117 illustrates specific characteristic data of the lens optical system 2-4 and lens data of the first lens L1 to the fourth lens L4.

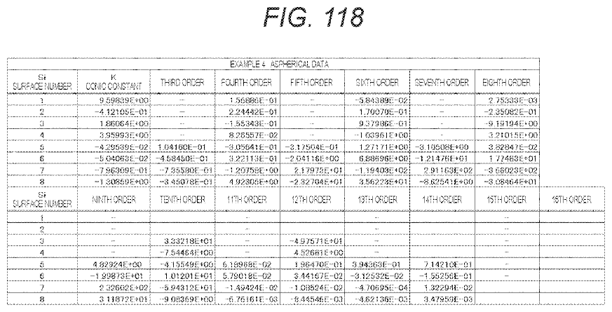

FIG. 118 illustrates a conic constant K of Formula (1) for specifying the aspherical shape of each surface S1 of the lens optical system 2-4 and a value of the i-th order (i is an integer of 3 or more) aspherical coefficient Ai.

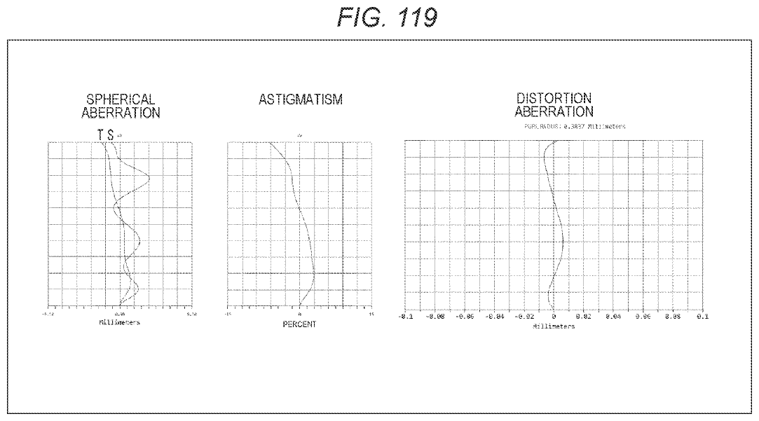

FIG. 119 is a diagram illustrating aberration performance of the lens optical system 2-4, and illustrates a spherical aberration diagram, an astigmatism diagram, and a distortion aberration diagram.

As can be seen from each aberration diagram, the lens optical system 2-4 has various aberrations corrected well and has excellent image forming performance.

<2.5 Fifth Configuration Example of Second Embodiment>

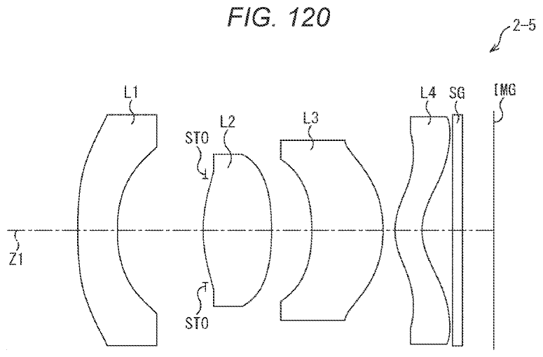

FIG. 120 illustrates a fifth configuration example (Example 5) of the lens optical system 2 in the second embodiment.

A lens optical system 2-5 in FIG. 120 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

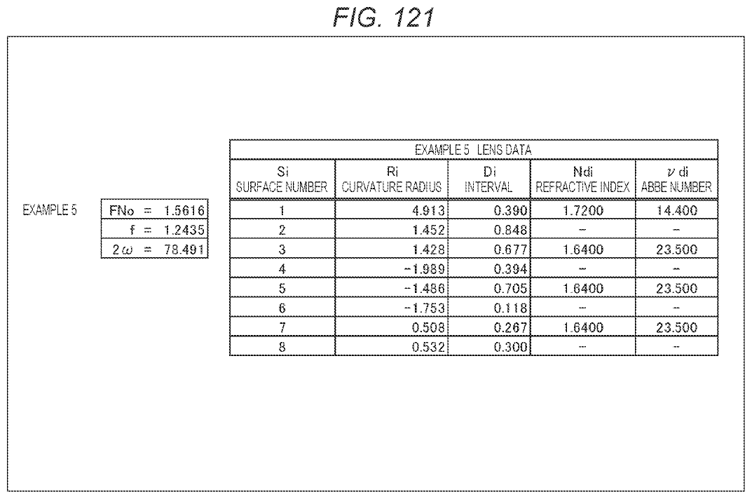

FIG. 121 illustrates specific characteristic data of the lens optical system 2-5 and lens data of the first lens L1 to the fourth lens L4.

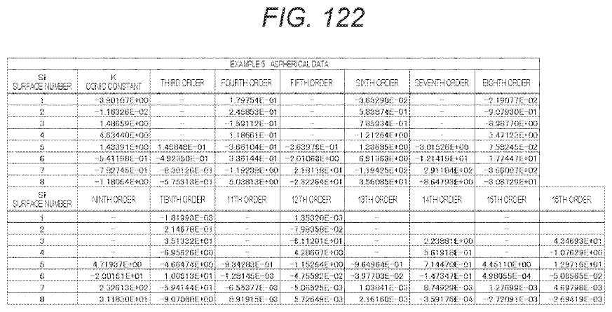

FIG. 122 illustrates a conic constant K of Formula (1) for specifying the aspherical shape of each surface S1 of the lens optical system 2-5 and a value of the i-th order (i is an integer of 3 or more) aspherical coefficient Ai.

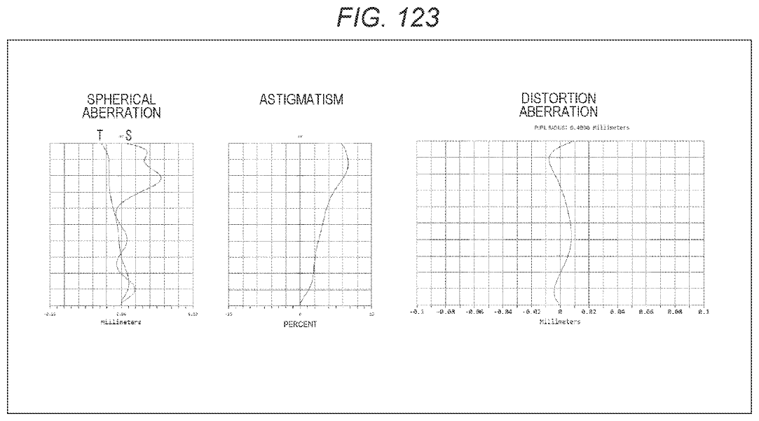

FIG. 123 is a diagram illustrating aberration performance of the lens optical system 2-5, and illustrates a spherical aberration diagram, an astigmatism diagram, and a distortion aberration diagram.

As can be seen from each aberration diagram, the lens optical system 2-5 has various aberrations corrected well and has excellent image forming performance.

<2.6 Sixth Configuration Example of Second Embodiment>

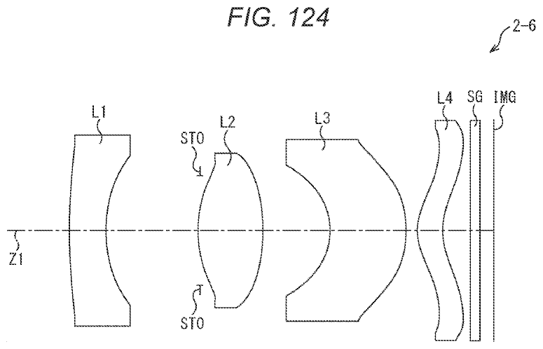

FIG. 124 illustrates a sixth configuration example (Example 6) of the lens optical system 2 in the second embodiment.

A lens optical system 2-6 in FIG. 124 includes the first lens group having a negative refractive power and the second lens group having a positive refractive power, and has a positive refractive power as a whole. The first lens L1 to the fourth lens L4 has negative, positive, negative, and positive refractive powers, respectively, in order from the first lens L1 on the object side. Therefore, the third lens L3 has a positive refractive power in the lens optical system 2-5 described above, but has a negative refractive power in the lens optical system 2-6.

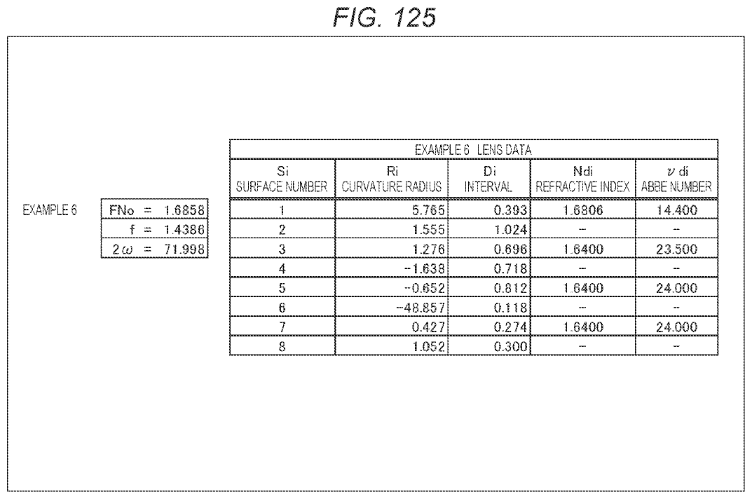

FIG. 125 illustrates specific characteristic data of the lens optical system 2-6 and lens data of the first lens L1 to the fourth lens L4.

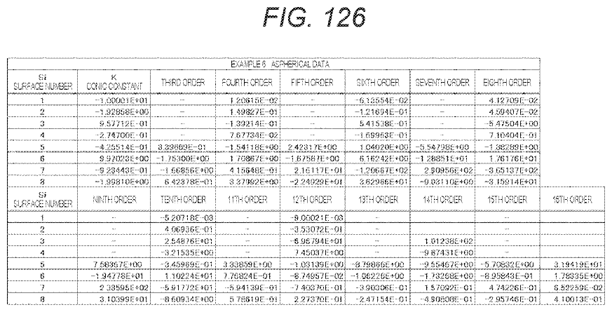

FIG. 126 illustrates a conic constant K of Formula (1) for specifying the aspherical shape of each surface S1 of the lens optical system 2-6 and a value of the i-th order (i is an integer of 3 or more) aspherical coefficient Ai.

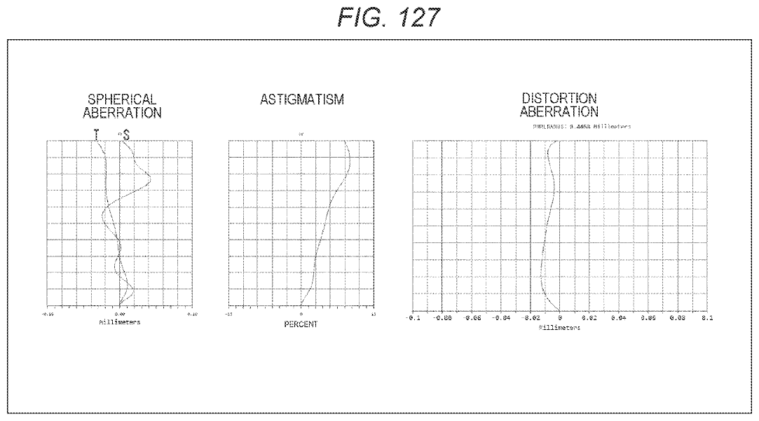

FIG. 127 is a diagram illustrating aberration performance of the lens optical system 2-6, and illustrates a spherical aberration diagram, an astigmatism diagram, and a distortion aberration diagram.

As can be seen from each aberration diagram, the lens optical system 2-6 has various aberrations corrected well and has excellent image forming performance.

<2.7 Seventh Configuration Example of Second Embodiment>

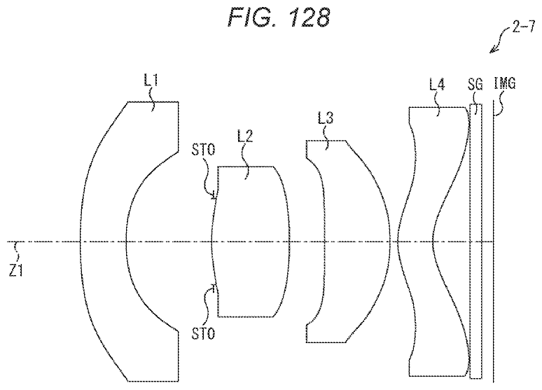

FIG. 128 illustrates a seventh configuration example (Example 7) of the lens optical system 2 in the second embodiment.

A lens optical system 2-7 in FIG. 128 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

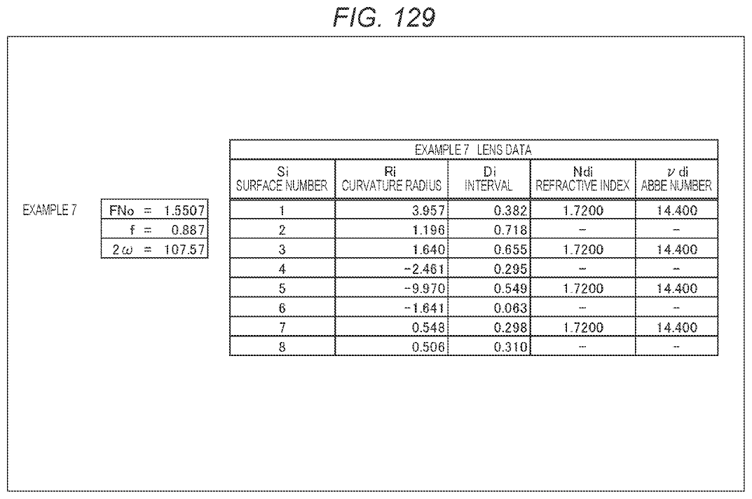

FIG. 129 illustrates specific characteristic data of the lens optical system 2-7 and lens data of the first lens L1 to the fourth lens L4.

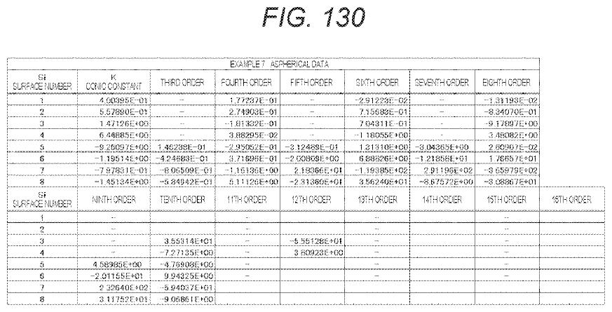

FIG. 130 illustrates a conic constant K of Formula (1) for specifying the aspherical shape of each surface S1 of the lens optical system 2-7 and a value of the i-th order (i is an integer of 3 or more) aspherical coefficient Ai.

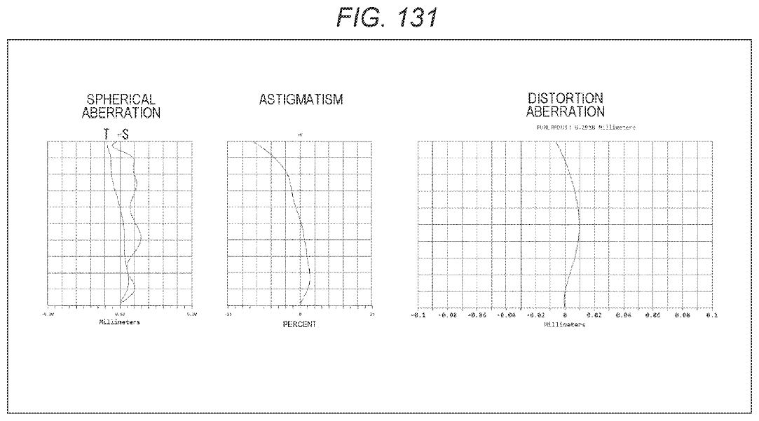

FIG. 131 is a diagram illustrating aberration performance of the lens optical system 2-7, and illustrates a spherical aberration diagram, an astigmatism diagram, and a distortion aberration diagram.

As can be seen from each aberration diagram, the lens optical system 2-7 has various aberrations corrected well and has excellent image forming performance.

<2.8 Eighth Configuration Example of Second Embodiment>

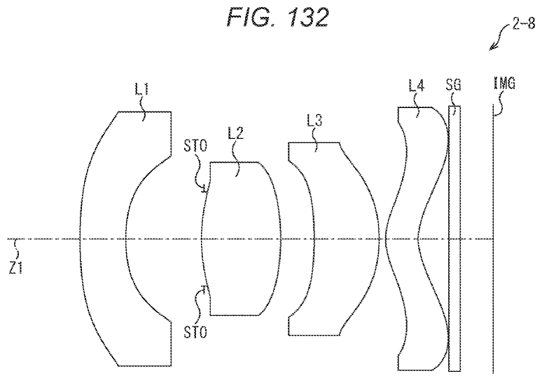

FIG. 132 illustrates an eighth configuration example (Example 8) of the lens optical system 2 in the second embodiment.

A lens optical system 2-8 in FIG. 132 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

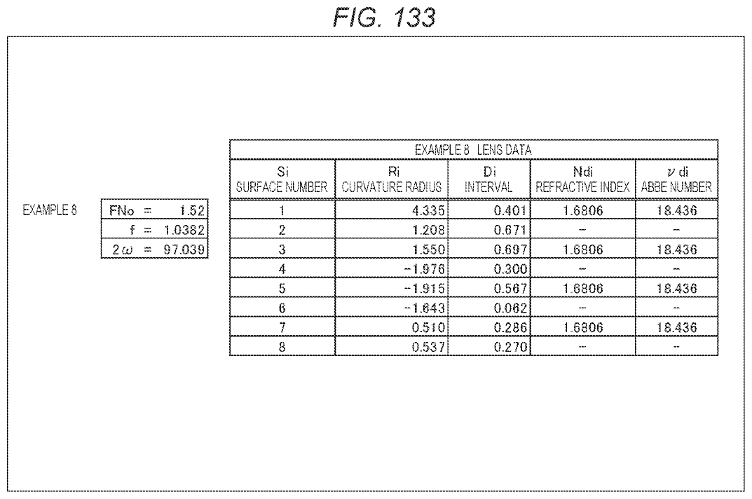

FIG. 133 illustrates specific characteristic data of the lens optical system 2-8 and lens data of the first lens L1 to the fourth lens L4.

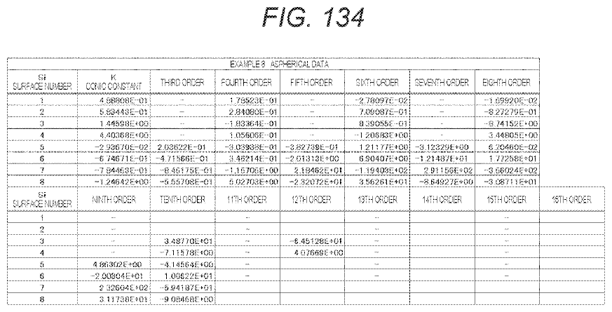

FIG. 134 illustrates a conic constant K of Formula (1) for specifying the aspherical shape of each surface S1 of the lens optical system 2-8 and a value of the i-th order (i is an integer of 3 or more) aspherical coefficient Ai.

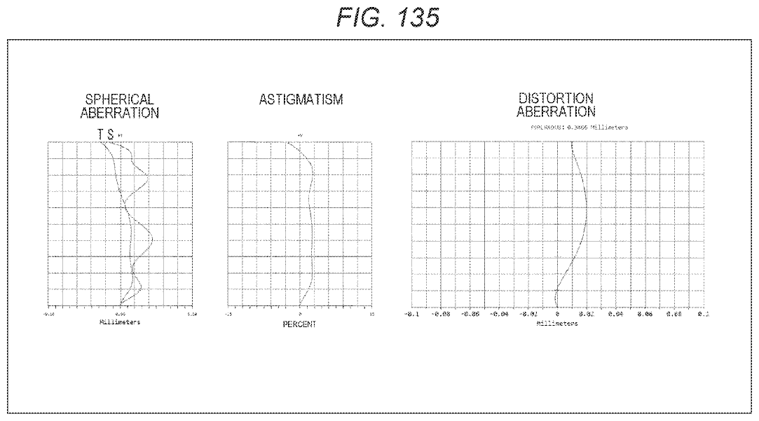

FIG. 135 is a diagram illustrating aberration performance of the lens optical system 2-8, and illustrates a spherical aberration diagram, an astigmatism diagram, and a distortion aberration diagram.

As can be seen from each aberration diagram, the lens optical system 2-8 has various aberrations corrected well and has excellent image forming performance.

<2.9 Ninth Configuration Example of Second Embodiment>

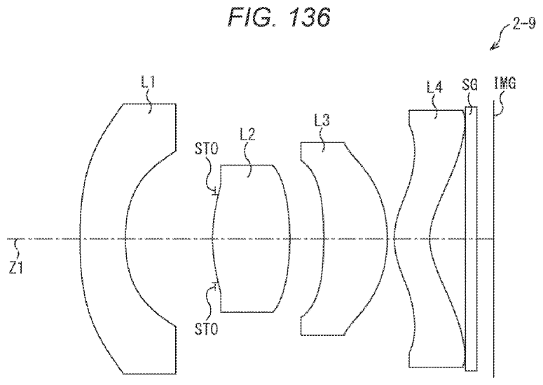

FIG. 136 illustrates a ninth configuration example (Example 9) of the lens optical system 2 in the second embodiment.

A lens optical system 2-9 in FIG. 136 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

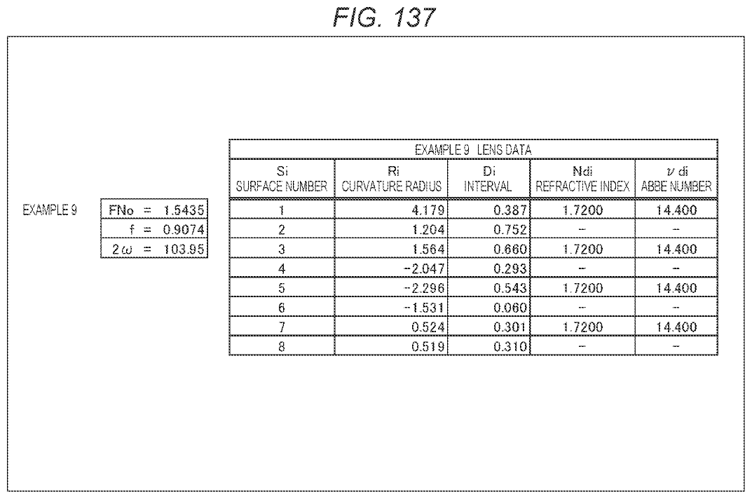

FIG. 137 illustrates specific characteristic data of the lens optical system 2-9 and lens data of the first lens L1 to the fourth lens L4.

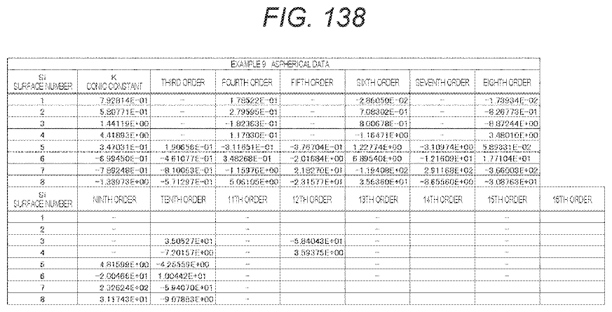

FIG. 138 illustrates a conic constant K of Formula (1) for specifying the aspherical shape of each surface S1 of the lens optical system 2-9 and a value of the i-th order (i is an integer of 3 or more) aspherical coefficient Ai.

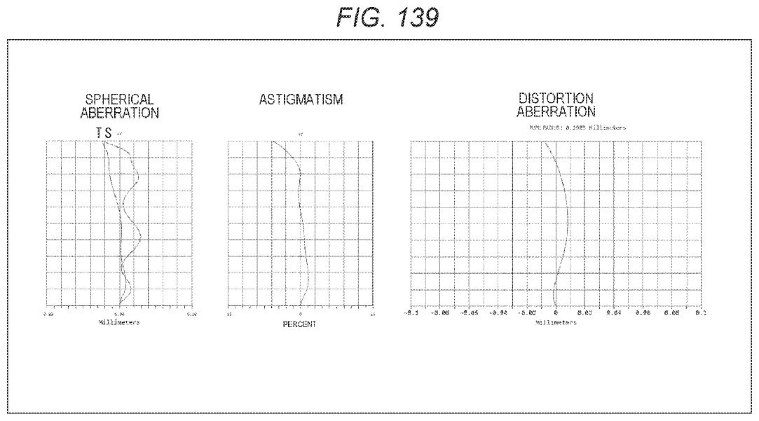

FIG. 139 is a diagram illustrating aberration performance of the lens optical system 2-9, and illustrates a spherical aberration diagram, an astigmatism diagram, and a distortion aberration diagram.

As can be seen from each aberration diagram, the lens optical system 2-9 has various aberrations corrected well and has excellent image forming performance.

<2.10 Tenth Configuration Example of Second Embodiment>

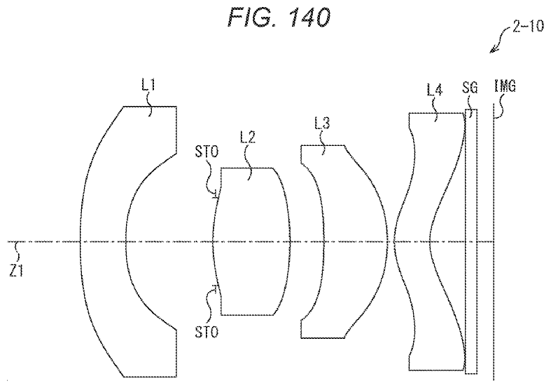

FIG. 140 illustrates a tenth configuration example (Example 10) of the lens optical system 2 in the second embodiment.

A lens optical system 2-10 in FIG. 140 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

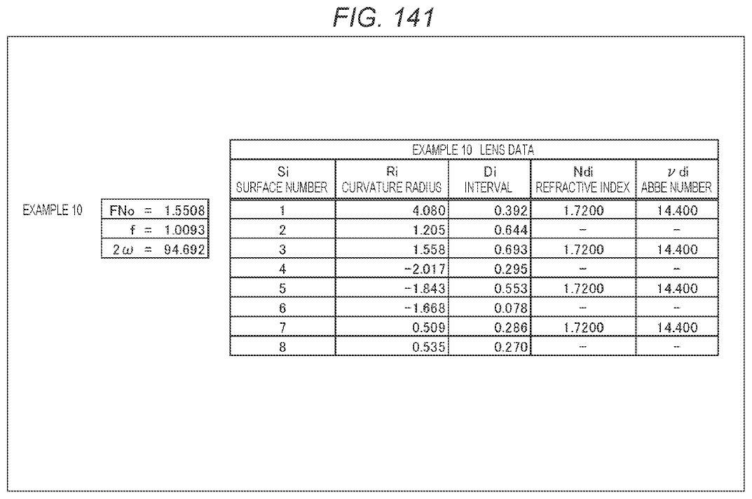

FIG. 141 illustrates specific characteristic data of the lens optical system 2-10 and lens data of the first lens L1 to the fourth lens L4.

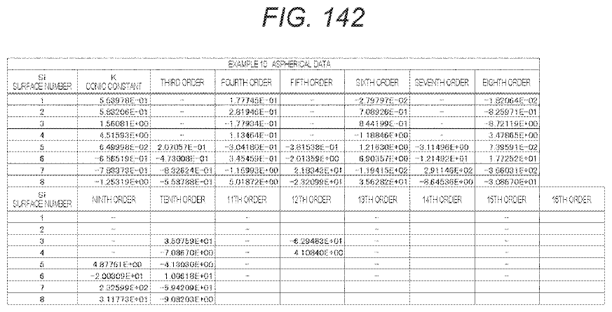

FIG. 142 illustrates a conic constant K of Formula (1) for specifying the aspherical shape of each surface S1 of the lens optical system 2-10 and a value of the i-th order (i is an integer of 3 or more) aspherical coefficient Ai.

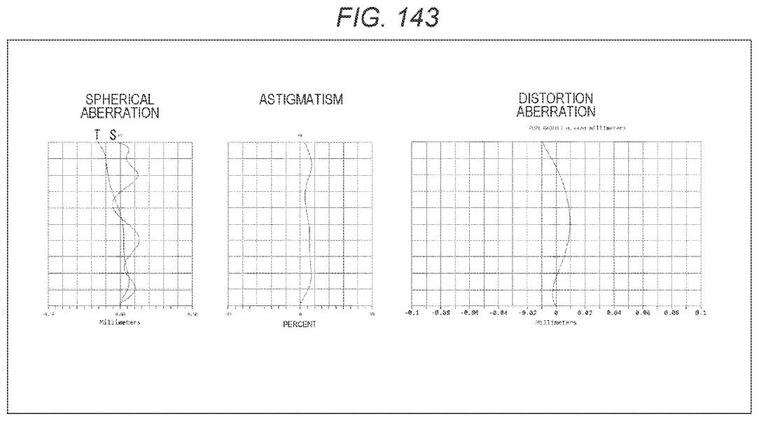

FIG. 143 is a diagram illustrating aberration performance of the lens optical system 2-10, and illustrates a spherical aberration diagram, an astigmatism diagram, and a distortion aberration diagram.

As can be seen from each aberration diagram, the lens optical system 2-10 has various aberrations corrected well and has excellent image forming performance.

<2.11 11th Configuration Example of Second Embodiment>

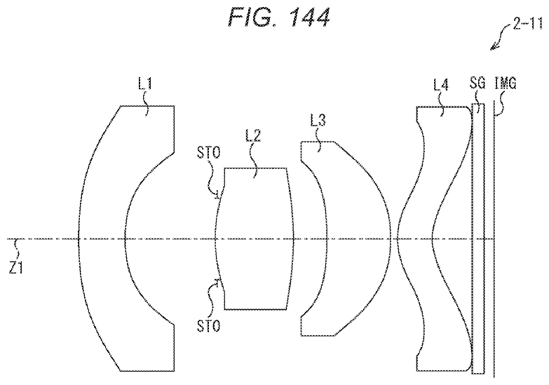

FIG. 144 illustrates an 11th configuration example (Example 11) of the lens optical system 2 in the second embodiment.

A lens optical system 2-11 in FIG. 144 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

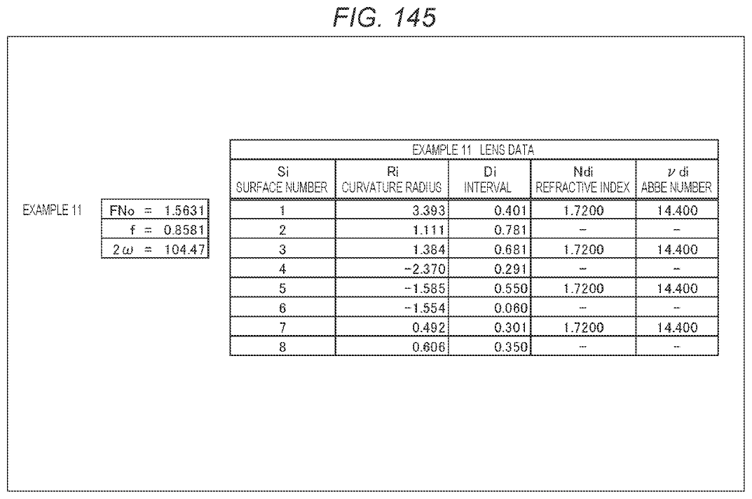

FIG. 145 illustrates specific characteristic data of the lens optical system 2-11 and lens data of the first lens L1 to the fourth lens L4.

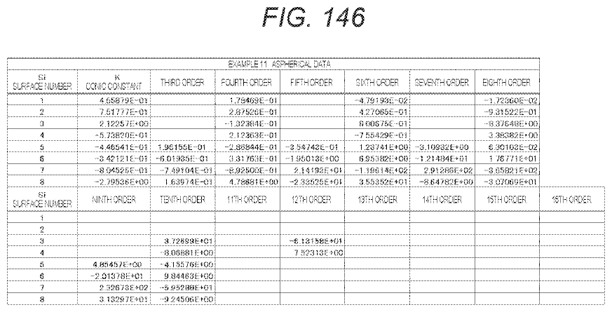

FIG. 146 illustrates a conic constant K of Formula (1) for specifying the aspherical shape of each surface S1 of the lens optical system 2-11 and a value of the i-th order (i is an integer of 3 or more) aspherical coefficient Ai.

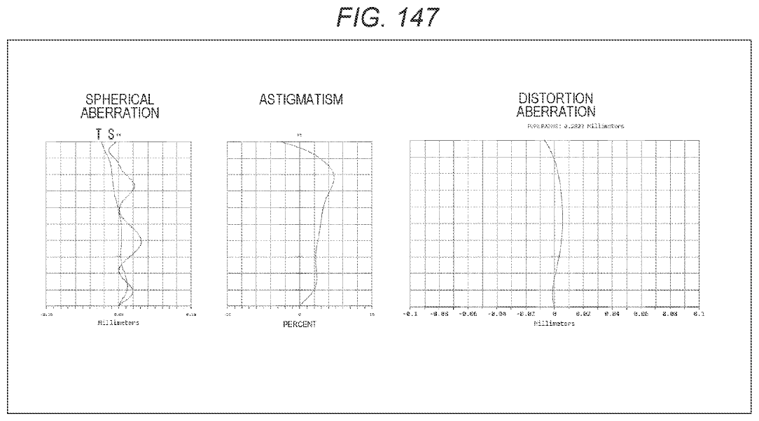

FIG. 147 is a diagram illustrating aberration performance of the lens optical system 2-11, and illustrates a spherical aberration diagram, an astigmatism diagram, and a distortion aberration diagram.

As can be seen from each aberration diagram, the lens optical system 2-11 has various aberrations corrected well and has excellent image forming performance.

<2.12 12th Configuration Example of Second Embodiment>

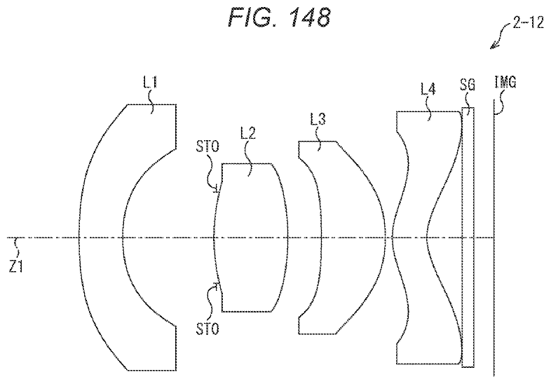

FIG. 148 illustrates a 12th configuration example (Example 12) of the lens optical system 2 in the second embodiment.

A lens optical system 2-12 in FIG. 148 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

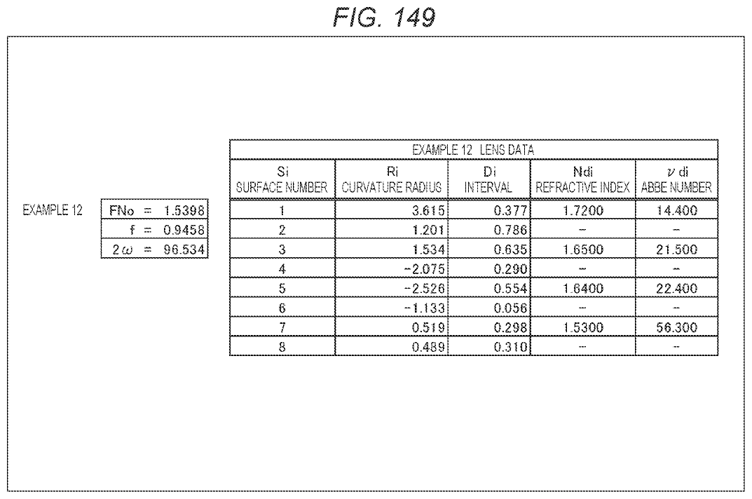

FIG. 149 illustrates specific characteristic data of the lens optical system 2-12 and lens data of the first lens L1 to the fourth lens L4.

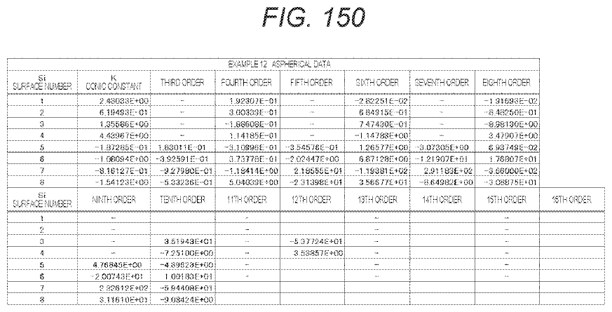

FIG. 150 illustrates a conic constant K of Formula (1) for specifying the aspherical shape of each surface S1 of the lens optical system 2-12 and a value of the i-th order (i is an integer of 3 or more) aspherical coefficient Ai.

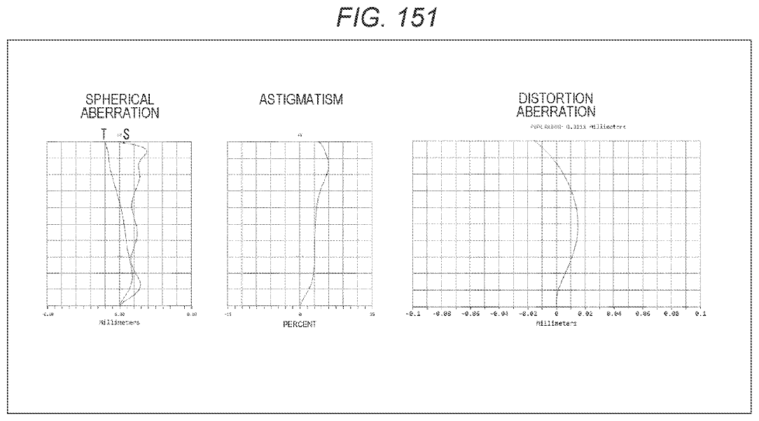

FIG. 151 is a diagram illustrating aberration performance of the lens optical system 2-12, and illustrates a spherical aberration diagram, an astigmatism diagram, and a distortion aberration diagram.

As can be seen from each aberration diagram, the lens optical system 2-12 has various aberrations corrected well and has excellent image forming performance.

<2.13 13th Configuration Example of Second Embodiment>

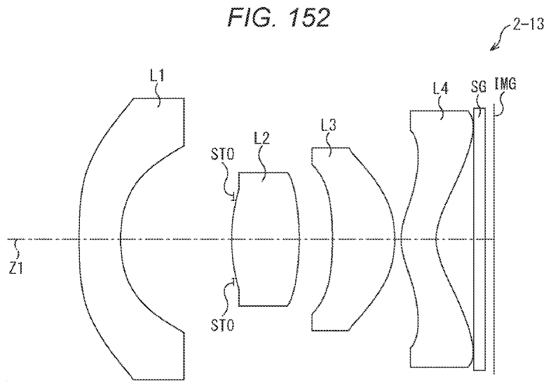

FIG. 152 illustrates a 13th configuration example (Example 13) of the lens optical system 2 in the second embodiment.

A lens optical system 2-13 in FIG. 152 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

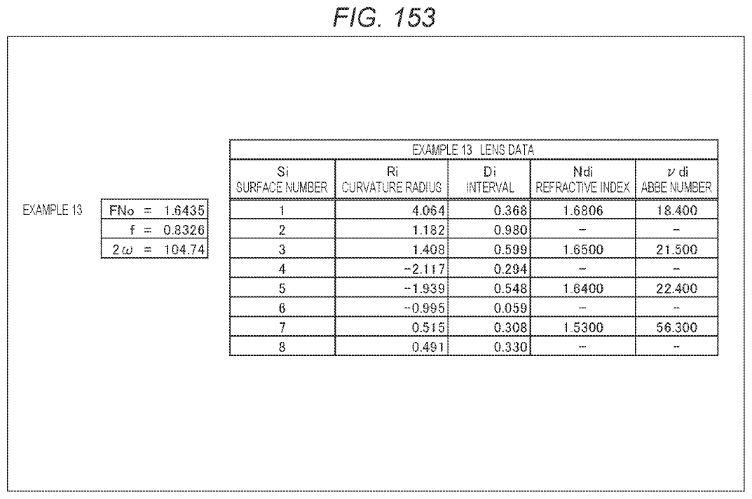

FIG. 153 illustrates specific characteristic data of the lens optical system 2-13 and lens data of the first lens L1 to the fourth lens L4.

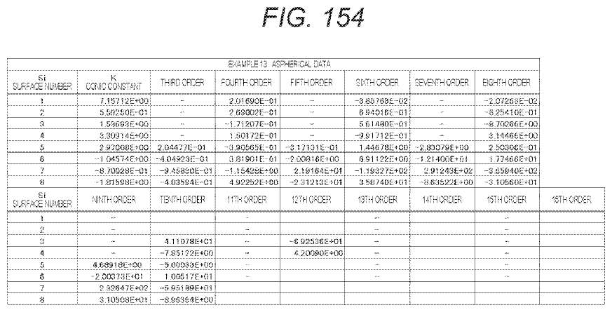

FIG. 154 illustrates a conic constant K of Formula (1) for specifying the aspherical shape of each surface S1 of the lens optical system 2-13 and a value of the i-th order (i is an integer of 3 or more) aspherical coefficient Ai.

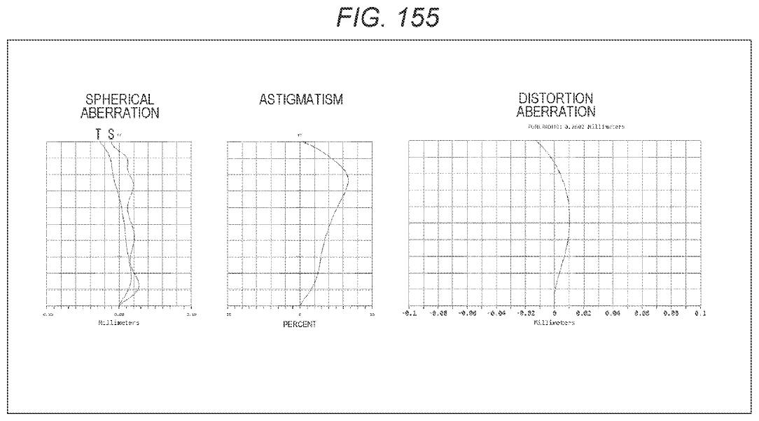

FIG. 155 is a diagram illustrating aberration performance of the lens optical system 2-13, and illustrates a spherical aberration diagram, an astigmatism diagram, and a distortion aberration diagram.

As can be seen from each aberration diagram, the lens optical system 2-13 has various aberrations corrected well and has excellent image forming performance.

<2.14 14th Configuration Example of Second Embodiment>

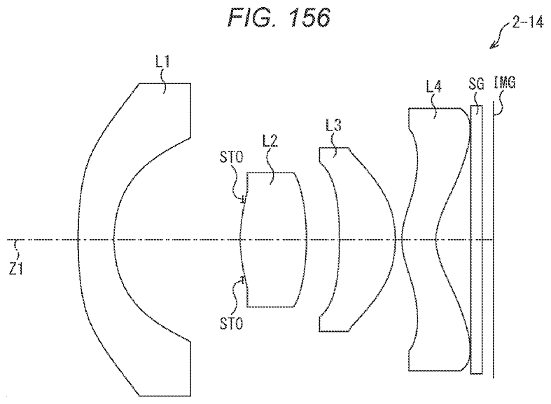

FIG. 156 illustrates a 14th configuration example (Example 14) of the lens optical system 2 in the second embodiment.

A lens optical system 2-14 in FIG. 156 includes the first lens group having a negative refractive power and the second lens group having a positive refractive power, and has a positive refractive power as a whole. The first lens L1 to the fourth lens L4 has negative, positive, positive, and positive refractive powers, respectively, in order from the first lens L1 on the object side.

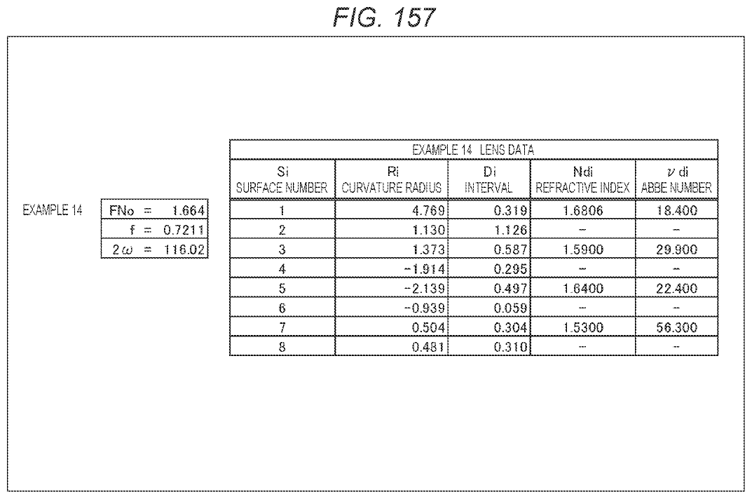

FIG. 157 illustrates specific characteristic data of the lens optical system 2-14 and lens data of the first lens L1 to the fourth lens L4.

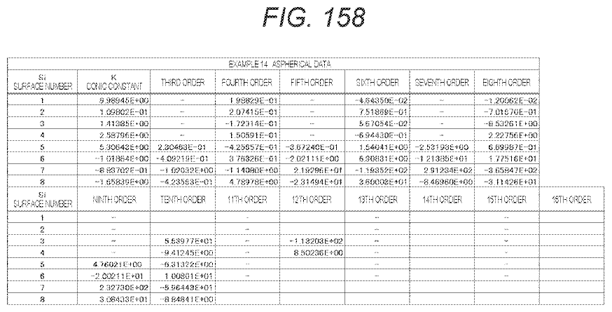

FIG. 158 illustrates a conic constant K of Formula (1) for specifying the aspherical shape of each surface S1 of the lens optical system 2-14 and a value of the i-th order (i is an integer of 3 or more) aspherical coefficient Ai.

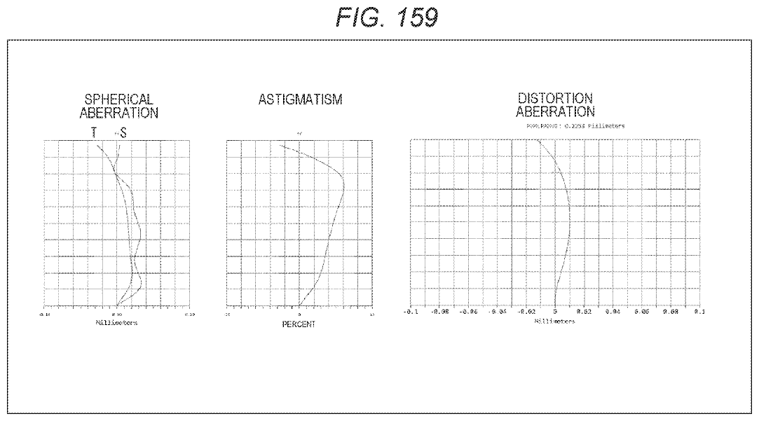

FIG. 159 is a diagram illustrating aberration performance of the lens optical system 2-14, and illustrates a spherical aberration diagram, an astigmatism diagram, and a distortion aberration diagram.

As can be seen from each aberration diagram, the lens optical system 2-14 has various aberrations corrected well and has excellent image forming performance.

<2.15 Conditional Expression Data of Lens Optical System According to Second Embodiment>

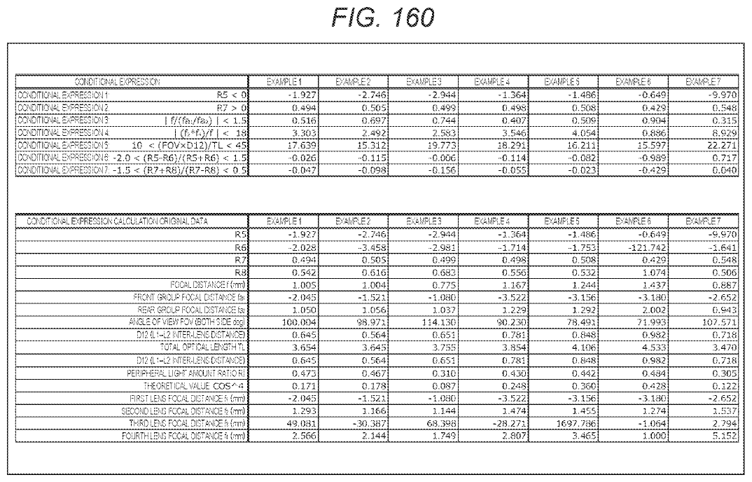

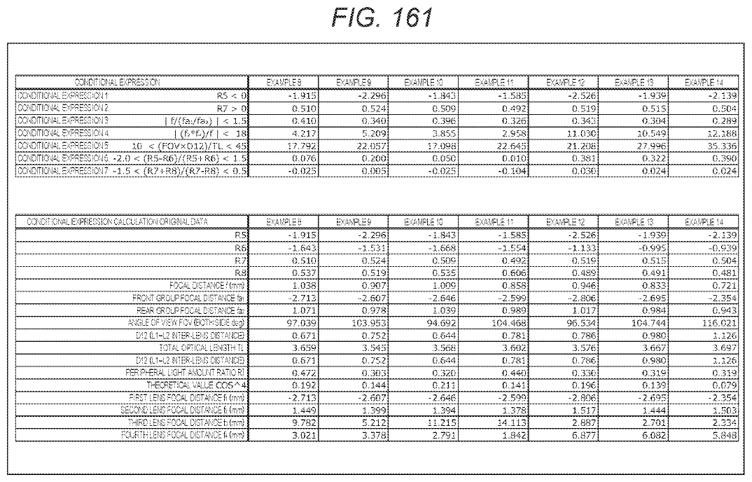

FIGS. 160 and 161 illustrate values obtained by calculating the conditional expressions (1) to (7) and original data required for calculating the respective conditional expressions in the lens optical systems 2-1 to 2-14 illustrated in FIGS. 104 to 159.

As illustrated in FIGS. 160 and 161, the lens optical systems 2-1 to 2-14 satisfy all of the conditional expressions (1) to (7). Furthermore, the lens optical systems 2-1 to 2-14 also satisfy the conditional expressions (3)′ to (7)′ which are more preferable conditions.

With the lens optical systems 2-1 to 2-14 satisfying the conditional expressions (1) to (7), more preferably the conditional expressions (3)′ to (7)′, Fno is bright, the light beams including peripheral light beams can be captured with high efficiency, and reduction in size and height can be achieved.

<3. Application Example to Distance Measuring System>

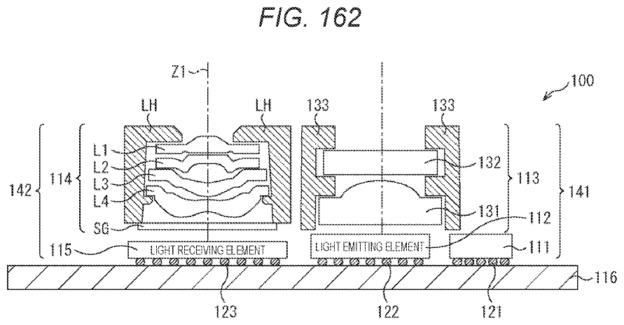

FIG. 162 illustrates a configuration example of a distance measuring system equipped with the lens optical system 1 according to the first embodiment or the lens optical system 2 according to the second embodiment described above.

A distance measuring system 100 in FIG. 162 includes a lighting device 141 that irradiates a predetermined object as a subject with irradiation light and a light receiving device 142 that receives reflected light returned after the irradiation light is reflected by the object.

The lighting device 141 includes a light emission control circuit 111, a light emitting element 112, and a light emitting side optical system 113, and the light receiving device 142 includes a light receiving side optical system 114 and a light receiving element 115.

The light emission control circuit 111, the light emitting element 112, and the light receiving element 115 are disposed on a same circuit board 116, the light emission control circuit 111 is electrically connected to the circuit board 116 via a plurality of solder balls 121, the light emitting element 112 is electrically connected to the circuit board 116 via a plurality of solder balls 122, and the light receiving element 115 is electrically connected to the circuit board 116 via a plurality of solder balls 123.

The light emission control circuit 111 generates a light emission timing signal for controlling a timing at which the light emitting element 112 emits irradiation light, and supplies the light emission timing signal to the light emitting element 112 and the light receiving element 115 via the circuit board 116.

The light emitting element 112 includes, for example, a VCSEL array in which a plurality of vertical cavity surface emitting lasers (VCSEL) is arranged in a matrix. The light emitting element 112 turns on/off light emission (irradiation light) on the basis of the light emission timing signal supplied from the light emission control circuit 111 via the circuit board 116.

The light emitting side optical system 113 includes a collimator lens 131 and a diffractive optical element 132, and a lens holder 133 that holds them. The collimator lens 131 converts light emitted from the light emitting element 112 at a predetermined divergence angle into parallel light and outputs the parallel light. The diffractive optical element 132 enlarges an irradiation area by replicating a light emission pattern (light emission surface) of a predetermined region having passed through the collimator lens 131 in a direction perpendicular to the optical axis direction.

The light receiving side optical system 114 includes the first lens L1, the second lens L2, the third lens L3, the fourth lens L4, the sealing glass SG, and a lens holder LH that holds them. Furthermore, although not illustrated, the aperture stop STO is disposed between the first lens L1 and the second lens L2. Note that the sealing glass SG may be omitted.

The light receiving side optical system 114 has a positive refractive power as a whole of a four-lens configuration with the first lens L1 to the fourth lens L4, collects reflected light from the object side, and forms an image on the photoelectric conversion section of the light receiving element 115. As the light receiving side optical system 114, the lens optical system 1 according to the first embodiment described above or the lens optical system 2 according to the second embodiment can be employed.

The light receiving element 115 has a pixel array in which pixels are two-dimensionally arranged in a matrix in a row direction and a column direction. The pixel of the light receiving element 115 includes, for example, a single photon avalanche diode (SPAD), an avalanche photodiode (APD), or the like as the photoelectric conversion section.

The light receiving element 115 receives the reflected light collected by the light receiving side optical system 114. Then, the light receiving element 115 performs an operation of obtaining the distance to the subject on the basis of a digital count value obtained by counting the time from when the light emitting element 112 emits the irradiation light to when the light receiving element 115 receives the irradiation light and the light speed, and generates and outputs a distance image in which the operation result is stored in each pixel. The light emission timing signal indicating a light emission timing of the light emitting element 112 is supplied from the light emission control circuit 111 via the circuit board 116.

By employing the lens optical system 1 according to the first embodiment or the lens optical system 2 according to the second embodiment as the light receiving side optical system 114, the angle of view is widened, so that the range on the object side can be widened, and the light beams from the object side can be efficiently collected and guided to the light receiving element 115. Moreover, in addition to good light collecting performance and optical performance, the total optical length can be shortened, and reduction in size and height are achieved.

The light receiving element 115 described above is a ToF sensor of a direct ToF method that directly counts the time from when the light emitting element 112 emits the irradiation light to when the light receiving element 115 receives the irradiation light by the digital count value, but may be a ToF sensor of an indirect ToF method that detects the time from when the light emitting element 112 emits the irradiation light to when the light receiving element 115 receives the irradiation light as a phase difference. That is, the lens optical system 1 according to the first embodiment and the lens optical system 2 according to the second embodiment described above can be applied to the lens optical system of the ToF sensor of either the direct ToF method or the indirect ToF method. Furthermore, a charge coupled device (CCD) or a complementary metal oxide semiconductor (CMOS) image sensor can be applied as the light receiving element 115 instead of the ToF sensor. That is, the light receiving side optical system 114 can also be applied to an image forming lens of an image sensor for image generation.

<4. Application Example to Electronic Apparatus>

The above-described distance measuring system 100 can be mounted on, for example, electronic devices such as a smartphone, a tablet terminal, a mobile phone, a personal computer, a game device, a television receiver, a wearable terminal, a digital still camera, and a digital video camera.

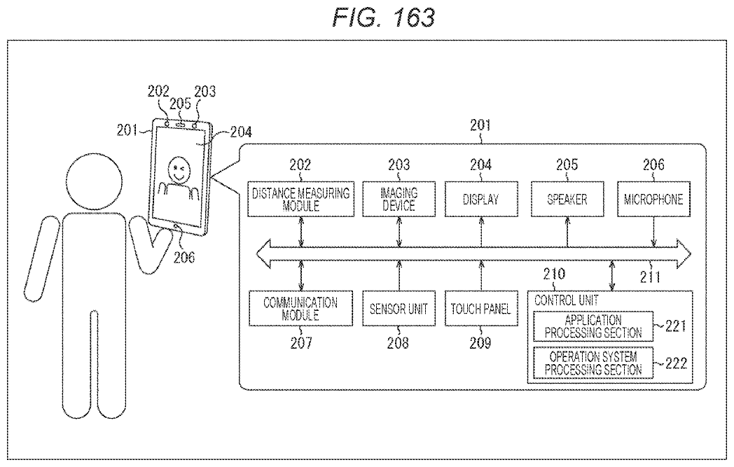

FIG. 163 is a block diagram illustrating a configuration example of a smartphone as an electronic device equipped with the distance measuring system 100.

As illustrated in FIG. 163, a smartphone 201 is configured by connecting a distance measuring module 202, an imaging device 203, a display 204, a speaker 205, a microphone 206, a communication module 207, a sensor unit 208, a touch panel 209, and a control unit 210 via a bus 211. Furthermore, the control unit 210 has functions as an application processing section 221 and an operation system processing section 222 by the CPU executing a program.

The distance measuring system 100 in FIG. 162 is applied to the distance measuring module 202. For example, the distance measuring module 202 is arranged on the front surface of the smartphone 201, and performs distance measurement for the user of the smartphone 201, so that it is possible to output a distance image of a surface shape of a face, a hand, a finger, or the like of the user as a distance measurement result.

The imaging device 203 is arranged in front of the smartphone 201, and performs imaging with the user of the smartphone 201 as a subject to acquire an image in which the user is captured. Note that, although not illustrated, a configuration may be employed in which the imaging device 203 is also disposed on the back surface of the smartphone 201.

The display 204 displays an operation screen for performing processing by the application processing section 221 and the operation system processing section 222, an image captured by the imaging device 203, and the like. The speaker 205 and the microphone 206 output the voice of the other party and collect the voice of the user, for example, when making a call using the smartphone 201.

The communication module 207 performs communication via a communication network. The sensor unit 208 senses speed, acceleration, proximity, and the like, and the touch panel 209 acquires a touch operation by the user on an operation screen displayed on the display 204.

The application processing section 221 performs processing for providing various services by the smartphone 201. For example, the application processing section 221 can perform processing of creating a face by computer graphics virtually reproducing the expression of the user on the basis of a depth map supplied from the distance measuring module 202 and displaying the face on the display 204. Furthermore, the application processing section 221 can perform processing of creating, for example, three-dimensional shape data of an arbitrary three-dimensional object on the basis of the depth map supplied from the distance measuring module 202.

The operation system processing section 222 performs processing for achieving basic functions and operations of the smartphone 201. For example, the operation system processing section 222 can perform processing of authenticating the user's face, and unlocking the smartphone 201 on the basis of the depth map supplied from the distance measuring module 202. Furthermore, the operation system processing section 222 can perform, for example, processing of recognizing a gesture of the user on the basis of the depth map supplied from the distance measuring module 202, and processing of inputting various operations according to the gesture.

In the smartphone 201 configured as described above, for example, the distance image can be generated with high accuracy and at high speed by applying the above-described distance measuring system 100. Thus, the smartphone 201 can more accurately detect the distance measurement information.

<5. Application Example to Mobile Object>

The technology according to the present disclosure (the present technology) can be applied to various products. For example, the technology according to the present disclosure may be achieved as a device mounted on any type of mobile object such as an automobile, an electric vehicle, a hybrid electric vehicle, a motorcycle, a bicycle, a personal mobility, an airplane, a drone, a ship, a robot, and the like.

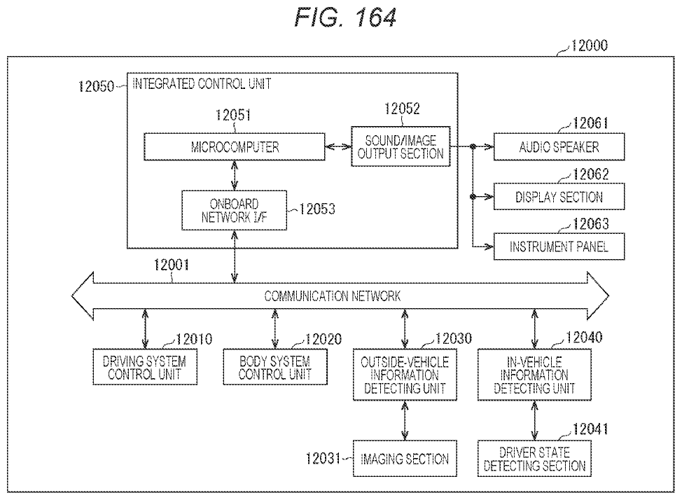

FIG. 164 is a block diagram illustrating a schematic configuration example of a vehicle control system which is an example of a mobile object control system to which the technology according to the present disclosure can be applied.

The vehicle control system 12000 includes a plurality of electronic control units connected to each other via a communication network 12001. In the example depicted in FIG. 164, the vehicle control system 12000 includes a driving system control unit 12010, a body system control unit 12020, an outside-vehicle information detecting unit 12030, an in-vehicle information detecting unit 12040, and an integrated control unit 12050. Furthermore, as a functional configuration of the integrated control unit 12050, a microcomputer 12051, a sound/image output section 12052, and an onboard network interface (I/F) 12053 are illustrated.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives input of these radio waves or signals, and controls a door lock device, a power window device, a lamp, and the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electrical signal as an image or as distance measurement information. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041 includes, for example, a camera that captures an image of the driver, and the in-vehicle information detecting unit 12040 may calculate the degree of fatigue or the degree of concentration of the driver, or determine whether or not the driver has fallen asleep on the basis of detection information input from the driver state detecting section 12041.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) including collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control for the purpose of anti-glare, such as controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 164, an audio speaker 12061, a display section 12062, and an instrument panel 12063 are illustrated as the output device. The display section 12062 may, for example, include at least one of an on-board display or a head-up display.

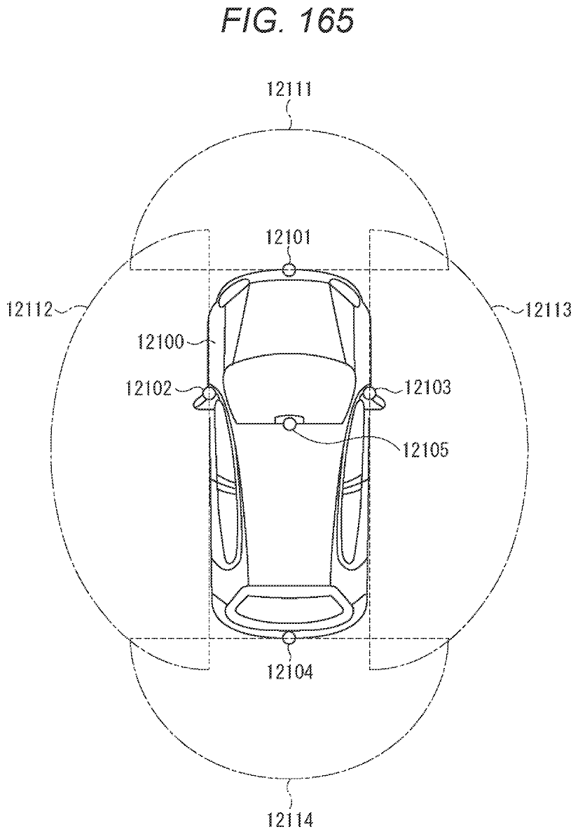

FIG. 165 is a view illustrating an example of the installation position of the imaging section 12031.

In FIG. 165, the vehicle 12100 includes imaging sections 12101, 12102, 12103, 12104, and 12105 as the imaging section 12031.

The imaging sections 12101, 12102, 12103, 12104, and 12105 are provided, for example, at positions such as a front nose, a side mirror, a rear bumper, a back door, and an upper part of a windshield in the cabin of the vehicle 12100. The imaging section 12101 provided on the front nose and the imaging section 12105 provided above the windshield in the cabin mainly obtain a forward image of the vehicle 12100. The imaging sections 12102 and 12103 provided in the side mirrors mainly obtain images of sides of the vehicle 12100. The imaging section 12104 provided in a rear bumper or a back door mainly obtains an image behind the vehicle 12100. The forward image obtained by the imaging sections 12101 and 12105 are mainly used for detecting a preceding vehicle, a pedestrian, an obstacle, a traffic light, a traffic sign, a lane, and the like.

Incidentally, FIG. 165 illustrates an example of imaging ranges of the imaging sections 12101 to 12104. An imaging range 12111 represents the imaging range of the imaging section 12101 provided on the front nose, imaging ranges 12112 and 12113 represent the imaging ranges of the imaging sections 12102 and 12103 provided in the side mirrors, respectively, and an imaging range 12114 represents the imaging range of the imaging section 12104 provided in the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating the risk of collision with each obstacle, and when the collision risk is equal to or higher than a set value and there is a possibility of collision, the microcomputer 12051 can output a warning to the driver via the audio speaker 12061 and the display section 12062, or perform forced deceleration or avoidance steering via the driving system control unit 12010, to thereby perform assistance in driving for collision avoidance.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure can be applied has been described above. The technology according to the present disclosure can be applied to the outside-vehicle information detecting unit 12030 and the in-vehicle information detecting unit 12040 among the above-described configurations. Specifically, by using the distance measurement by the distance measuring system 100 as the outside-vehicle information detecting unit 12030 and the in-vehicle information detecting unit 12040, processing of recognizing the gesture of the driver is performed, and various operations (for example, an audio system, a navigation system, and an air conditioning system) according to the gesture can be executed, or the state of the driver can be detected more accurately. Furthermore, unevenness of the road surface can be recognized using the distance measurement by the distance measuring system 1 and reflected in control of the suspension.

The embodiments of the present disclosure are not limited to the above-described embodiments, and various modifications can be made without departing from the gist of the present disclosure.

The plurality of present technologies which has been described in the present description can be each implemented independently as a single unit as long as no contradiction occurs. Of course, any plurality of the present technologies can also be used and implemented in combination. Furthermore, part or all of any of the above-described present technologies can be implemented by using together with another technology that is not described above.

Further, for example, a configuration described as one device (or processing section) may be divided and configured as a plurality of devices (or processing sections). Conversely, configurations described above as a plurality of devices (or processing sections) may be combined and configured as one device (or processing section). Furthermore, a configuration other than those described above may of course be added to the configuration of each device (or each processing section). Moreover, if the configuration and operation of the entire system are substantially the same, a part of the configuration of a certain device (or processing section) may be included in the configuration of another device (or another processing section).

Moreover, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

Note that the effects described in the present description are merely examples and are not limited, and effects other than those described in the present description may be provided.

Note that the present disclosure can have the following configurations.

(1)

A lens optical system including,

in order from an object side:

a first lens group having a negative refractive power; and

a second lens group having a positive refractive power, in which

the first lens group includes
a first lens having a negative refractive power,

the second lens group includes
a second lens having a positive or negative refractive power,
a third lens having a positive refractive power, and
a fourth lens having a positive refractive power, and

the lens optical system has a positive refractive power as a whole.

(2)

The lens optical system according to (1) above, in which

a conditional expression (1) as follows is satisfied

R3<0 (1)

where R3 represents a curvature radius of an object-side surface of the second lens.

(3)

The lens optical system according to (1) or (2) above, in which

a conditional expression (2) as follows is satisfied

R7>0 (2)

where R7 represents a curvature radius of an object-side surface of the fourth lens.

(4)

The lens optical system according to any one of (1) to (3) above, in which

a conditional expression (3) as follows is satisfied

|f/(fa₁/fa₂)|<2.0 (3)

where f represents a focal length of the lens optical system at a d-line (wavelength 587.6 nanometers),

fa₁ represents a focal length of the first lens group at the d-line (wavelength 587.6 nanometers), and

fa₂ represents a focal length of the second lens group at the d-line (wavelength 587.6 nanometers).

(5)

The lens optical system according to any one of (1) to (4) above, in which

a conditional expression (4) as follows is satisfied

15<f/(f₂×f₃)<70 (4)

where f represents a focal length of the lens optical system at a d-line (wavelength 587.6 nanometers),

f₂ represents a focal length of the second lens at the d-line (wavelength 587.6 nanometers), and

f₃ represents a focal length of the third lens at the d-line (wavelength 587.6 nanometers).

(6)

The lens optical system according to any one of (1) to (5) above, in which

a conditional expression (5) as follows is satisfied

3<(FOV×D12)/TL<25 (5)

where TL represents a total optical length of the lens optical system,

FOV represents an angle of view, and

D12 represents an inter-lens distance between the first lens and the second lens.

(7)

The lens optical system according to any one of (1) to (6) above, in which

a conditional expression (6) as follows is satisfied

−8.0<(R1−R2)/(R1+R2)<140 (6)

where R1 represents a lens curvature radius of an object-side surface of the first lens, and

R2 represents a lens curvature radius of an image-side surface of the first lens.

(8)

The lens optical system according to any one of (1) to (7) above, in which

a conditional expression (7) as follows is satisfied

−2.0<(R3−R4)/(R3+R4)<2.0 (7)

where R3 represents a lens curvature radius of an object-side surface of the second lens, and

R4 represents a lens curvature radius of an image-side surface of the second lens.

(9)

The lens optical system according to any one of (1) to (8) above, in which

a conditional expression (8) as follows is satisfied

−10.0<(R7+R8)/(R7−R8)<2.0 (8)

where R7 represents a lens curvature radius of an object-side surface of the fourth lens, and

R8 represents a lens curvature radius of an image-side surface of the fourth lens.

(10)

A light receiving device including:

a lens optical system; and

a light receiving element that receives light from an object side collected by the lens optical system, in which

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive or negative refractive power,
a third lens having a positive refractive power, and
a fourth lens having a positive refractive power.

(11)

A distance measuring system including:

a lighting device that emits irradiation light; and

a light receiving device that receives reflected light in which the irradiation light is reflected by an object, in which

the light receiving device includes
a lens optical system, and
a light receiving element that receives light beams from an object side collected by the lens optical system, and

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive or negative refractive power,
a third lens having a positive refractive power, and
a fourth lens having a positive refractive power.

(12)

A lens optical system including,

in order from an object side:

a first lens group having a negative refractive power; and

a second lens group having a positive refractive power, in which

the first lens group includes
a first lens having a negative refractive power,

the second lens group includes
a second lens having a positive refractive power,
a third lens having a positive or negative refractive power, and
a fourth lens having a positive refractive power, and

the lens optical system has a positive refractive power as a whole.

(13)

The lens optical system according to (12) above, in which

a conditional expression (1) as follows is satisfied

R5<0 (1)

where R5 represents a curvature radius of an object-side surface of the third lens.

(14)

The lens optical system according to (12) or (13) above, in which

a conditional expression (2) as follows is satisfied

R7>0 (2)

where R7 represents a curvature radius of an object-side surface of the fourth lens.

(15)

The lens optical system according to any one of (12) to (14) above, in which

a conditional expression (3) as follows is satisfied

|f/(fa₁/fa₂)|<1.5 (3)

where f represents a focal length of the lens optical system at a d-line (wavelength 587.6 nanometers),

fa₁ represents a focal length of the first lens group at the d-line (wavelength 587.6 nanometers), and

fa₂ represents a focal length of the second lens group at the d-line (wavelength 587.6 nanometers).

(16)

The lens optical system according to any one of (12) to (15) above, in which

a conditional expression (4) as follows is satisfied

|(f₂×f₄)/f|<18 (4)

where f represents a focal length of the lens optical system at a d-line (wavelength 587.6 nanometers),

f₂ represents a focal length of the second lens at the d-line (wavelength 587.6 nanometers), and

f₄ represents a focal length of the fourth lens at the d-line (wavelength 587.6 nanometers).

(17)

The lens optical system according to any one of (12) to (16) above, in which

a conditional expression (5) as follows is satisfied

10<(FOV×D12)/TL<45 (5)

where TL represents a total optical length of the lens optical system,

FOV represents an angle of view, and

D12 represents an inter-lens distance between the first lens and the second lens.

(18)

The lens optical system according to any one of (12) to (17) above, in which

a conditional expression (6) as follows is satisfied

−2.0<(R5−R6)/(R5+R6)<1.5 (6)

where R5 represents a lens curvature radius of an object-side surface of the third lens, and

R6 represents a lens curvature radius of an image-side surface of the fourth lens.

(19)

The lens optical system according to any one of (12) to (18) above, in which

a conditional expression (7) as follows is satisfied

−1.5<(R7+R8)/(R7−R8)<0.5 (7)

where R7 represents a lens curvature radius of an object-side surface of the fourth lens, and

R8 represents a lens curvature radius of an image-side surface of the fourth lens.

(20)

A light receiving device including:

a lens optical system; and

a light receiving element that receives light from an object side collected by the lens optical system, in which

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive refractive power,
a third lens having a positive or negative refractive power, and
a fourth lens having a positive refractive power.

(21)

A distance measuring system including:

a lighting device that emits irradiation light; and

a light receiving device that receives reflected light in which the irradiation light is reflected by an object, in which

the light receiving device includes
a lens optical system, and
a light receiving element that receives light beams from an object side collected by the lens optical system, and

the lens optical system has a positive refractive power as a whole, and includes,
in order from the object side,
a first lens group having a negative refractive power, and
a second lens group having a positive refractive power,

the first lens group includes
a first lens having a negative refractive power, and

the second lens group includes
a second lens having a positive refractive power,
a third lens having a positive or negative refractive power, and
a fourth lens having a positive refractive power.

### REFERENCE SIGNS LIST

L1 First lens
L2 Second lens
L3 Third lens
L4 Fourth lens
SG Sealing glass
STO Aperture stop
IMG Image plane
1-1 to 1-25 Lens optical system
2-1 to 2-14 Lens optical system
100 Distance measuring system
111 Light emission control circuit
112 Light emitting element
113 Light emitting side optical system
114 Light receiving side optical system
115 Light receiving element
116 Circuit board
131 Collimator lens
132 Diffractive optical element
133 Lens holder
141 Lighting device
142 Light receiving device

1. A lens optical system comprising,
in order from an object side:
a first lens group having a negative refractive power; and
a second lens group having a positive refractive power,
wherein
the first lens group includes
a first lens having a negative refractive power,
the second lens group includes
a second lens having a positive or negative refractive power,
a third lens having a positive refractive power, and
a fourth lens having a positive refractive power, and
the lens optical system has a positive refractive power as a whole.

2. The lens optical system according to claim 1, wherein
a conditional expression (1) as follows is satisfied
R3<0 (1)
where R3 represents a curvature radius of an object-side surface of the second lens.

3. The lens optical system according to claim 1, wherein
a conditional expression (2) as follows is satisfied
R7>0 (2)
where R7 represents a curvature radius of an object-side surface of the fourth lens.

4. The lens optical system according to claim 1, wherein
a conditional expression (3) as follows is satisfied

|f/(fa₁/fa₂)|<2.0 (3)
where f represents a focal length of the lens optical system at a d-line (wavelength 587.6 nanometers),
fa₁ represents a focal length of the first lens group at the d-line (wavelength 587.6 nanometers), and
fa₂ represents a focal length of the second lens group at the d-line (wavelength 587.6 nanometers).

5. The lens optical system according to claim 1, wherein
a conditional expression (4) as follows is satisfied
15<f/(f₂×f₃)<70 (4)
where f represents a focal length of the lens optical system at a d-line (wavelength 587.6 nanometers),
f₂ represents a focal length of the second lens at the d-line (wavelength 587.6 nanometers), and
f₃ represents a focal length of the third lens at the d-line (wavelength 587.6 nanometers).

6. The lens optical system according to claim 1, wherein
a conditional expression (5) as follows is satisfied
3<(FOV×D12)/TL<25 (5)
where TL represents a total optical length of the lens optical system,
FOV represents an angle of view, and
D12 represents an inter-lens distance between the first lens and the second lens.

7. The lens optical system according to claim 1, wherein
a conditional expression (6) as follows is satisfied
−8.0<(R1−R2)/(R1+R2)<140 (6)
where R1 represents a lens curvature radius of an object-side surface of the first lens, and
R2 represents a lens curvature radius of an image-side surface of the first lens.

8. The lens optical system according to claim 1, wherein
a conditional expression (7) as follows is satisfied
−2.0<(R3−R4)/(R3+R4)<2.0 (7)
where R3 represents a lens curvature radius of an object-side surface of the second lens, and
R4 represents a lens curvature radius of an image-side surface of the second lens.

9. The lens optical system according to claim 1, wherein
a conditional expression (8) as follows is satisfied
−10.0<(R7+R8)/(R7−R8)<2.0 (8)
where R7 represents a lens curvature radius of an object-side surface of the fourth lens, and
R8 represents a lens curvature radius of an image-side surface of the fourth lens.

10. A light receiving device comprising:
a lens optical system; and
a light receiving element that receives light from an object side collected by the lens optical system, wherein
the lens optical system has a positive refractive power as a whole, and includes,
in order from the object side,
a first lens group having a negative refractive power, and
a second lens group having a positive refractive power,
the first lens group includes
a first lens having a negative refractive power, and
the second lens group includes
a second lens having a positive or negative refractive power,
a third lens having a positive refractive power, and
a fourth lens having a positive refractive power.

11. A distance measuring system comprising:
a lighting device that emits irradiation light; and
a light receiving device that receives reflected light in which the irradiation light is reflected by an object, wherein
the light receiving device includes
a lens optical system, and
a light receiving element that receives light beams from an object side collected by the lens optical system, and
the lens optical system has a positive refractive power as a whole, and includes,
in order from the object side,
a first lens group having a negative refractive power, and
a second lens group having a positive refractive power,
the first lens group includes
a first lens having a negative refractive power, and
the second lens group includes
a second lens having a positive or negative refractive power,
a third lens having a positive refractive power, and
a fourth lens having a positive refractive power.

12. A lens optical system comprising,
in order from an object side:
a first lens group having a negative refractive power; and
a second lens group having a positive refractive power,
wherein
the first lens group includes
a first lens having a negative refractive power,
the second lens group includes
a second lens having a positive refractive power,
a third lens having a positive or negative refractive power, and
a fourth lens having a positive refractive power, and
the lens optical system has a positive refractive power as a whole.

13. The lens optical system according to claim 12, wherein
a conditional expression (1) as follows is satisfied
R5<0 (1)
where R5 represents a curvature radius of an object-side surface of the third lens.

14. The lens optical system according to claim 12, wherein
a conditional expression (2) as follows is satisfied
R7>0 (2)
where R7 represents a curvature radius of an object-side surface of the fourth lens.

15. The lens optical system according to claim 12, wherein
a conditional expression (3) as follows is satisfied

|f/(fa₁/fa₂)|<2.0 (3)
where f represents a focal length of the lens optical system at a d-line (wavelength 587.6 nanometers),
fa₁ represents a focal length of the first lens group at the d-line (wavelength 587.6 nanometers), and
fa₂ represents a focal length of the second lens group at the d-line (wavelength 587.6 nanometers).

16. The lens optical system according to claim 12, wherein
a conditional expression (4) as follows is satisfied

|(f₂×f₄)/f|<18 (4)
where f represents a focal length of the lens optical system at a d-line (wavelength 587.6 nanometers),
f₂ represents a focal length of the second lens at the d-line (wavelength 587.6 nanometers), and
f₄ represents a focal length of the fourth lens at the d-line (wavelength 587.6 nanometers).

17. The lens optical system according to claim 12, wherein
a conditional expression (5) as follows is satisfied
3<(FOV×D12)/TL<25 (5)
where TL represents a total optical length of the lens optical system,
FOV represents an angle of view, and
D12 represents an inter-lens distance between the first lens and the second lens.

18. The lens optical system according to claim 12, wherein
a conditional expression (6) as follows is satisfied
−2.0<(R5−R6)/(R5+R6)<1.5 (6)
where R5 represents a lens curvature radius of an object-side surface of the third lens, and
R6 represents a lens curvature radius of an image-side surface of the fourth lens.

19. The lens optical system according to claim 12, wherein
a conditional expression (7) as follows is satisfied
−1.5<(R7+R8)/(R7−R8)<0.5 (7)
where R7 represents a lens curvature radius of an object-side surface of the fourth lens, and
R8 represents a lens curvature radius of an image-side surface of the fourth lens.

20. A light receiving device comprising:
a lens optical system; and
a light receiving element that receives light from an object side collected by the lens optical system, wherein
the lens optical system has a positive refractive power as a whole, and includes,
in order from the object side,
a first lens group having a negative refractive power, and
a second lens group having a positive refractive power,
the first lens group includes
a first lens having a negative refractive power, and
the second lens group includes
a second lens having a positive refractive power,
a third lens having a positive or negative refractive power, and
a fourth lens having a positive refractive power.

21. A distance measuring system comprising:
a lighting device that emits irradiation light; and
a light receiving device that receives reflected light in which the irradiation light is reflected by an object, wherein
the light receiving device includes
a lens optical system, and
a light receiving element that receives light beams from an object side collected by the lens optical system, and
the lens optical system has a positive refractive power as a whole, and includes,
in order from the object side,
a first lens group having a negative refractive power, and
a second lens group having a positive refractive power,
the first lens group includes
a first lens having a negative refractive power, and
the second lens group includes
a second lens having a positive refractive power,
a third lens having a positive or negative refractive power, and
a fourth lens having a positive refractive power.
